(19) United States
(12) Patent Application Publication
(10) Pub. No.: US 2002/0120741 A1
(43) Pub. Date: Aug. 29, 2002

(54) Systems and methods for using distributed interconnects in information management enviroments

(76) Inventors: Theodore S. Webb, Austin, TX (US); Gregory J. Jackson, Dripping Springs, TX (US); Scott C. Johnson, Round Rock, TX (US); Brian J. Pellerin, Austin, TX (US); Chaoxin C. Qiu, Austin, TX (US); Roger K. Richter, Leander, TX (US)

Correspondence Address: O'KEEFE, EGAN & PETERMAN, L.L.P., Building C, Suite 200, 1101 Capital of Texas Highway South, Austin, TX, 78746, US

(21) Appl. No.: 10/003,683

(22) Filed: Nov. 2, 2001

Related U.S. Application Data
(63) Continuation-in-part of application No. 09/879,810, filed on Jun. 12, 2001.
(60) Provisional application No. 60/285,211, filed on Apr. 20, 2001.
(60) Provisional application No. 60/291,073, filed on May 15, 2001.
(60) Provisional application No. 60/187,211, filed on Mar. 3, 2000.
(60) Provisional application No. 60/246,401, filed on Nov. 7, 2000.
(60) Provisional application No. 60/246,373, filed on Nov. 7, 2000.

(51) Int. Cl. G06F 15/173

(52) U.S. Cl. 709/225

(57) ABSTRACT

A distributed interconnect may be employed in information management environments to distribute functionality, for example, among processing engines of an information management system and/or processing modules thereof. Distributive interconnects such as switch fabrics and virtual distributed interconnect backplanes, may be employed to establish independent paths from node to node and thus may be used to facilitate parallel and independent operation of each processing engine of a multi-processing engine information management system, e.g. to provide peer-to-peer communication between the engines on an as-needed basis. These and other features of distributed interconnects may be advantageously employed to optimize information management systems operations in a variety of system configurations.

This application is a continuation-in-part of co-pending U.S. patent application Ser. No. 09/879,810 filed on Jun. 12, 2001 which is entitled “SYSTEMS AND METHODS FOR PROVIDING DIFFERENTIATED SERVICE IN INFORMATION MANAGEMENT ENVIRONMENTS,” and also claims priority from co-pending Provisional Application Serial No. 60/285,211 filed on Apr. 20, 2001 which is entitled “SYSTEMS AND METHODS FOR PROVIDING DIFFERENTIATED SERVICE IN A NETWORK ENVIRONMENT,” and also claims priority from co-pending Provisional Application Serial No. 60/291,073 filed on May 15, 2001 which is entitled “SYSTEMS AND METHODS FOR PROVIDING DIFFERENTIATED SERVICE IN A NETWORK ENVIRONMENT,” the disclosures of each of the forgoing applications being incorporated herein by reference. This application also claims priority from co-pending U.S. patent application Ser. No. 09/797,200 filed on Mar. 1, 2001 which is entitled “SYSTEMS AND METHODS FOR THE DETERMINISTIC MANAGEMENT OF INFORMATION” which itself claims priority from Provisional Application Serial No. 60/187,211 filed on Mar. 3, 2000 which is entitled “SYSTEM AND APPARATUS FOR INCREASING FILE SERVER BANDWIDTH,” the disclosures of each of the forgoing applications being incorporated herein by reference. This application also claims priority from co-pending Provisional Application Serial No. 60/246,401 filed on Nov. 7, 2000 which is entitled “SYSTEM AND METHOD FOR THE DETERMINISTIC DELIVERY OF DATA AND SERVICES,” the disclosure of which is incorporated herein by reference.

### BACKGROUND OF THE INVENTION

The present invention relates generally to computing systems, and more particularly to network connected computing systems.

Most network computing systems, including servers and switches, are typically provided with a number of subsystems that interact to accomplish the designated task/s of the individual computing system. Each subsystem within such a network computing system is typically provided with a number of resources that it utilizes to carry out its function. In operation, one or more of these resources may become a bottleneck as load on the computing system increases, ultimately resulting in degradation of client connection quality, severance of one or more client connections, and/or server crashes.

Network computing system bottlenecks have traditionally been dealt with by throwing more resources at the problem. For example, when performance degradation is encountered, more memory, a faster CPU (central processing unit), multiple CPU's, or more disk drives are added to the server in an attempt to alleviate the bottlenecks. Such solutions therefore typically involve spending more money to add more hardware. Besides being expensive and time consuming, the addition of hardware often only serves to push the bottleneck to a different subsystem or resource.

Issues associated with thin last mile access networks are currently being addressed by technologies such as DSL and cable modems, while overrun core networks are being improved using, for example, ultra-high speed switching/routing and wave division multiplexing technologies. However, even with the implementation of such technologies, end user expectations of service quality per device and content usage experience is often not met due to network equipment limitations encountered in the face of the total volume of network usage. Lack of network quality assurance for information management applications such as content delivery makes the implementation of mission-critical or high quality content delivery undesirable on networks such as the Internet, limiting service growth and profitability and leaving content delivery and other information management applications as thin profit commodity businesses on such networks.

Often the ultimate network bottleneck is the network server itself. For example, to maintain high-quality service for a premium customer necessarily requires that the traditional video server be under-utilized so that sufficient bandwidth is available to deliver a premium video stream without packet loss. However, to achieve efficient levels of utilization the server must handle multiple user sessions simultaneously, often including both premium and non-premium video streams. In this situation, the traditional server often becomes overloaded, and delivers all streams with equal packet loss. Thus, the premium customer has the same low quality experience as a non-premium customer.

A number of standards, protocols and techniques have been developed over the years to provide varying levels of treatment for different types of traffic on local area networks (“LANs”). These standards have been implemented at many Open System Interconnection (“OSI”) levels. For example, Ethernet has priority bits in the 802.1 p/q header, and. TCP/IP has TOS bits. Presumably, switches and routers would use these bits to give higher priority to packets labeled with one set of bits, as opposed to another. RSVP is a signaling protocol that is used to reserve resources throughout the LAN (from one endpoint to another), so that bandwidth for a connection can be guaranteed. Many of these protocols have being considered for use within the Internet.

### SUMMARY OF THE INVENTION

Disclosed herein are systems and methods for the deterministic management of information, such as management of the delivery of content across a network that utilizes computing systems such as servers, switches and/or routers. Among the many advantages provided by the disclosed systems and methods are increased performance and improved predictability of such computing systems in the performance of designated tasks across a wide range of loads. Examples include greater predictability in the capability of a network server, switch or router to process and manage information such as content requests, and acceleration in the delivery of information across a network utilizing such computing systems.

Deterministic embodiments of the disclosed systems and methods may be implemented to achieve substantial elimination of indeterminate application performance characteristics common with conventional information management systems, such as conventional content delivery infrastructures. For example, the disclosed systems and methods may be advantageously employed to solve unpredictability, delivery latencies, capacity planning, and other problems associated with general application serving in a computer network environment, for example, in the delivery of streaming media, data and/or services. Other advantages and benefits possible with implementation of the disclosed systems and methods include maximization of hardware resource use for delivery of content while at the same time allowing minimization of the need to add expensive hardware across all functional subsystems simultaneously to a content delivery system, and elimination of the need for an application to have intimate knowledge of the hardware it intends to employ by maintaining such knowledge in the operating system of a deterministically enabled computing component.

In one exemplary embodiment, the disclosed systems and methods may be employed with network content delivery systems to manage content delivery hardware in a manner to achieve efficient and predictable delivery of content. In another exemplary embodiment, deterministic delivery of data through a content delivery system may be implemented with end-to-end consideration of QoS priority policies within and across all components from storage disk to wide area network (WAN) interface. In yet another exemplary embodiment, delivery of content may be tied to the rate at which the content is delivered from networking components. These and other benefits of the disclosed methods and systems may be achieved, for example, by incorporating intelligence into individual system components.

The disclosed systems and methods may be implemented to utilize end-to-end consideration of quality assurance parameters so as to provide scalable and practical mechanisms that allow varying levels of service to be differentially tailored or personalized for individual network users. Consideration of such quality assurance parameters may be used to advantageously provide end-to-end network systems, such as end-to-end content delivery infrastructures, with network based mechanisms that provide users with class of service (“CoS”), quality of service (“QoS”), connection admission control, etc. This ability may be used by service providers (“xSPs”) to offer their users premium information management services for premium prices. Examples of such xSPs include, but are not limited to, Internet service providers (“ISPs”), application service providers (“ASPs”), content delivery service providers (“CDSPs”), storage service providers (“SSPs”), content providers (“CPs”), Portals, etc.

Certain embodiments of the disclosed systems and methods may be advantageously employed in network computing system environments to enable differentiated service provisioning, for example, in accordance with business objectives. Examples of types of differentiated service provisioning that may be implemented include, but are not limited to, re-provisioned and real time system resource allocation and management, service, metering, billing, etc. In other embodiments disclosed herein, monitoring, tracking and/or reporting features may be implemented in network computing system environments. Advantageously, these functions may be implemented at the resource, platform subsystem, platform, and/or application levels, to fit the needs of particular network environments. In other examples, features that may be implemented include, but are not limited to, system and Service Level Agreement (SLA) performance reporting, content usage tracking and reporting (e.g., identity of content accessed, identity of user accessing the content, bandwidth at which the content is accessed, frequency and/or time of day of access to the content, etc.), bill generation and/or billing information reporting, etc. Advantageously, the disclosed systems and methods make possible the delivery of such differentiated information management features at the edge of a network (e.g., across single or multiple nodes), for example, by using SLA policies to control system resource allocation to service classes (e.g., packet processing) at the network edge, etc.

In one disclosed embodiment, an information management system platform may be provided that is capable of delivering content, applications and/or services to a network with service guarantees specified through policies. Such a system platform may be advantageously employed to provide an overall network infrastructure the ability to provide differentiated services for bandwidth consumptive applications from the xSP standpoint, advantageously allowing implementation of rich media audio and video content delivery applications on such networks.

In a further embodiment disclosed herein, a separate operating system or operating system method may be provided that is inherently optimized to allow standard/traditional network-connected compute system applications (or other applications designed for traditional I/O intensive environments) to be run without modification on the disclosed systems having multi-layer asymmetrical processing architecture, although optional modifications and further optimization are possible if so desired. Examples include, but are not limited to, applications related to streaming, HTTP, storage networking (network attached storage (NAS), storage area network (SAN), combinations thereof, etc.), data base, caching, life sciences, etc.

In yet another embodiment disclosed herein, a utility-based computing process may be implemented to manage information and provide differentiated service using a process that includes provisioning of resources (e.g., based on SLA policies), tracking and logging of provisioning statistics (e.g., to measure how well SLA policies have been met), and transmission of periodic logs to a billing system (e.g., for SLA verification, future resource allocation, bill generation, etc.). Such a process may also be implemented so as to be scalable to bandwidth requirements (network (NET), compute, storage elements, etc.), may be deterministic at various system levels (below the operating system level, at the application level, at the subsystem or subscriber flow level, etc.), may be implemented across all applications hosted (HTTP, RTSP, NFS, etc.), as well as across multiple users and multiple applications, systems, and operating system configurations.

Advantageously, the scalable and deterministic aspects of certain embodiments disclosed herein may be implemented in a way so as to offer surprising and significant advantages with regard to differentiated service, while at the same time providing reduced total cost of system use, and increased performance for system cost relative to traditional computing and network systems. Further, these scalable and deterministic features may be used to provide information management systems capable of performing differentiated service functions or tasks such as service prioritization, monitoring, and reporting functions in a fixed hardware implementation platform, variable hardware implementation platform or distributed set of platforms (either full system or distributed subsystems across a network), and which may be further configured to be capable of delivering such features at the edge of a network in a manner that is network transport independent.

In one specific example, deterministic management of information may be implemented to extend network traffic management principles to achieve a true end-to-end quality experience, for example, all the way to the stored content in a content delivery system environment. For example, the disclosed systems and methods may be implemented in one embodiment to provide differentiated service functions or tasks (e.g., that may be content-aware, user-aware, application-aware, etc.) in a storage spindle-to-WAN edge router environment, and in doing so make possible the delivery of differentiated information services and/or differentiated business services.

In other embodiments, distributed interconnects may be employed in information management environments to distribute functionality, for example, among processing engines of an information management system and/or processing modules thereof Distributive interconnects such as switch fabrics and virtual distributed interconnect backplanes, may be employed to establish independent paths from node to node and thus may be used to facilitate parallel and independent operation of each processing engine of a multi-processing engine information management system, e.g., to provide peer-to-peer communication between the engines on an as-needed basis.

In one respect, disclosed herein is a system for loading an executable image on to at least one image receiver, the system including at least one image source, the image source having access to at least one executable image; and the system also including at least one image receiver coupled to the at least one image source by a distributed interconnect, with the at least one image source being capable of communicating the executable image to the at least one image receiver across the distributed interconnect for loading on to the at least one image receiver. Exemplary types of distributed interconnects that may be employed in the system include, but are not limited to, at least one of a switch fabric, a virtual distributed interconnect, or a combination thereof.

In another respect, disclosed herein is a method of loading an executable image on to at least one image receiver. The method may include the steps of: communicating the executable image from at least one image source to the at least one image receiver; and loading the executable image on to the image receiver; with the at least one image source and the at least one image receiver being coupled together by a distributed interconnect, and with the executable image being communicated from the at least one image source to the at least one image receiver across the distributed interconnect. Exemplary types of distributed interconnects that may be employed in the practice of the method include, but are not limited to, at least one of a switch fabric, a virtual distributed interconnect, or a combination thereof.

In another respect, disclosed herein is a system for interfacing a first processing object with a second processing object, the system including: a first processing engine, the first processing engine having the first processing object residing thereon; and a second processing engine coupled to the first processing engine by a distributed interconnect, the second processing engine having the second processing object residing thereon; with the second processing object being specific to the first processing object, and with the first object being capable of interfacing with the second object across the distributed interconnect. Exemplary types of distributed interconnects that may be employed in the system include, but are not limited to, at least one of a switch fabric, a virtual distributed interconnect, or a combination thereof.

In another respect, disclosed herein is a method of interfacing a first processing object with a second processing object, the method including interfacing the second processing object with the first processing object across a distributed interconnect; with the second processing object being specific to the first processing object. Exemplary types of distributed interconnects that may be employed in the practice of the method include, but are not limited to, at least one of a switch fabric, a virtual distributed interconnect, or a combination thereof.

In another respect, disclosed herein is a system for managing a processing object, the system including: a first processing engine, the first processing engine having at least one first processing object residing thereon; and a management entity coupled to the first processing engine by a distributed interconnect, the management entity capable of managing the first processing object residing on the first processing engine across the distributed interconnect. Exemplary types of distributed interconnects that may be employed in the system include, but are not limited to, at least one of a switch fabric, a virtual distributed interconnect, or a combination thereof.

In another respect, disclosed herein is a method of managing at least one processing object, the method including managing the processing object across a distributed interconnect. Exemplary types of distributed interconnects that may be employed in the practice of the method include, but are not limited to, at least one of a switch fabric, a virtual distributed interconnect, or a combination thereof.

In another respect, disclosed herein is a method of coordinating a group of multiple processing engines in the performance of an operating task, the method including broadcasting a multicast message to the group of multiple processing engines across a distributed interconnect, the multicast facilitating the performance of the operating task. Exemplary types of distributed interconnects that may be employed in the practice of the method include, but are not limited to, at least one of a switch fabric, a virtual distributed interconnect, or a combination thereof.

In another respect, disclosed herein is a method of analyzing software code running on a first processing engine, the method including communicating debug information associated with the code from the first processing engine to a second processing engine across a distributed interconnect. Exemplary types of distributed interconnects that may be employed in the practice of the method include, but are not limited to, at least one of a switch fabric, a virtual distributed interconnect, or a combination thereof.

In another respect, disclosed herein is a method of managing the manipulation of information among a group of multiple processing engines in an information management environment, each of the processing engines being capable of performing one or more information manipulation tasks, the method including: receiving first and second requests for information management; selecting a first processing flow path among the group of processing engines in order to perform a first selected combination of information manipulation tasks associated with the first request for information management; and selecting a second processing flow path among the group of processing engines in order to perform a second selected combination of information manipulation tasks associated with the second request for information management; wherein the group of multiple processing engines are coupled together by a distributed interconnect, wherein the first processing flow path may be different from the second processing flow path, and wherein the first and second processing flow paths are each selected using the distributed interconnect. Exemplary types of distributed interconnects that may be employed in the practice of the method include, but are not limited to, at least one of a switch fabric, a virtual distributed interconnect, or a combination thereof.

### BRIEF DESCRIPTION OF THE DRAWINGS

FIG. 1A is a representation of components of a content delivery system according to one embodiment of the disclosed content delivery system.

FIG. 1B is a representation of data flow between modules of a content delivery system of FIG. 1A according to one embodiment of the disclosed content delivery system.

FIG. 1C is a simplified schematic diagram showing one possible network content delivery system hardware configuration.

FIG. 1D is a simplified schematic diagram showing a network content delivery engine configuration possible with the network content delivery system hardware configuration of FIG. 1C.

FIG. 1E is a simplified schematic diagram showing an alternate network content delivery engine configuration possible with the network content delivery system hardware configuration of FIG. 1C.

FIG. 1F is a simplified schematic diagram showing another alternate network content delivery engine configuration possible with the network content delivery system hardware configuration of FIG. 1C.

FIGS. 1G-1J illustrate exemplary clusters of network content delivery systems.

FIG. 2 is a simplified schematic diagram showing another possible network content delivery system configuration.

FIG. 2A is a simplified schematic diagram showing a network endpoint computing system.

FIG. 2B is a simplified schematic diagram showing a network endpoint computing system.

FIG. 3 is a functional block diagram of an exemplary network processor.

FIG. 4 is a functional block diagram of an exemplary interface between a switch fabric and a processor.

FIG. 5 is a flow chart illustrating a method for the deterministic delivery of content according to one embodiment of the present invention.

FIG. 6 is a simplified schematic diagram illustrating a data center operable to perform deterministic delivery of content according to one embodiment of the present invention.

FIG. 7 is a simplified representation illustrating interrelation of various functional components of an information management system and method for delivering differentiated service according to one embodiment of the present invention.

FIG. 8 is a flow chart illustrating a method of providing differentiated service based on defined business objectives according to one embodiment of the present invention.

FIG. 9A is a simplified representation illustrating an endpoint information management node and data center connected to a network according to one embodiment of the disclosed content delivery system.

FIG. 9B is a simplified representation illustrating a traffic management node connected to a network according to one embodiment of the disclosed content delivery system.

FIG. 9C is a simplified representation of multiple edge content delivery nodes connected to a network according to one embodiment of the disclosed content delivery system.

FIG. 9D is a representation of components of an information management system interconnected across a network according to one embodiment of the disclosed content delivery system.

FIG. 10 is a simplified representation of an initial image source coupled to image receiver via a distributed interconnect according to one embodiment of the disclosed systems and methods.

FIG. 11 is a simplified representation of a first processing engine coupled to a second processing engine via a distributed interconnect according to one embodiment of the disclosed systems and methods.

FIG. 12 is a simplified representation of multiple first processing engines coupled to multiple second processing engines via a distributed interconnect according to one embodiment of the disclosed systems and methods.

FIG. 13 is a representation of data flow between modules of a content delivery system across a distributed interconnect according to one embodiment of the disclosed systems and methods.

FIG. 14 is a representation of data flow between modules of a content delivery system across a distributed interconnect according to one embodiment of the disclosed systems and methods.

FIG. 15 is a representation of data flow between modules of a content delivery system across a distributed interconnect according to one embodiment of the disclosed systems and methods.

FIG. 16 is a representation of data flow between modules of a content delivery system across a distributed interconnect according to one embodiment of the disclosed systems and methods.

### DESCRIPTION OF ILLUSTRATIVE EMBODIMENTS

Disclosed herein are systems and methods for operating network connected computing systems. The network connected computing systems disclosed provide a more efficient use of computing system resources and provide improved performance as compared to traditional network connected computing systems. Network connected computing systems may include network endpoint systems. The systems and methods disclosed herein may be particularly beneficial for use in network endpoint systems. Network endpoint systems may include a wide variety of computing devices, including but not limited to, classic general purpose servers, specialized servers, network appliances, storage area networks or other storage medium, content delivery systems, corporate data centers, application service providers, home or laptop computers, clients, any other device that operates as an endpoint network connection, etc.

Other network connected systems may be considered a network intermediate node system. Such systems are generally connected to some node of a network that may operate in some other fashion than an endpoint. Typical examples include network switches or network routers. Network intermediate node systems may also include any other devices coupled to intermediate nodes of a network.

Further, some devices may be considered both a network intermediate node system and a network endpoint system. Such hybrid systems may perform both endpoint functionality and intermediate node functionality in the same device. For example, a network switch that also performs some endpoint functionality may be considered a hybrid system. As used herein such hybrid devices are considered to be a network endpoint system and are also considered to be a network intermediate node system.

For ease of understanding, the systems and methods disclosed herein are described with regards to an illustrative network connected computing system. In the illustrative example the system is a network endpoint system optimized for a content delivery application. Thus a content delivery system is provided as an illustrative example that demonstrates the structures, methods, advantages and benefits of the network computing system and methods disclosed herein. Content delivery systems (such as systems for serving streaming content, HTTP content, cached content, etc.) generally have intensive input/output demands.

It will be recognized that the hardware and methods discussed below may be incorporated into other hardware or applied to other applications. For example with respect to hardware, the disclosed system and methods may be utilized in network switches. Such switches may be considered to be intelligent or smart switches with expanded functionality beyond a traditional switch. Referring to the content delivery application described in more detail herein, a network switch may be configured to also deliver at least some content in addition to traditional switching functionality. Thus, though the system may be considered primarily a network switch (or some other network intermediate node device), the system may incorporate the hardware and methods disclosed herein. Likewise a network switch performing applications other than content delivery may utilize the systems and methods disclosed herein. The nomenclature used for devices utilizing the concepts of the present invention may vary. The network switch or router that includes the content delivery system disclosed herein may be called a network content switch or a network content router or the like. Independent of the nomenclature assigned to a device, it will be recognized that the network device may incorporate some or all of the concepts disclosed herein.

The disclosed hardware and methods also may be utilized in storage area networks, network attached storage, channel attached storage systems, disk arrays, tape storage systems, direct storage devices or other storage systems. In this case, a storage system having the traditional storage system functionality may also include additional functionality utilizing the hardware and methods shown herein. Thus, although the system may primarily be considered a storage system, the system may still include the hardware and methods disclosed herein. The disclosed hardware and methods of the present invention also may be utilized in traditional personal computers, portable computers, servers, workstations, mainframe computer systems, or other computer systems. In this case, a computer system having the traditional computer system functionality associated with the particular type of computer system may also include additional functionality utilizing the hardware and methods shown herein. Thus, although the system may primarily be considered to be a particular type of computer system, the system may still include the hardware and methods disclosed herein.

As mentioned above, the benefits of the present invention are not limited to any specific tasks or applications. The content delivery applications described herein are thus illustrative only. Other tasks and applications that may incorporate the principles of the present invention include, but are not limited to, database management systems, application service providers, corporate data centers, modeling and simulation systems, graphics rendering systems, other complex computational analysis systems, etc. Although the principles of the present invention may be described with respect to a specific application, it will be recognized that many other tasks or applications performed with the hardware and methods.

Disclosed herein are systems and methods for delivery of content to computer-based networks that employ functional multi-processing using a “staged pipeline” content delivery environment to optimize bandwidth utilization and accelerate content delivery while allowing greater determination in the data traffic management. The disclosed systems may employ individual modular processing engines that are optimized for different layers of a software stack. Each individual processing engine may be provided with one or more discrete subsystem modules configured to run on their own optimized platform and/or to function in parallel with one or more other subsystem modules across a high speed distributive interconnect, such as a switch fabric, that allows peer-to-peer communication between individual subsystem modules. The use of discrete subsystem modules that are distributively interconnected in this manner advantageously allows individual resources (e.g., processing resources, memory resources) to be deployed by sharing or reassignment in order to maximize acceleration of content delivery by the content delivery system. The use of a scalable packet-based interconnect, such as a switch fabric, advantageously allows the installation of additional subsystem modules without significant degradation of system performance. Furthermore, policy enhancement/enforcement may be optimized by placing intelligence in each individual modular processing engine.

The network systems disclosed herein may operate as network endpoint systems. Examples of network endpoints include, but are not limited to, servers, content delivery systems, storage systems, application service providers, database management systems, corporate data center servers, etc. A client system is also a network endpoint, and its resources may typically range from those of a general purpose computer to the simpler resources of a network appliance. The various processing units of the network endpoint system may be programmed to achieve the desired type of endpoint.

Some embodiments of the network endpoint systems disclosed herein are network endpoint content delivery systems. The network endpoint content delivery systems may be utilized in replacement of or in conjunction with traditional network servers. A “server” can be any device that delivers content, services, or both. For example, a content delivery server receives requests for content from remote browser clients via the network, accesses a file system to retrieve the requested content, and delivers the content to the client. As another example, an applications server may be programmed to execute applications software on behalf of a remote client, thereby creating data for use by the client. Various server appliances are being developed and often perform specialized tasks.

As will be described more fully below, the network endpoint system disclosed herein may include the use of network processors. Though network processors conventionally are designed and utilized at intermediate network nodes, the network endpoint system disclosed herein adapts this type of processor for endpoint use.

The network endpoint system disclosed may be construed as a switch based computing system. The system may further be characterized as an asymmetric multi-processor system configured in a staged pipeline manner.

Exemplary System Overview

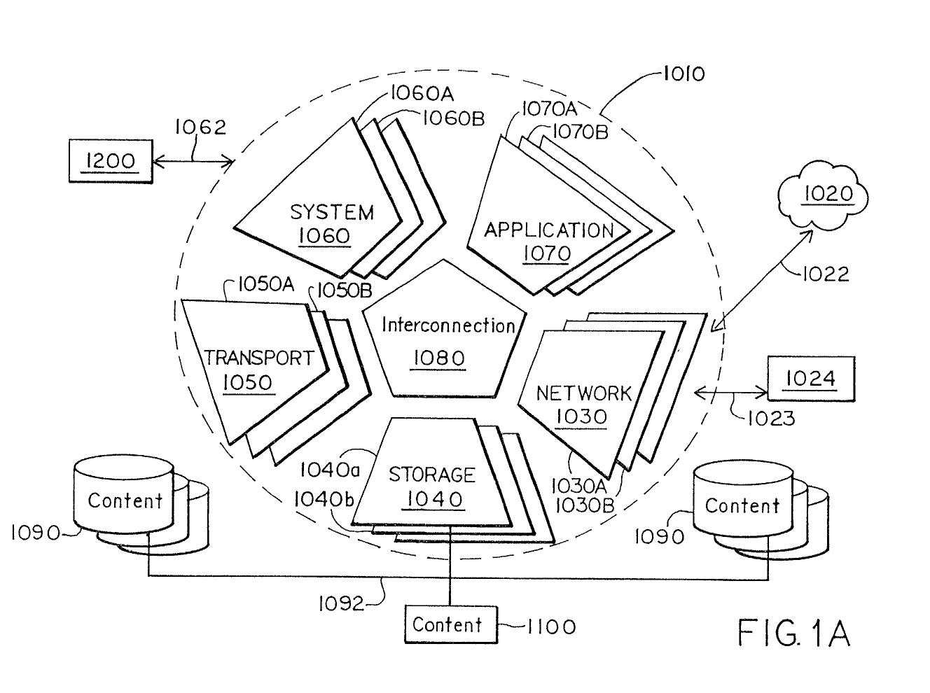

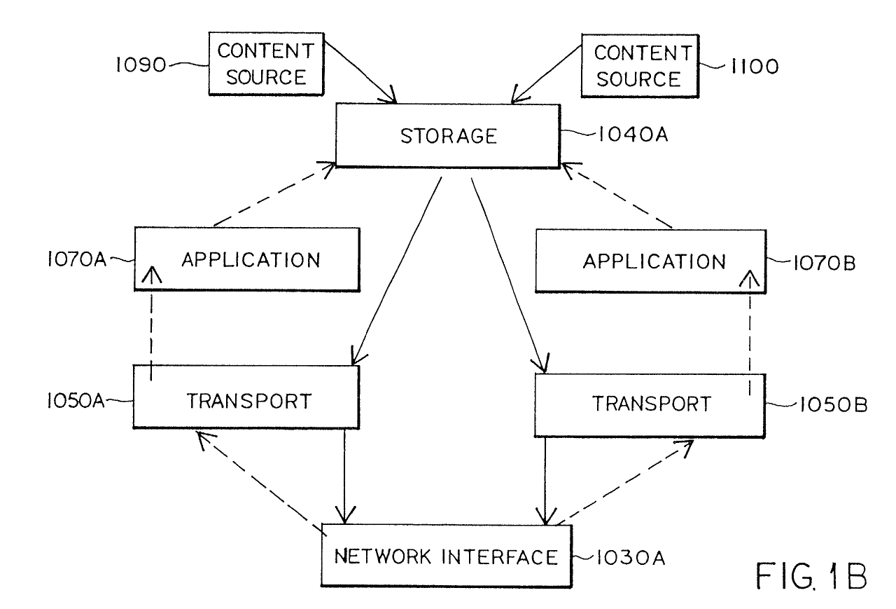

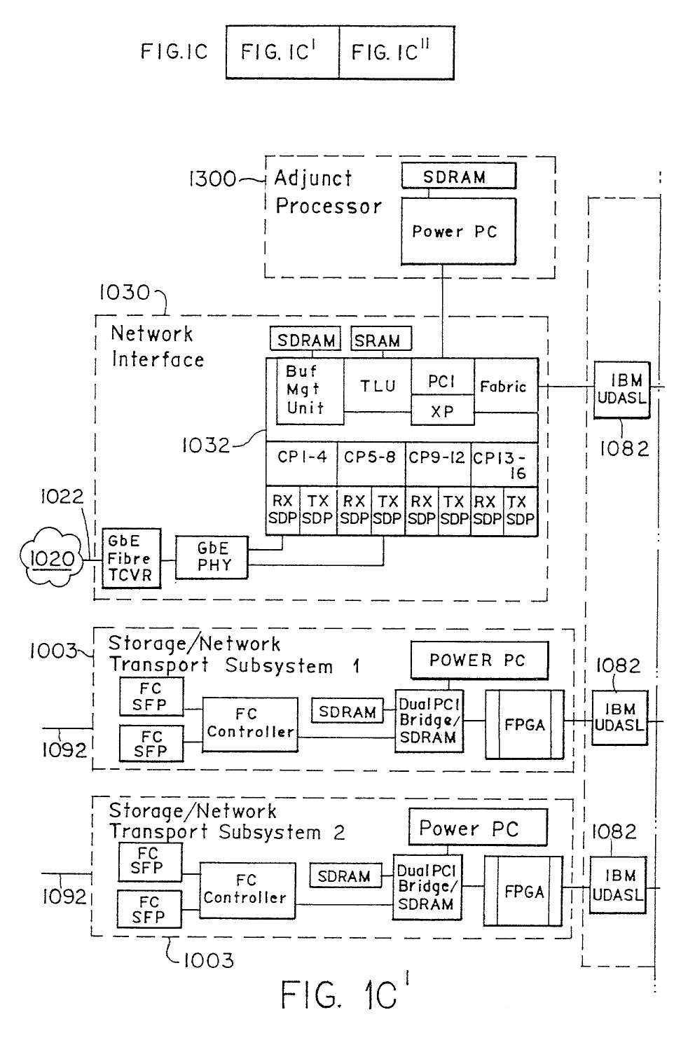

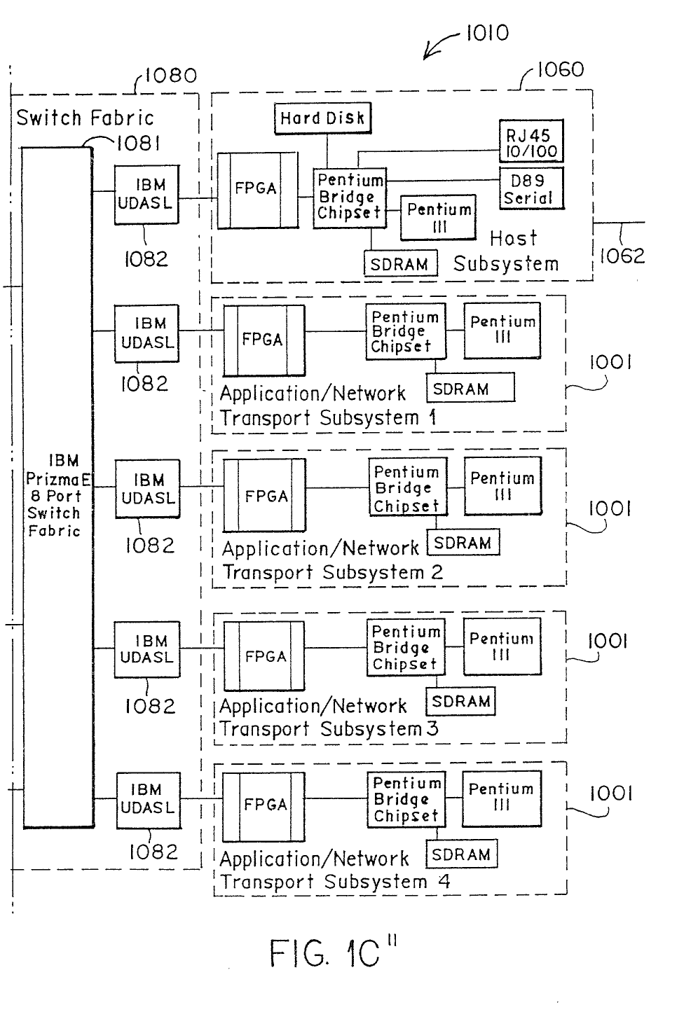

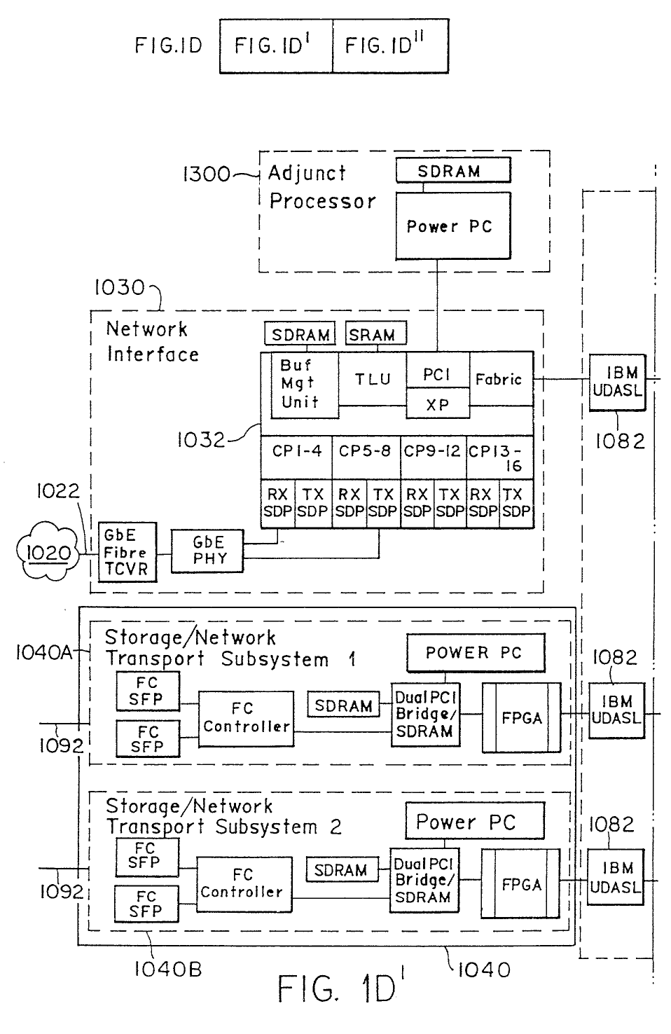

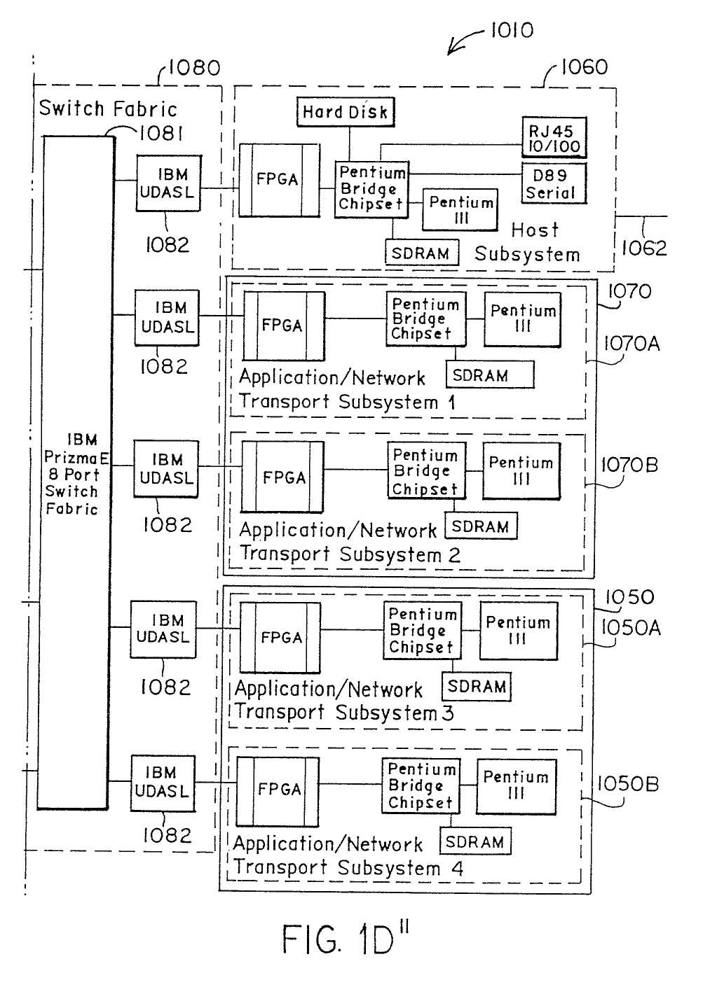

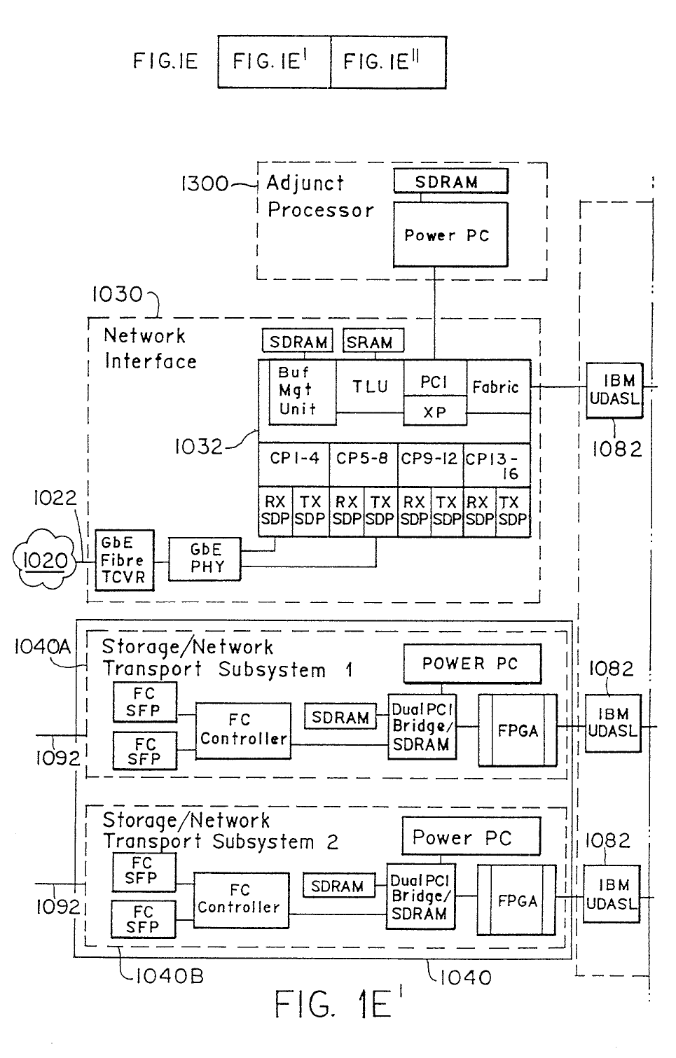

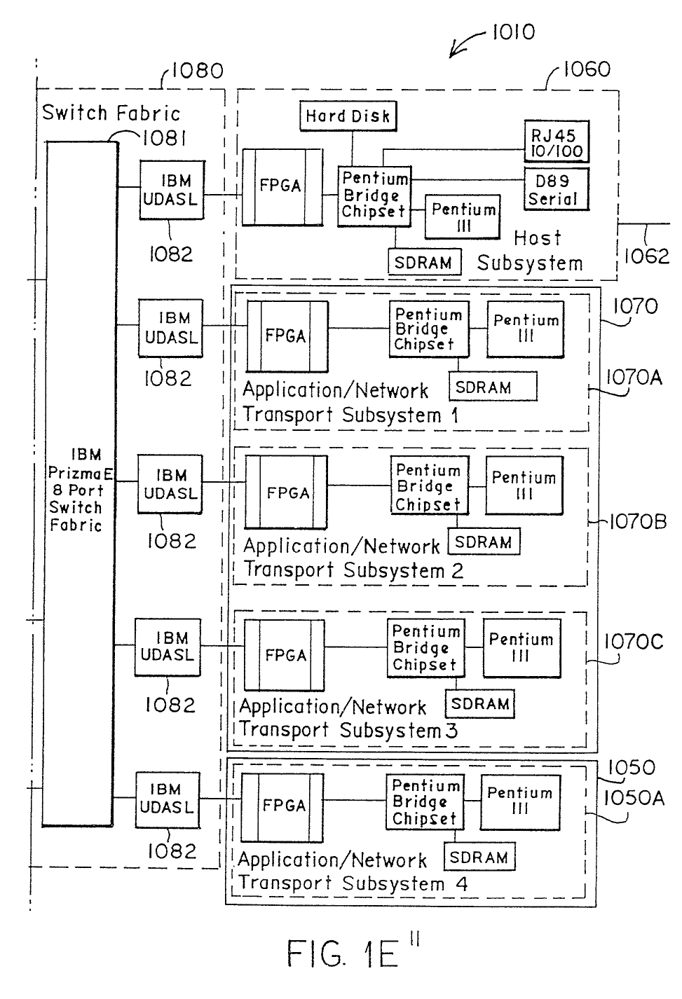

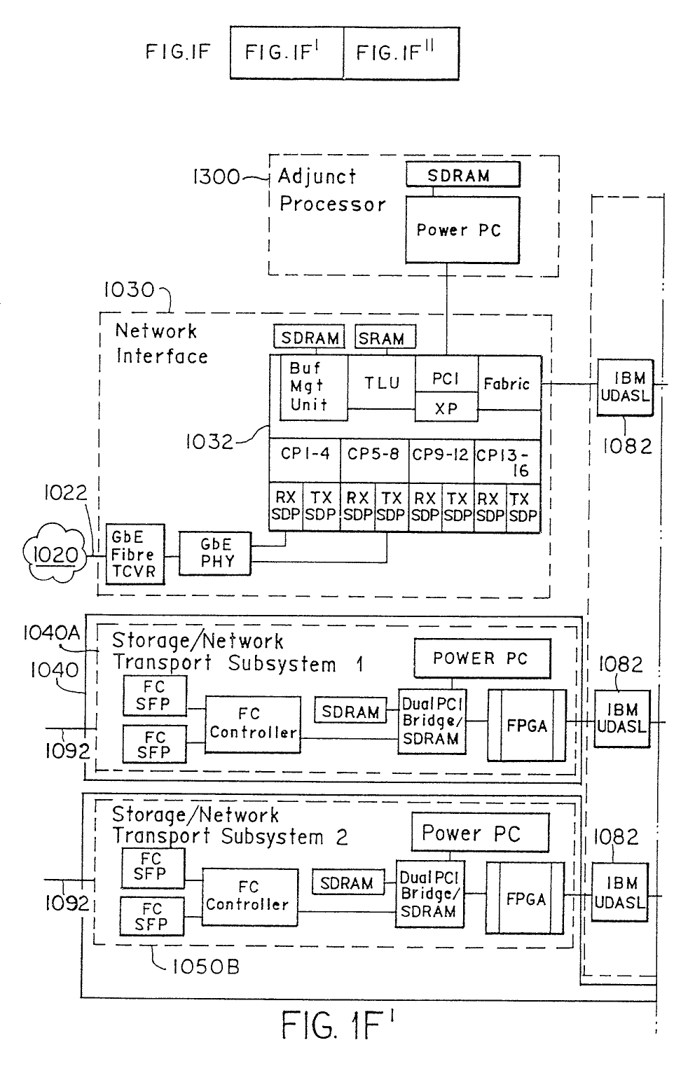

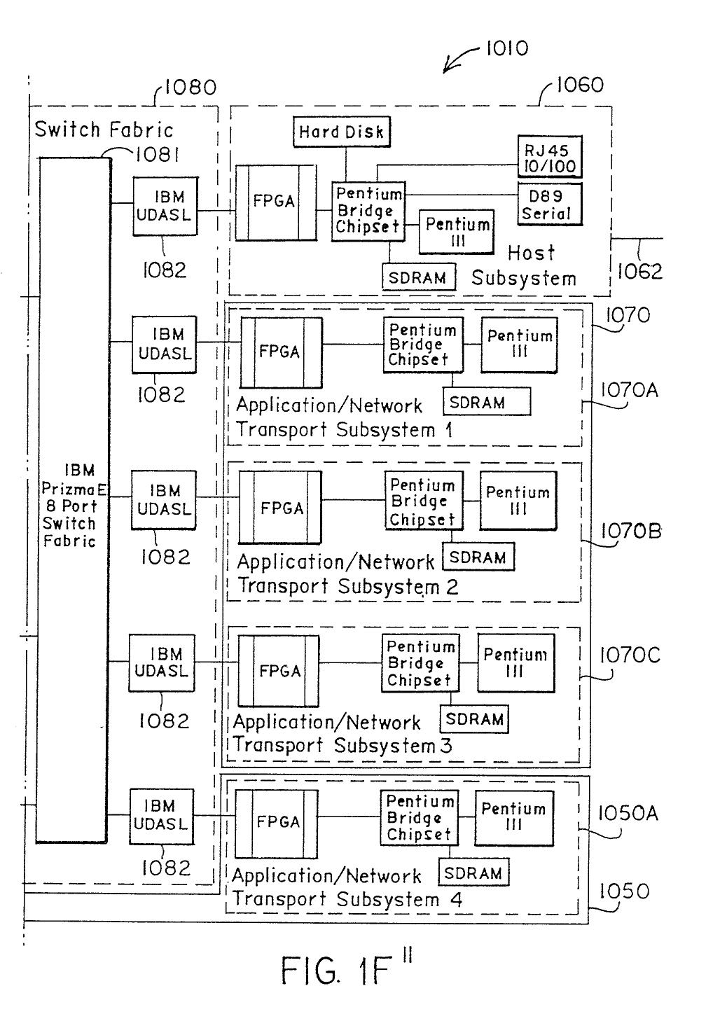

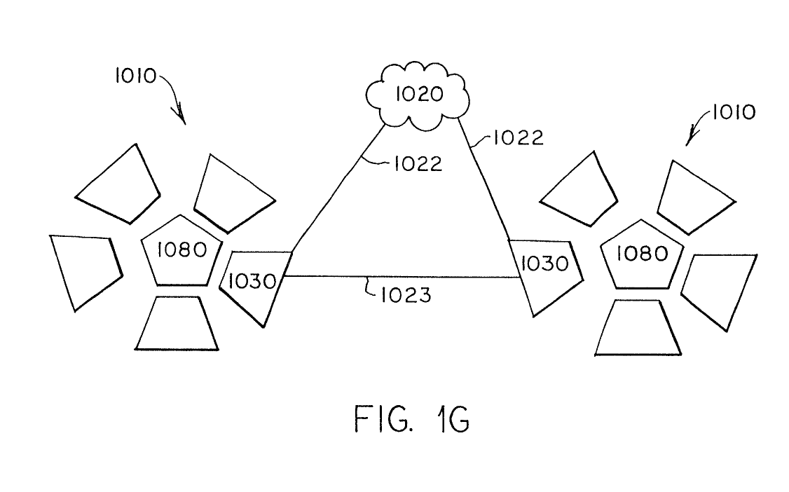

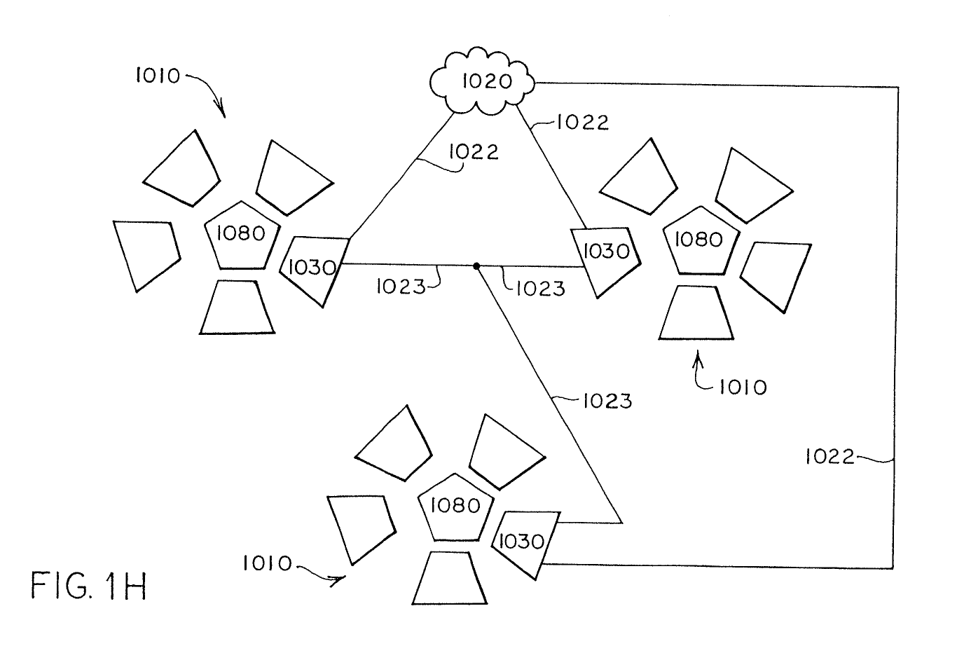

FIG. 1A is a representation of one embodiment of a content delivery system 1010, for example as may be employed as a network endpoint system in connection with a network 1020. Network 1020 may be any type of computer network suitable for linking computing systems. Content delivery system 1010 may be coupled to one or more networks including, but not limited to, the public internet, a private intranet network (e.g., linking users and hosts such as employees of a corporation or institution), a wide area network (WAN), a local area network (LAN), a wireless network, any other client based network or any other network environment of connected computer systems or online users. Thus, the data provided from the network 1020 may be in any networking protocol. In one embodiment, network 1020 may be the public internet that serves to provide access to content delivery system 1010 by multiple online users that utilize internet web browsers on personal computers operating through an internet service provider. In this case the data is assumed to follow one or more of various Internet Protocols, such as TCP/IP, UDP, HTTP, RTSP, SSL, FTP, etc. However, the same concepts apply to networks using other existing or future protocols, such as IPX, SNMP, NetBios, Ipv6, etc. The concepts may also apply to file protocols such as network file system (NFS) or common internet file system (CIFS) file sharing protocol.

Examples of content that may be delivered by content delivery system 1010 include, but are not limited to, static content (e.g., web pages, MP3 files, HTTP object files, audio stream files, video stream files, etc.), dynamic content, etc. In this regard, static content may be defined as content available to content delivery system 1010 via attached storage devices and as content that does not generally require any processing before delivery. Dynamic content, on the other hand, may be defined as content that either requires processing before delivery, or resides remotely from content delivery system 1010. As illustrated in FIG. 1A, content sources may include, but are not limited to, one or more storage devices 1090 (magnetic disks, optical disks, tapes, storage area networks (SAN's), etc.), other content sources 1100, third party remote content feeds, broadcast sources (live direct audio or video broadcast feeds, etc.), delivery of cached content, combinations thereof, etc. Broadcast or remote content may be advantageously received through second network connection 1023 and delivered to network 1020 via an accelerated fiowpath through content delivery system 1010. As discussed below, second network connection 1023 may be connected to a second network 1024 (as shown). Alternatively, both network connections 1022 and 1023 may be connected to network 1020.

As shown in FIG. 1A, one embodiment of content delivery system 1010 includes multiple system engines 1030, 1040, 1050, 1060, and 1070 communicatively coupled via distributive interconnection 1080. In the exemplary embodiment provided, these system engines operate as content delivery engines. As used herein, “content delivery engine” generally includes any hardware, software or hardware/software combination capable of performing one or more dedicated tasks or sub-tasks associated with the delivery or transmittal of content from one or more content sources to one or more networks. In the embodiment illustrated in FIG. 1A content delivery processing engines (or “processing blades”) include network interface processing engine 1030, storage processing engine 1040, network transport/protocol processing engine 1050 (referred to hereafter as a transport processing engine), system management processing engine 1060, and application processing engine 1070. Thus configured, content delivery system 1010 is capable of providing multiple dedicated and independent processing engines that are optimized for networking, storage and application protocols, each of which is substantially self-contained and therefore capable of functioning without consuming resources of the remaining processing engines.

It will be understood with benefit of this disclosure that the particular number and identity of content delivery engines illustrated in FIG. 1A are illustrative only, and that for any given content delivery system 1010 the number and/or identity of content delivery engines may be varied to fit particular needs of a given application or installation. Thus, the number of engines employed in a given content delivery system may be greater or fewer in number than illustrated in FIG. 1A, and/or the selected engines may include other types of content delivery engines and/or may not include all of the engine types illustrated in FIG. 1A. In one embodiment, the content delivery system 1010 may be implemented within a single chassis, such as for example, a 2U chassis.

Content delivery engines 1030, 1040, 1050, 1060 and 1070 are present to independently perform selected sub-tasks associated with content delivery from content sources 1090 and/or 1100, it being understood however that in other embodiments any one or more of such subtasks may be combined and performed by a single engine, or subdivided to be performed by more than one engine. In one embodiment, each of engines 1030, 1040, 1050, 1060 and 1070 may employ one or more independent processor modules (e.g., CPU modules) having independent processor and memory subsystems and suitable for performance of a given function/s, allowing independent operation without interference from other engines or modules. Advantageously, this allows custom selection of particular processor-types based on the particular sub-task each is to perform, and in consideration of factors such as speed or efficiency in performance of a given subtask, cost of individual processor, etc. The processors utilized may be any processor suitable for adapting to endpoint processing. Any “PC on a board” type device may be used, such as the ×86 and Pentium processors from Intel Corporation, the SPARC processor from Sun Microsystems, Inc., the PowerPC processor from Motorola, Inc. or any other microcontroller or microprocessor. In addition, network processors (discussed in more detail below) may also be utilized. The modular multi-task configuration of content delivery system 1010 allows the number and/or type of content delivery engines and processors to be selected or varied to fit the needs of a particular application.

The configuration of the content delivery system described above provides scalability without having to scale all the resources of a system. Thus, unlike the traditional rack and stack systems, such as server systems in which an entire server may be added just to expand one segment of system resources, the content delivery system allows the particular resources needed to be the only expanded resources. For example, storage resources may be greatly expanded without having to expand all of the traditional server resources.

Distributive Interconnect

Still referring to FIG. 1A, distributive interconnection 1080 may be any multi-node I/O interconnection hardware or hardware/software system suitable for distributing functionality by selectively interconnecting two or more content delivery engines of a content delivery system including, but not limited to, high speed interchange systems such as a switch fabric or bus architecture. Examples of switch fabric architectures include cross-bar switch fabrics, Ethernet switch fabrics, ATM switch fabrics, etc. Examples of bus architectures include PCI, PCI-X, S-Bus, Microchannel, VME, etc. Generally, for purposes of this description, a “bus” is any system bus that carries data in a manner that is visible to all nodes on the bus. Generally, some sort of bus arbitration scheme is implemented and data may be carried in parallel, as n-bit words. As distinguished from a bus, a switch fabric establishes independent paths from node to node and data is specifically addressed to a particular node on the switch fabric. Other nodes do not see the data nor are they blocked from creating their own paths. The result is a simultaneous guaranteed bit rate in each direction for each of the switch fabric's ports.

The use of a distributed interconnect 1080 to connect the various processing engines in lieu of the network connections used with the switches of conventional multi-server endpoints is beneficial for several reasons. As compared to network connections, the distributed interconnect 1080 is less error prone, allows more deterministic content delivery, and provides higher bandwidth connections to the various processing engines. The distributed interconnect 1080 also has greatly improved data integrity and throughput rates as compared to network connections.

Use of the distributed interconnect 1080 allows latency between content delivery engines to be short, finite and follow a known path. Known maximum latency specifications are typically associated with the various bus architectures listed above. Thus, when the employed interconnect medium is a bus, latencies fall within a known range. In the case of a switch fabric, latencies are fixed. Further, the connections are “direct”, rather than by some undetermined path. In general, the use of the distributed interconnect 1080 rather than network connections, permits the switching and interconnect capacities of the content delivery system 1010 to be predictable and consistent.

One example interconnection system suitable for use as distributive interconnection 1080 is an 8/16 port 28.4 Gbps high speed PRIZMA-E non-blocking switch fabric switch available from IBM. It will be understood that other switch fabric configurations having greater or lesser numbers of ports, throughput, and capacity are also possible. Among the advantages offered by such a switch fabric interconnection in comparison to shared-bus interface interconnection technology are throughput, scalability and fast and efficient communication between individual discrete content delivery engines of content delivery system 1010. In the embodiment of FIG. 1A, distributive interconnection 1080 facilitates parallel and independent operation of each engine in its own optimized environment without bandwidth interference from other engines, while at the same time providing peer-to-peer communication between the engines on an as-needed basis (e.g., allowing direct communication between any two content delivery engines 1030, 1040, 1050, 1060 and 1070). Moreover, the distributed interconnect may directly transfer inter-processor communications between the various engines of the system. Thus, communication, command and control information may be provided between the various peers via the distributed interconnect. In addition, communication from one peer to multiple peers may be implemented through a broadcast communication which is provided from one peer to all peers coupled to the interconnect. The interface for each peer may be standardized, thus providing ease of design and allowing for system scaling by providing standardized ports for adding additional peers.

Network Interface Processing Engine

As illustrated in FIG. 1A, network interface processing engine 1030 interfaces with network 1020 by receiving and processing requests for content and delivering requested content to network 1020. Network interface processing engine 1030 may be any hardware or hardware/software subsystem suitable for connections utilizing TCP (Transmission Control Protocol) IP (Internet Protocol), UDP (User Datagram Protocol), RTP (Real-Time Transport Protocol), Internet Protocol (IP), Wireless Application Protocol (WAP) as well as other networking protocols. Thus the network interface processing engine 1030 may be suitable for handling queue management, buffer management, TCP connect sequence, checksum, IP address lookup, internal load balancing, packet switching, etc. Thus, network interface processing engine 1030 may be employed as illustrated to process or terminate one or more layers of the network protocol stack and to perform look-up intensive operations, off loading these tasks from other content delivery processing engines of content delivery system 1010. Network interface processing engine 1030 may also be employed to load balance among other content delivery processing engines of content delivery system 1010. Both of these features serve to accelerate content delivery, and are enhanced by placement of distributive interchange and protocol termination processing functions on the same board. Examples of other functions that may be performed by network interface processing engine 1030 include, but are not limited to, security processing.

With regard to the network protocol stack, the stack in traditional systems may often be rather large. Processing the entire stack for every request across the distributed interconnect may significantly impact performance. As described herein, the protocol stack has been segmented or “split” between the network interface engine and the transport processing engine. An abbreviated version of the protocol stack is then provided across the interconnect. By utilizing this functionally split version of the protocol stack, increased bandwidth may be obtained. In this manner the communication and data flow through the content delivery system 1010 may be accelerated. The use of a distributed interconnect (for example a switch fabric) further enhances this acceleration as compared to traditional bus interconnects.

The network interface processing engine 1030 may be coupled to the network 1020 through a Gigabit (Gb) Ethernet fiber front end interface 1022. One or more additional Gb Ethernet interfaces 1023 may optionally be provided, for example, to form a second interface with network 1020, or to form an interface with a second network or application 1024 as shown (e.g., to form an interface with one or more server/s for delivery of web cache content, etc.). Regardless of whether the network connection is via Ethernet, or some other means, the network connection could be of any type, with other examples being ATM, SONET, or wireless. The physical medium between the network and the network processor may be copper, optical fiber, wireless, etc.

In one embodiment, network interface processing engine 1030 may utilize a network processor, although it will be understood that in other embodiments a network processor may be supplemented with or replaced by a general purpose processor or an embedded microcontroller. The network processor may be one of the various types of specialized processors that have been designed and marketed to switch network traffic at intermediate nodes. Consistent with this conventional application, these processors are designed to process high speed streams of network packets. In conventional operation, a network processor receives a packet from a port, verifies fields in the packet header, and decides on an outgoing port to which it forwards the packet. The processing of a network processor may be considered as “pass through” processing, as compared to the intensive state modification processing performed by general purpose processors. A typical network processor has a number of processing elements, some operating in parallel and some in pipeline. Often a characteristic of a network processor is that it may hide memory access latency needed to perform lookups and modifications of packet header fields. A network processor may also have one or more network interface controllers, such as a gigabit Ethernet controller, and are generally capable of handling data rates at “wire speeds”.

Examples of network processors include the C-Port processor manufactured by Motorola, Inc., the IXP1200 processor manufactured by Intel Corporation, the Prism processor manufactured by SiTera Inc., and others manufactured by MMC Networks, Inc. and Agere, Inc. These processors are programmable, usually with a RISC or augmented RISC instruction set, and are typically fabricated on a single chip.

The processing cores of a network processor are typically accompanied by special purpose cores that perform specific tasks, such as fabric interfacing, table lookup, queue management, and buffer management. Network processors typically have their memory management optimized for data movement, and have multiple I/O and memory buses. The programming capability of network processors permit them to be programmed for a variety of tasks, such as load balancing, network protocol processing, network security policies, and QoS/CoS support. These tasks can be tasks that would otherwise be performed by another processor. For example, TCP/IP processing may be performed by a network processor at the front end of an endpoint system. Another type of processing that could be offloaded is execution of network security policies or protocols. A network processor could also be used for load balancing. Network processors used in this manner can be referred to as “network accelerators” because their front end “look ahead” processing can vastly increase network response speeds. Network processors perform look ahead processing by operating at the front end of the network endpoint to process network packets in order to reduce the workload placed upon the remaining endpoint resources. Various uses of network accelerators are described in the following U.S. patent applications: Ser. No. 09/797,412, filed Mar. 1, 2001 and entitled “Network Transport Accelerator,” by Bailey et. al; Ser. No. 09/797,507 filed Mar. 1, 2001 and entitled “Single Chassis Network Endpoint System With Network Processor For Load Balancing,” by Richter et. al; and Ser. No. 09/797,411 filed Mar. 1, 2001 and entitled “Network Security Accelerator,” by Canion et. al; the disclosures of which are all incorporated herein by reference. When utilizing network processors in an endpoint environment it may be advantageous to utilize techniques for order serialization of information, such as for example, as disclosed in U.S. patent application Ser. No. 09/797,197, filed Mar. 1, 2001 and entitled “Methods and Systems For The Order Serialization Of Information In A Network Processing Environment,” by Richter et. al, the disclosure of which is incorporated herein by reference.

FIG. 3 illustrates one possible general configuration of a network processor. As illustrated, a set of traffic processors 21 operate in parallel to handle transmission and receipt of network traffic. These processors may be general purpose microprocessors or state machines. Various core processors 22-24 handle special tasks. For example, the core processors 22-24 may handle lookups, checksums, and buffer management. A set of serial data processors 25 provide Layer 1 network support. Interface 26 provides the physical interface to the network 1020. A general purpose bus interface 27 is used for downloading code and configuration tasks. A specialized interface 28 may be specially programmed to optimize the path between network processor 12 and distributed interconnection 1080.

As mentioned above, the network processors utilized in the content delivery system 1010 are utilized for endpoint use, rather than conventional use at intermediate network nodes. In one embodiment, network interface processing engine 1030 may utilize a MOTOROLA C-Port C-5 network processor capable of handling two Gb Ethernet interfaces at wire speed, and optimized for cell and packet processing. This network processor may contain sixteen 200 MHz MIPS processors for cell/packet switching and thirty-two serial processing engines for bit/byte processing, checksum generation/verification, etc. Further processing capability may be provided by five co-processors that perform the following network specific tasks: supervisor/executive, switch fabric interface, optimized table lookup, queue management, and buffer management. The network processor may be coupled to the network 1020 by using a VITESSE GbE SERDES (serializer-deserializer) device (for example the VSC7123) and an SFP (small form factor pluggable) optical transceiver for LC fiber connection.

Transport/Protocol Processing Engine

Referring again to FIG. 1A, transport processing engine 1050 may be provided for performing network transport protocol sub-tasks, such as processing content requests received from network interface engine 1030. Although named a “transport” engine for discussion purposes, it will be recognized that the engine 1050 performs transport and protocol processing and the term transport processing engine is not meant to limit the functionality of the engine. In this regard transport processing engine 1050 may be any hardware or hardware/software subsystem suitable for TCP/UDP processing, other protocol processing, transport processing, etc. In one embodiment transport engine 1050 may be a dedicated TCP/UDP processing module based on an INTEL PENTIUM III or MOTOROLA POWERPC 7450 based processor running the Thread-X RTOS environment with protocol stack based on TCP/IP technology.

As compared to traditional server type computing systems, the transport processing engine 1050 may off-load other tasks that traditionally a main CPU may perform. For example, the performance of server CPUs significantly decreases when a large amount of network connections are made merely because the server CPU regularly checks each connection for time outs. The transport processing engine 1050 may perform time out checks for each network connection, session management, data reordering and retransmission, data queuing and flow control, packet header generation, etc. off-loading these tasks from the application processing engine or the network interface processing engine. The transport processing engine 1050 may also handle error checking, likewise freeing up the resources of other processing engines.

Network Interface/Transport Split Protocol

The embodiment of FIG. 1A contemplates that the protocol processing is shared between the transport processing engine 1050 and the network interface engine 1030. This sharing technique may be called “split protocol stack” processing. The division of tasks may be such that higher tasks in the protocol stack are assigned to the transport processor engine. For example, network interface engine 1030 may processes all or some of the TCP/IP protocol stack as well as all protocols lower on the network protocol stack. Another approach could be to assign state modification intensive tasks to the transport processing engine.

In one embodiment related to a content delivery system that receives packets, the network interface engine performs the MAC header identification and verification, IP header identification and verification, IP header checksum validation, TCP and UDP header identification and validation, and TCP or UDP checksum validation. It also may perform the lookup to determine the TCP connection or UDP socket (protocol session identifier) to which a received packet belongs. Thus, the network interface engine verifies packet lengths, checksums, and validity. For transmission of packets, the network interface engine performs TCP or UDP checksum generation, IP header generation, and MAC header generation, IP checksum generation, MAC FCS/CRC generation, etc.

Tasks such as those described above can all be performed rapidly by the parallel and pipeline processors within a network processor. The “fly by” processing style of a network processor permits it to look at each byte of a packet as it passes through, using registers and other alternatives to memory access. The network processor's “stateless forwarding” operation is best suited for tasks not involving complex calculations that require rapid updating of state information.

An appropriate internal protocol may be provided for exchanging information between the network interface engine 1030 and the transport engine 1050 when setting up or terminating a TCP and/or UDP connections and to transfer packets between the two engines. For example, where the distributive interconnection medium is a switch fabric, the internal protocol may be implemented as a set of messages exchanged across the switch fabric. These messages indicate the arrival of new inbound or outbound connections and contain inbound or outbound packets on existing connections, along with identifiers or tags for those connections. The internal protocol may also be used to transfer identifiers or tags between the transport engine 1050 and the application processing engine 1070 and/or the storage processing engine 1040. These identifiers or tags may be used to reduce or strip or accelerate a portion of the protocol stack.

For example, with a TCP/IP connection, the network interface engine 1030 may receive a request for a new connection. The header information associated with the initial request may be provided to the transport processing engine 1050 for processing. That result of this processing may be stored in the resources of the transport processing engine 1050 as state and management information for that particular network session. The transport processing engine 1050 then informs the network interface engine 1030 as to the location of these results. Subsequent packets related to that connection that are processed by the network interface engine 1030 may have some of the header information stripped and replaced with an identifier or tag that is provided to the transport processing engine 1050. The identifier or tag may be a pointer, index or any other mechanism that provides for the identification of the location in the transport processing engine of the previously setup state and management information (or the corresponding network session). In this manner, the transport processing engine 1050 does not have to process the header information of every packet of a connection. Rather, the transport interface engine merely receives a contextually meaningful identifier or tag that identifies the previous processing results for that connection.

In one embodiment, the data link, network, transport and session layers (layers 2-5) of a packet may be replaced by identifier or tag information. For packets related to an established connection the transport processing engine does not have to perform intensive processing with regard to these layers such as hashing, scanning, look up, etc. operations. Rather, these layers have already been converted (or processed) once in the transport processing engine and the transport processing engine just receives the identifier or tag provided from the network interface engine that identifies the location of the conversion results.

In this manner an identifier label or tag is provided for each packet of an established connection so that the more complex data computations of converting header information may be replaced with a more simplistic analysis of an identifier or tag. The delivery of content is thereby accelerated, as the time for packet processing and the amount of system resources for packet processing are both reduced. The functionality of network processors, which provide efficient parallel processing of packet headers, is well suited for enabling the acceleration described herein. In addition, acceleration is further provided as the physical size of the packets provided across the distributed interconnect may be reduced.

Though described herein with reference to messaging between the network interface engine and the transport processing engine, the use of identifiers or tags may be utilized amongst all the engines in the modular pipelined processing described herein. Thus, one engine may replace packet or data information with contextually meaningful information that may require less processing by the next engine in the data and communication flow path. In addition, these techniques may be utilized for a wide variety of protocols and layers, not just the exemplary embodiments provided herein.

With the above-described tasks being performed by the network interface engine, the transport engine may perform TCP sequence number processing, acknowledgement and retransmission, segmentation and reassembly, and flow control tasks. These tasks generally call for storing and modifying connection state information on each TCP and UDP connection, and therefore are considered more appropriate for the processing capabilities of general purpose processors.

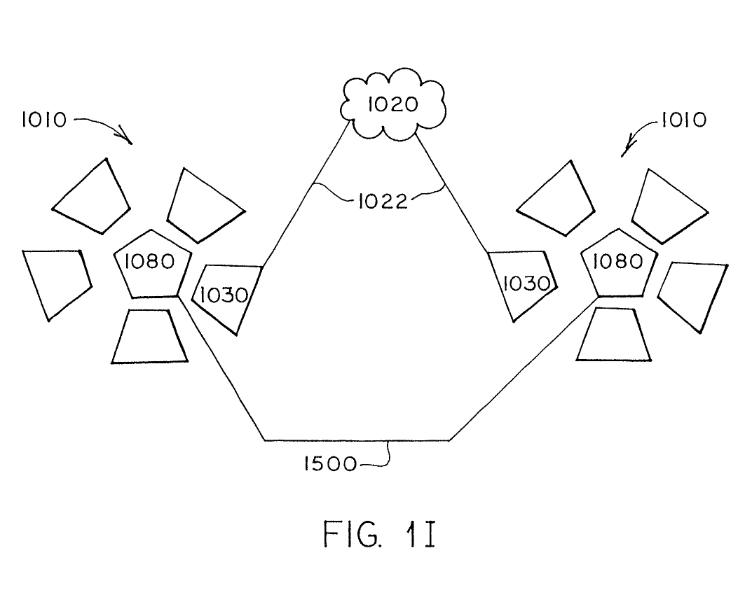

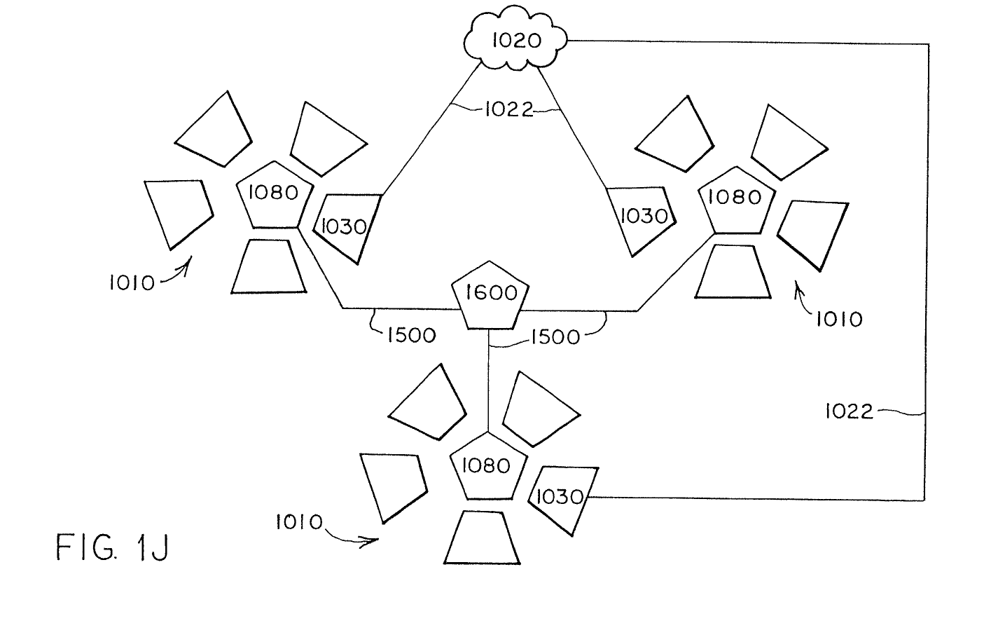

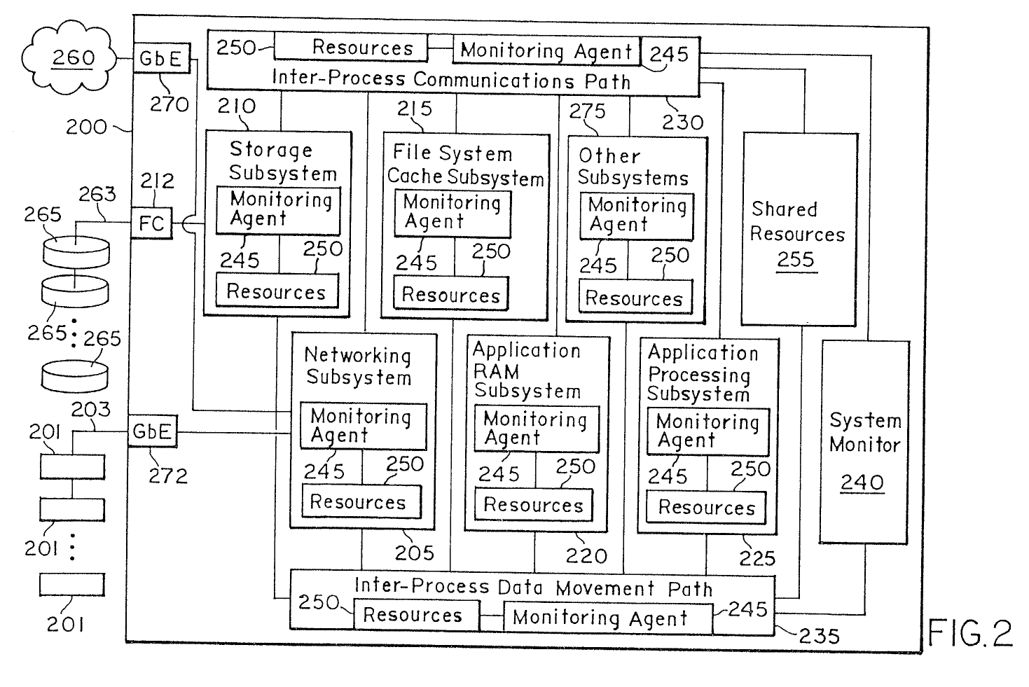

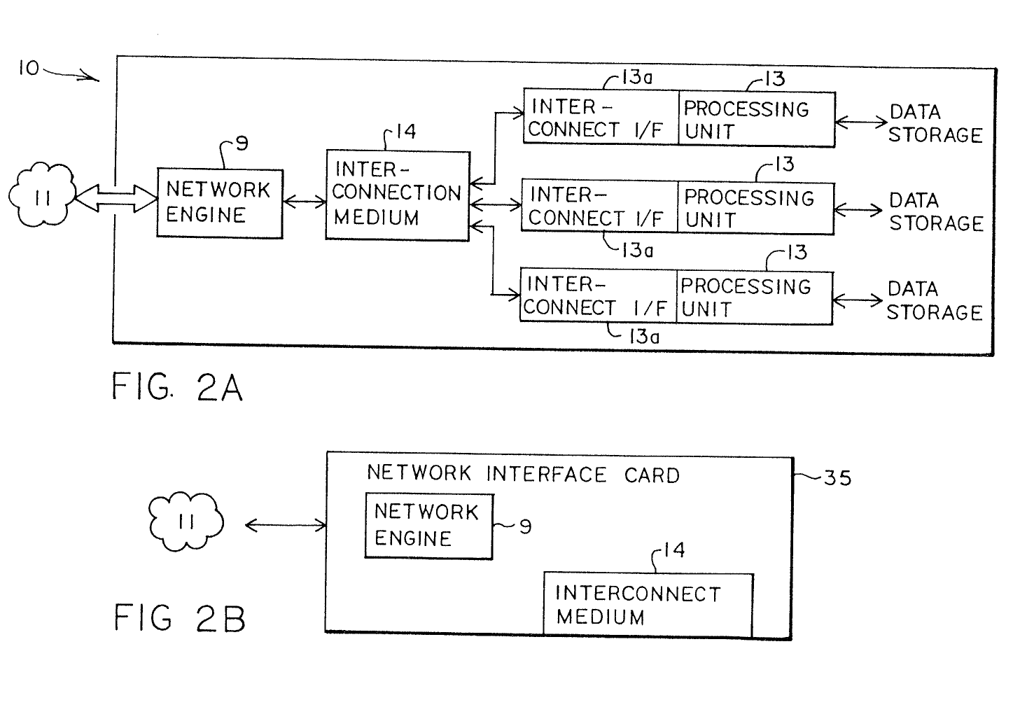

As will be discussed with references to alternative embodiments (such as FIGS. 2 and 2A), the transport engine 1050 and the network interface engine 1030 may be combined into a single engine. Such a combination may be advantageous as communication across the switch fabric is not necessary for protocol processing. However, limitations of many commercially available network processors make the split protocol stack processing described above desirable.

Application Processing Engine

Application processing engine 1070 may be provided in content delivery system 1010 for application processing, and may be, for example, any hardware or hardware/software subsystem suitable for session layer protocol processing (e.g., HTTP, RTSP streaming, etc.) of content requests received from network transport processing engine 1050. In one embodiment application processing engine 1070 may be a dedicated application processing module based on an INTEL PENTIUM III processor running, for example, on standard ×86 OS systems (e.g., Linux, Windows NT, FreeBSD, etc.). Application processing engine 1070 may be utilized for dedicated application-only processing by virtue of the off-loading of all network protocol and storage processing elsewhere in content delivery system 1010. In one embodiment, processor programming for application processing engine 1070 may be generally similar to that of a conventional server, but without the tasks off-loaded to network interface processing engine 1030, storage processing engine 1040, and transport processing engine 1050.

Storage Management Engine

Storage management engine 1040 may be any hardware or hardware/software subsystem suitable for effecting delivery of requested content from content sources (for example content sources 1090 and/or 1100) in response to processed requests received from application processing engine 1070. It will also be understood that in various embodiments a storage management engine 1040 may be employed with content sources other than disk drives (e.g., solid state storage, the storage systems described above, or any other media suitable for storage of data) and may be programmed to request and receive data from these other types of storage.

In one embodiment, processor programming for storage management engine 1040 may be optimized for data retrieval using techniques such as caching, and may include and maintain a disk cache to reduce the relatively long time often required to retrieve data from content sources, such as disk drives. Requests received by storage management engine 1040 from application processing engine 1070 may contain information on how requested data is to be formatted and its destination, with this information being comprehensible to transport processing engine 1050 and/or network interface processing engine 1030. The storage management engine 1040 may utilize a disk cache to reduce the relatively long time it may take to retrieve data stored in a storage medium such as disk drives. Upon receiving a request, storage management engine 1040 may be programmed to first determine whether the requested data is cached, and then to send a request for data to the appropriate content source 1090 or 1100. Such a request may be in the form of a conventional read request. The designated content source 1090 or 1100 responds by sending the requested content to storage management engine 1040, which in turn sends the content to transport processing engine 1050 for forwarding to network interface processing engine 1030.

Based on the data contained in the request received from application processing engine 1070, storage processing engine 1040 sends the requested content in proper format with the proper destination data included. Direct communication between storage processing engine 1040 and transport processing engine 1050 enables application processing engine 1070 to be bypassed with the requested content. Storage processing engine 1040 may also be configured to write data to content sources 1090 and/or 1100 (e.g., for storage of live or broadcast streaming content).

In one embodiment storage management engine 1040 may be a dedicated block-level cache processor capable of block level cache processing in support of thousands of concurrent multiple readers, and direct block data switching to network interface engine 1030. In this regard storage management engine 1040 may utilize a POWER PC 7450 processor in conjunction with ECC memory and a LSI SYMFC929 dual 2 GBaud fibre channel controller for fibre channel interconnect to content sources 1090 and/or 1100 via dual fibre channel arbitrated loop 1092. It will be recognized, however, that other forms of interconnection to storage sources suitable for retrieving content are also possible. Storage management engine 1040 may include hardware and/or software for running the Fibre Channel (FC) protocol, the SCSI (Small Computer Systems Interface) protocol, iSCSI protocol as well as other storage networking protocols.

Storage management engine 1040 may employ any suitable method for caching data, including simple computational caching algorithms such as random removal (RR), first-in first-out (FIFO), predictive read-ahead, over buffering, etc. algorithms. Other suitable caching algorithms include those that consider one or more factors in the manipulation of content stored within the cache memory, or which employ multi-level ordering, key based ordering or function based calculation for replacement. In one embodiment, storage management engine may implement a layered multiple LRU (LMLRU) algorithm that uses an integrated block/buffer management structure including at least two layers of a configurable number of multiple LRU queues and a two-dimensional positioning algorithm for data blocks in the memory to reflect the relative priorities of a data block in the memory in terms of both recency and frequency. Such a caching algorithm is described in further detail in U.S. patent application Ser. No. 09/797,198, entitled “Systems and Methods for Management of Memory” by Qiu et. al, the disclosure of which is incorporated herein by reference.

For increasing delivery efficiency of continuous content, such as streaming multimedia content, storage management engine 1040 may employ caching algorithms that consider the dynamic characteristics of continuous content. Suitable examples include, but are not limited to, interval caching algorithms. In one embodiment, improved caching performance of continuous content may be achieved using an LMLRU caching algorithm that weighs ongoing viewer cache value versus the dynamic time-size cost of maintaining particular content in cache memory. Such a caching algorithm is described in further detail in U.S. patent application Ser. No. 09/797,201, filed Mar. 1, 2001 and entitled “Systems and Methods for Management of Memory in Information Delivery Environments” by Qiu et. al, the disclosure of which is incorporated herein by reference.

System Management Engine

System management (or host) engine 1060 may be present to perform system management functions related to the operation of content delivery system 1010. Examples of system management functions include, but are not limited to, content provisioning/updates, comprehensive statistical data gathering and logging for sub-system engines, collection of shared user bandwidth utilization and content utilization data that may be input into billing and accounting systems, “on the fly” ad insertion into delivered content, customer programmable sub-system level quality of service (“QoS”) parameters, remote management (e.g., SNMP, web-based, CLI), health monitoring, clustering controls, remote/local disaster recovery functions, predictive performance and capacity planning, etc. In one embodiment, content delivery bandwidth utilization by individual content suppliers or users (e.g., individual supplier/user usage of distributive interchange and/or content delivery engines) may be tracked and logged by system management engine 1060, enabling an operator of the content delivery system 1010 to charge each content supplier or user on the basis of content volume delivered.

System management engine 1060 may be any hardware or hardware/software subsystem suitable for performance of one or more such system management engines and in one embodiment may be a dedicated application processing module based, for example, on an INTEL PENTIUM III processor running an ×86 OS. Because system management engine 1060 is provided as a discrete modular engine, it may be employed to perform system management functions from within content delivery system 1010 without adversely affecting the performance of the system. Furthermore, the system management engine 1060 may maintain information on processing engine assignment and content delivery paths for various content delivery applications, substantially eliminating the need for an individual processing engine to have intimate knowledge of the hardware it intends to employ.

Under manual or scheduled direction by a user, system management processing engine 1060 may retrieve content from the network 1020 or from one or more external servers on a second network 1024 (e.g., LAN) using, for example, network file system (NFS) or common internet file system (CIFS) file sharing protocol. Once content is retrieved, the content delivery system may advantageously maintain an independent copy of the original content, and therefore is free to employ any file system structure that is beneficial, and need not understand low level disk formats of a large number of file systems.

Management interface 1062 may be provided for interconnecting system management engine 1060 with a network 1200 (e.g., LAN), or connecting content delivery system 1010 to other network appliances such as other content delivery systems 1010, servers, computers, etc. Management interface 1062 may be by any suitable network interface, such as 10/100 Ethernet, and may support communications such as management and origin traffic. Provision for one or more terminal management interfaces (not shown) for may also be provided, such as by RS-232 port, etc. The management interface may be utilized as a secure port to provide system management and control information to the content delivery system 1010. For example, tasks which may be accomplished through the management interface 1062 include reconfiguration of the allocation of system hardware (as discussed below with reference to FIGS. 1C-1F), programming the application processing engine, diagnostic testing, and any other management or control tasks. Though generally content is not envisioned being provided through the management interface, the identification of or location of files or systems containing content may be received through the management interface 1062 so that the content delivery system may access the content through the other higher bandwidth interfaces.

Management Performed by the Network Interface

Some of the system management functionality may also be performed directly within the network interface processing engine 1030. In this case some system policies and filters may be executed by the network interface engine 1030 in real-time at wirespeed. These polices and filters may manage some traffic/bandwidth management criteria and various service level guarantee policies. Examples of such system management functionality of are described below. It will be recognized that these functions may be performed by the system management engine 1060, the network interface engine 1030, or a combination thereof.

For example, a content delivery system may contain data for two web sites. An operator of the content delivery system may guarantee one web site (“the higher quality site”) higher performance or bandwidth than the other web site (“the lower quality site”), presumably in exchange for increased compensation from the higher quality site. The network interface processing engine 1030 may be utilized to determine if the bandwidth limits for the lower quality site have been exceeded and reject additional data requests related to the lower quality site. Alternatively, requests related to the lower quality site may be rejected to ensure the guaranteed performance of the higher quality site is achieved. In this manner the requests may be rejected immediately at the interface to the external network and additional resources of the content delivery system need not be utilized. In another example, storage service providers may use the content delivery system to charge content providers based on system bandwidth of downloads (as opposed to the traditional storage area based fees). For billing purposes, the network interface engine may monitor the bandwidth use related to a content provider. The network interface engine may also reject additional requests related to content from a content provider whose bandwidth limits have been exceeded. Again, in this manner the requests may be rejected immediately at the interface to the external network and additional resources of the content delivery system need not be utilized.

Additional system management functionality, such as quality of service (QoS) functionality, also may be performed by the network interface engine. A request from the external network to the content delivery system may seek a specific file and also may contain Quality of Service (QoS) parameters. In one example, the QoS parameter may indicate the priority of service that a client on the external network is to receive. The network interface engine may recognize the QoS data and the data may then be utilized when managing the data and communication flow through the content delivery system. The request may be transferred to the storage management engine to access this file via a read queue, e.g., [Destination IP][Filename][File Type (CoS)][Transport Priorities (QoS)]. All file read requests may be stored in a read queue. Based on CoS/QoS policy parameters as well as buffer status within the storage management engine (empty, full, near empty, block seq#, etc), the storage management engine may prioritize which blocks of which files to access from the disk next, and transfer this data into the buffer memory location that has been assigned to be transmitted to a specific IP address. Thus based upon QoS data in the request provided to the content delivery system, the data and communication traffic through the system may be prioritized. The QoS and other policy priorities may be applied to both incoming and outgoing traffic flow. Therefore a request having a higher QoS priority may be received after a lower order priority request, yet the higher priority request may be served data before the lower priority request.

The network interface engine may also be used to filter requests that are not supported by the content delivery system. For example, if a content delivery system is configured only to accept HTTP requests, then other requests such as FTP, telnet, etc. may be rejected or filtered. This filtering may be applied directly at the network interface engine, for example by programming a network processor with the appropriate system policies. Limiting undesirable traffic directly at the network interface off loads such functions from the other processing modules and improves system performance by limiting the consumption of system resources by the undesirable traffic. It will be recognized that the filtering example described herein is merely exemplary and many other filter criteria or policies may be provided.

Multi-Processor Module Design

As illustrated in FIG. 1A, any given processing engine of content delivery system 1010 may be optionally provided with multiple processing modules so as to enable parallel or redundant processing of data and/or communications. For example, two or more individual dedicated TCP/UDP processing modules 1050a and 1050b may be provided for transport processing engine 1050, two or more individual application processing modules 1070a and 1070b may be provided for network application processing engine 1070, two or more individual network interface processing modules 1030a and 1030b may be provided for network interface processing engine 1030 and two or more individual storage management processing modules 1040a and 1040b may be provided for storage management processing engine 1040. Using such a configuration, a first content request may be processed between a first TCP/UDP processing module and a first application processing module via a first switch fabric path, at the same time a second content request is processed between a second TCP/UDP processing module and a second application processing module via a second switch fabric path. Such parallel processing capability may be employed to accelerate content delivery.

Alternatively, or in combination with parallel processing capability, a first TCP/UDP processing module 1050a may be backed-up by a second TCP/UDP processing module 1050b that acts as an automatic fail over spare to the first module 1050a. In those embodiments employing multiple-port switch fabrics, various combinations of multiple modules may be selected for use as desired on an individual system-need basis (e.g., as may be dictated by module failures and/or by anticipated or actual bottlenecks), limited only by the number of available ports in the fabric. This feature offers great flexibility in the operation of individual engines and discrete processing modules of a content delivery system, which may be translated into increased content delivery acceleration and reduction or substantial elimination of adverse effects resulting from system component failures.

In yet other embodiments, the processing modules may be specialized to specific applications, for example, for processing and delivering HTTP content, processing and delivering RTSP content, or other applications. For example, in such an embodiment an application processing module 1070a and storage processing module 1040a may be specially programmed for processing a first type of request received from a network. In the same system, application processing module 1070b and storage processing module 1040b may be specially programmed to handle a second type of request different from the first type. Routing of requests to the appropriate respective application and/or storage modules may be accomplished using a distributive interconnect and may be controlled by transport and/or interface processing modules as requests are received and processed by these modules using policies set by the system management engine.

Further, by employing processing modules capable of performing the function of more than one engine in a content delivery system, the assigned functionality of a given module may be changed on an as-needed basis, either manually or automatically by the system management engine upon the occurrence of given parameters or conditions. This feature may be achieved, for example, by using similar hardware modules for different content delivery engines (e.g., by employing PENTIUM III based processors for both network transport processing modules and for application processing modules), or by using different hardware modules capable of performing the same task as another module through software programmability (e.g., by employing a POWER PC processor based module for storage management modules that are also capable of functioning as network transport modules). In this regard, a content delivery system may be configured so that such functionality reassignments may occur during system operation, at system boot-up or in both cases. Such reassignments may be effected, for example, using software so that in a given content delivery system every content delivery engine (or at a lower level, every discrete content delivery processing module) is potentially dynamically reconfigurable using software commands. Benefits of engine or module reassignment include maximizing use of hardware resources to deliver content while minimizing the need to add expensive hardware to a content delivery system.

Thus, the system disclosed herein allows various levels of load balancing to satisfy a work request. At a system hardware level, the functionality of the hardware may be assigned in a manner that optimizes the system performance for a given load. At the processing engine level, loads may be balanced between the multiple processing modules of a given processing engine to further optimize the system performance.

Clusters of Systems

The systems described herein may also be clustered together in groups of two or more to provide additional processing power, storage connections, bandwidth, etc. Communication between two individual systems each configured similar to content delivery system 1010 may be made through network interface 1022 and/or 1023. Thus, one content delivery system could communicate with another content delivery system through the network 1020 and/or 1024. For example, a storage unit in one content delivery system could send data to a network interface engine of another content delivery system. As an example, these communications could be via TCP/IP protocols. Alternatively, the distributed interconnects 1080 of two content delivery systems 1010 may communicate directly. For example, a connection may be made directly between two switch fabrics, each switch fabric being the distributed interconnect 1080 of separate content delivery systems 1010.

FIGS. 1G-1J illustrate four exemplary clusters of content delivery systems 1010. It will be recognized that many other cluster arrangements may be utilized including more or less content delivery systems. As shown in FIGS. 1G-1J, each content delivery system may be configured as described above and include a distributive interconnect 1080 and a network interface processing engine 1030. Interfaces 1022 may connect the systems to a network 1020. As shown in FIG. 1G, two content delivery systems may be coupled together through the interface 1023 that is connected to each system's network interface processing engine 1030. FIG. 1H shows three systems coupled together as in FIG. 1G. The interfaces 1023 of each system may be coupled directly together as shown, may be coupled together through a network or may be coupled through a distributed interconnect (for example a switch fabric).

FIG. 11 illustrates a cluster in which the distributed interconnects 1080 of two systems are directly coupled together through an interface 1500. Interface 1500 may be any communication connection, such as a copper connection, optical fiber, wireless connection, etc. Thus, the distributed interconnects of two or more systems may directly communicate without communication through the processor engines of the content delivery systems 1010. FIG. 1J illustrates the distributed interconnects of three systems directly communicating without first requiring communication through the processor engines of the content delivery systems 1010. As shown in FIG. 1J, the interfaces 1500 each communicate with each other through another distributed interconnect 1600. Distributed interconnect 1600 may be a switched fabric or any other distributed interconnect.

The clustering techniques described herein may also be implemented through the use of the management interface 1062. Thus, communication between multiple content delivery systems 1010 also may be achieved through the management interface 1062

Exemplary Data and Communication Flow Paths

FIG. 1B illustrates one exemplary data and communication flow path configuration among modules of one embodiment of content delivery system 1010. The flow paths shown in FIG. 1B are just one example given to illustrate the significant improvements in data processing capacity and content delivery acceleration that may be realized using multiple content delivery engines that are individually optimized for different layers of the software stack and that are distributively interconnected as disclosed herein. The illustrated embodiment of FIG. 1B employs two network application processing modules 1070a and 1070b, and two network transport processing modules 1050a and 1050b that are communicatively coupled with single storage management processing module 1040a and single network interface processing module 1030a. The storage management processing module 1040a is in turn coupled to content sources 1090 and 1100. In FIG. 1B, interprocessor command or control flow (i.e. incoming or received data request) is represented by dashed lines, and delivered content data flow is represented by solid lines. Command and data flow between modules may be accomplished through the distributive interconnection 1080 (not shown), for example a switch fabric.

As shown in FIG. 1B, a request for content is received and processed by network interface processing module 1030a and then passed on to either of network transport processing modules 1050a or 1050b for TCP/UDP processing, and then on to respective application processing modules 1070a or 1070b, depending on the transport processing module initially selected. After processing by the appropriate network application processing module, the request is passed on to storage management processor 1040a for processing and retrieval of the requested content from appropriate content sources 1090 and/or 1100. Storage management processing module 1040a then forwards the requested content directly to one of network transport processing modules 1050a or 1050b, utilizing the capability of distributive interconnection 1080 to bypass network application processing modules 1070a and 1070b. The requested content may then be transferred via the network interface processing module 1030a to the external network 1020. Benefits of bypassing the application processing modules with the delivered content include accelerated delivery of the requested content and off loading of workload from the application processing modules, each of which translate into greater processing efficiency and content delivery throughput. In this regard, throughput is generally measured in sustained data rates passed through the system and may be measured in bits per second. Capacity may be measured in terms of the number of files that may be partially cached, the number of TCP/IP connections per second as well as the number of concurrent TCP/IP connections that may be maintained or the number of simultaneous streams of a certain bit rate. In an alternative embodiment, the content may be delivered from the storage management processing module to the application processing module rather than bypassing the application processing module. This data flow may be advantageous if additional processing of the data is desired. For example, it may be desirable to decode or encode the data prior to delivery to the network.

To implement the desired command and content flow paths between multiple modules, each module may be provided with means for identification, such as a component ID. Components may be affiliated with content requests and content delivery to effect a desired module routing. The data-request generated by the network interface engine may include pertinent information such as the component ID of the various modules to be utilized in processing the request. For example, included in the data request sent to the storage management engine may be the component ID of the transport engine that is designated to receive the requested content data. When the storage management engine retrieves the data from the storage device and is ready to send the data to the next engine, the storage management engine knows which component ID to send the data to.

As further illustrated in FIG. 1B, the use of two network transport modules in conjunction with two network application processing modules provides two parallel processing paths for network transport and network application processing, allowing simultaneous processing of separate content requests and simultaneous delivery of separate content through the parallel processing paths, further increasing throughput/capacity and accelerating content delivery. Any two modules of a given engine may communicate with separate modules of another engine or may communicate with the same module of another engine. This is illustrated in FIG. 1B where the transport modules are shown to communicate with separate application modules and the application modules are shown to communicate with the same storage management module.

FIG. 1B illustrates only one exemplary embodiment of module and processing flow path configurations that may be employed using the disclosed method and system. Besides the embodiment illustrated in FIG. 1B, it will be understood that multiple modules may be additionally or alternatively employed for one or more other network content delivery engines (e.g., storage management processing engine, network interface processing engine, system management processing engine, etc.) to create other additional or alternative parallel processing flow paths, and that any number of modules (e.g., greater than two) may be employed for a given processing engine or set of processing engines so as to achieve more than two parallel processing flow paths. For example, in other possible embodiments, two or more different network transport processing engines may pass content requests to the same application unit, or vice-versa.

Thus, in addition to the processing flow paths illustrated in FIG. 1B, it will be understood that the disclosed distributive interconnection system may be employed to create other custom or optimized processing flow paths (e.g., by bypassing and/or interconnecting any given number of processing engines in desired sequence/s) to fit the requirements or desired operability of a given content delivery application. For example, the content flow path of FIG. 1B illustrates an exemplary application in which the content is contained in content sources 1090 and/or 1100 that are coupled to the storage processing engine 1040. However as discussed above with reference to FIG. 1A, remote and/or live broadcast content may be provided to the content delivery system from the networks 1020 and/or 1024 via the second network interface connection 1023. In such a situation the content may be received by the network interface engine 1030 over interface connection 1023 and immediately rebroadcast over interface connection 1022 to the network 1020. Alternatively, content may be proceed through the network interface connection 1023 to the network transport engine 1050 prior to returning to the network interface engine 1030 for re-broadcast over interface connection 1022 to the network 1020 or 1024. In yet another alternative, if the content requires some manner of application processing (for example encoded content that may need to be decoded), the content may proceed all the way to the application engine 1070 for processing. After application processing the content may then be delivered through the network transport engine 1050, network interface engine 1030 to the network 1020 or 1024.

In yet another embodiment, at least two network interface modules 1030a and 1030b may be provided, as illustrated in FIG. 1A. In this embodiment, a first network interface engine 1030a may receive incoming data from a network and pass the data directly to the second network interface engine 1030b for transport back out to the same or different network. For example, in the remote or live broadcast application described above, first network interface engine 1030a may receive content, and second network interface engine 1030b provide the content to the network 1020 to fulfill requests from one or more clients for this content. Peer-to-peer level communication between the two network interface engines allows first network interface engine 1030a to send the content directly to second network interface engine 1030b via distributive interconnect 1080. If necessary, the content may also be routed through transport processing engine 1050, or through transport processing engine 1050 and application processing engine 1070, in a manner described above.

Still yet other applications may exist in which the content required to be delivered is contained both in the attached content sources 1090 or 1100 and at other remote content sources. For example in a web caching application, not all content may be cached in the attached content sources, but rather some data may also be cached remotely. In such an application, the data and communication flow may be a combination of the various flows described above for content provided from the content sources 1090 and 1100 and for content provided from remote sources on the networks 1020 and/or 1024.

The content delivery system 1010 described above is configured in a peer-to-peer manner that allows the various engines and modules to communicate with each other directly as peers through the distributed interconnect. This is contrasted with a traditional server architecture in which there is a main CPU. Furthermore unlike the arbitrated bus of traditional servers, the distributed interconnect 1080 provides a switching means which is not arbitrated and allows multiple simultaneous communications between the various peers. The data and communication flow may by-pass unnecessary peers such as the return of data from the storage management processing engine 1040 directly to the network interface processing engine 1030 as described with reference to FIG. 1B.

Communications between the various processor engines may be made through the use of a standardized internal protocol. Thus, a standardized method is provided for routing through the switch fabric and communicating between any two of the processor engines which operate as peers in the peer to peer environment. The standardized internal protocol provides a mechanism upon which the external network protocols may “ride” upon or be incorporated within. In this manner additional internal protocol layers relating to internal communication and data exchange may be added to the external protocol layers. The additional internal layers may be provided in addition to the external layers or may replace some of the external protocol layers (for example as described above portions of the external headers may be replaced by identifiers or tags by the network interface engine).

The standardized internal protocol may consist of a system of message classes, or types, where the different classes can independently include fields or layers that are utilized to identify the destination processor engine or processor module for communication, control, or data messages provided to the switch fabric along with information pertinent to the corresponding message class. The standardized internal protocol may also include fields or layers that identify the priority that a data packet has within the content delivery system. These priority levels may be set by each processing engine based upon system-wide policies. Thus, some traffic within the content delivery system may be prioritized over other traffic and this priority level may be directly indicated within the internal protocol call scheme utilized to enable communications within the system. The prioritization helps enable the predictive traffic flow between engines and end-to-end through the system such that service level guarantees may be supported.

Other internally added fields or layers may include processor engine state, system timestamps, specific message class identifiers for message routing across the switch fabric and at the receiving processor engine(s), system keys for secure control message exchange, flow control information to regulate control and data traffic flow and prevent congestion, and specific address tag fields that allow hardware at the receiving processor engines to move specific types of data directly into system memory.

In one embodiment, the internal protocol may be structured as a set, or system of messages with common system defined headers that allows all processor engines and, potentially, processor engine switch fabric attached hardware, to interpret and process messages efficiently and intelligently. This type of design allows each processing engine, and specific functional entities within the processor engines, to have their own specific message classes optimized functionally for the exchanging their specific types control and data information. Some message classes that may be employed are: System Control messages for system management, Network Interface to Network Transport messages, Network Transport to Application Interface messages, File System to Storage engine messages, Storage engine to Network Transport messages, etc. Some of the fields of the standardized message header may include message priority, message class, message class identifier (subtype), message size, message options and qualifier fields, message context identifiers or tags, etc. In addition, the system statistics gathering, management and control of the various engines may be performed across the switch fabric connected system using the messaging capabilities.

By providing a standardized internal protocol, overall system performance may be improved. In particular, communication speed between the processor engines across the switch fabric may be increased. Further, communications between any two processor engines may be enabled. The standardized protocol may also be utilized to reduce the processing loads of a given engine by reducing the amount of data that may need to be processed by a given engine.

The internal protocol may also be optimized for a particular system application, providing further performance improvements. However, the standardized internal communication protocol may be general enough to support encapsulation of a wide range of networking and storage protocols. Further, while internal protocol may run on PCI, PCI-X, ATM, IB, Lightening I/O, the internal protocol is a protocol above these transport-level standards and is optimal for use in a switched (non-bus) environment such as a switch fabric. In addition, the internal protocol may be utilized to communicate devices (or peers) connected to the system in addition to those described herein. For example, a peer need not be a processing engine. In one example, a peer may be an ASIC protocol converter that is coupled to the distributed interconnect as a peer but operates as a slave device to other master devices within the system. The internal protocol may also be as a protocol communicated between systems such as used in the clusters described above.

Thus a system has been provided in which the networking/server clustering/storage networking has been collapsed into a single system utilizing a common low-overhead internal communication protocol/transport system.

Content Delivery Acceleration

As described above, a wide range of techniques have been provided for accelerating content delivery from the content delivery system 1010 to a network. By accelerating the speed at which content may be delivered, a more cost effective and higher performance system may be provided. These techniques may be utilized separately or in various combinations.

One content acceleration technique involves the use of a multi-engine system with dedicated engines for varying processor tasks. Each engine can perform operations independently and in parallel with the other engines without the other engines needing to freeze or halt operations. The engines do not have to compete for resources such as memory, I/O, processor time, etc. but are provided with their own resources. Each engine may also be tailored in hardware and/or software to perform specific content delivery task, thereby providing increasing content delivery speeds while requiring less system resources. Further, all data, regardless of the flow path, gets processed in a staged pipeline fashion such that each engine continues to process its layer of functionality after forwarding data to the next engine/layer.

Content acceleration is also obtained from the use of multiple processor modules within an engine. In this manner, parallelism may be achieved within a specific processing engine. Thus, multiple processors responding to different content requests may be operating in parallel within one engine.

Content acceleration is also provided by utilizing the multi-engine design in a peer to peer environment in which each engine may communicate as a peer. Thus, the communications and data paths may skip unnecessary engines. For example, data may be communicated directly from the storage processing engine to the transport processing engine without have to utilize resources of the application processing engine.

Acceleration of content delivery is also achieved by removing or stripping the contents of some protocol layers in one processing engine and replacing those layers with identifiers or tags for use with the next processor engine in the data or communications flow path. Thus, the processing burden placed on the subsequent engine may be reduced. In addition, the packet size transmitted across the distributed interconnect may be reduced. Moreover, protocol processing may be off-loaded from the storage and/or application processors, thus freeing those resources to focus on storage or application processing.

Content acceleration is also provided by using network processors in a network endpoint system. Network processors generally are specialized to perform packet analysis functions at intermediate network nodes, but in the content delivery system disclosed the network processors have been adapted for endpoint functions. Furthermore, the parallel processor configurations within a network processor allow these endpoint functions to be performed efficiently.

In addition, content acceleration has been provided through the use of a distributed interconnection such as a switch fabric. A switch fabric allows for parallel communications between the various engines and helps to efficiently implement some of the acceleration techniques described herein.

It will be recognized that other aspects of the content delivery system 1010 also provide for accelerated delivery of content to a network connection. Further, it will be recognized that the techniques disclosed herein may be equally applicable to other network endpoint systems and even non-endpoint systems.

Exemplary Hardware Embodiments

FIGS. 1C-1F illustrate just a few of the many multiple network content delivery engine configurations possible with one exemplary hardware embodiment of content delivery system 1010. In each illustrated configuration of this hardware embodiment, content delivery system 1010 includes processing modules that may be configured to operate as content delivery engines 1030, 1040, 1050, 1060, and 1070 communicatively coupled via distributive interconnection 1080. As shown in FIG. 1C, a single processor module may operate as the network interface processing engine 1030 and a single processor module may operate as the system management processing engine 1060. Four processor modules 1001 may be configured to operate as either the transport processing engine 1050 or the application processing engine 1070. Two processor modules 1003 may operate as either the storage processing engine 1040 or the transport processing engine 1050. The Gigabit (Gb) Ethernet front end interface 1022, system management interface 1062 and dual fibre channel arbitrated loop 1092 are also shown.

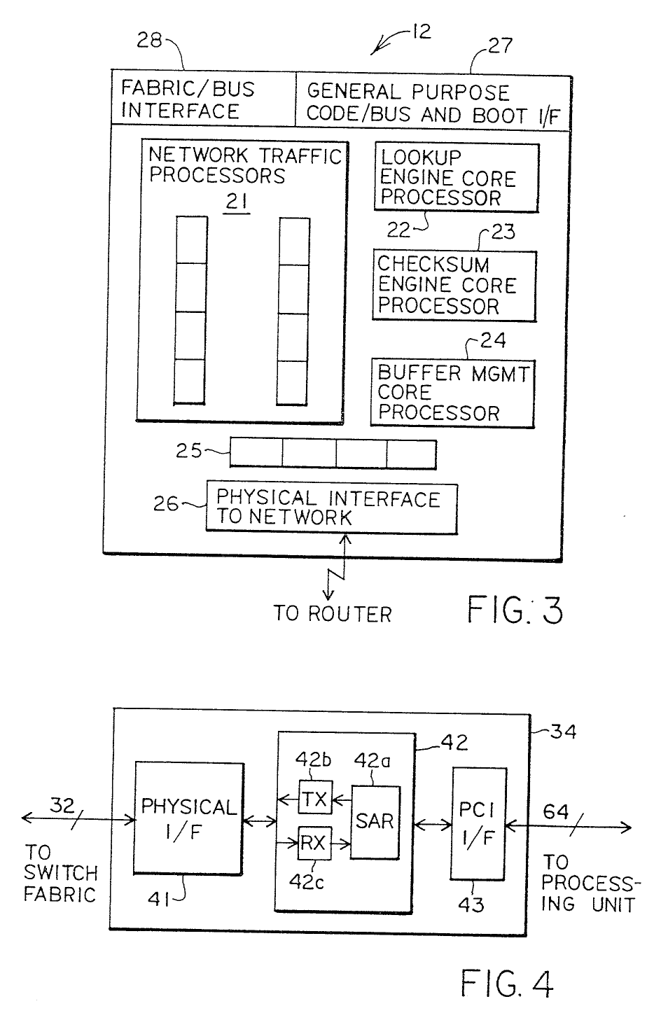

As mentioned above, the distributive interconnect 1080 may be a switch fabric based interconnect. As shown in FIG. 1C, the interconnect may be an IBM PRIZMA-E eight/sixteen port switch fabric 1081. In an eight port mode, this switch fabric is an 8×3.54 Gbps fabric and in a sixteen port mode, this switch fabric is a 16×1.77 Gbps fabric. The eight/sixteen port switch fabric may be utilized in an eight port mode for performance optimization. The switch fabric 1081 may be coupled to the individual processor modules through interface converter circuits 1082, such as IBM UDASL switch interface circuits. The interface converter circuits 1082 convert the data aligned serial link interface (DASL) to a UTOPIA (Universal Test and Operations PHY Interface for ATM) parallel interface. FPGAs (field programmable gate array) may be utilized in the processor modules as a fabric interface on the processor modules as shown in FIG. 1C. These fabric interfaces provide a 64/66 Mhz PCI interface to the interface converter circuits 1082. FIG. 4 illustrates a functional block diagram of such a fabric interface 34. As explained below, the interface 34 provides an interface between the processor module bus and the UDASL switch interface converter circuit 1082. As shown in FIG. 4, at the switch fabric side, a physical connection interface 41 provides connectivity at the physical level to the switch fabric. An example of interface 41 is a parallel bus interface complying with the UTOPIA standard. In the example of FIG. 4, interface 41 is a UTOPIA 3 interface providing a 32-bit 110 Mhz connection. However, the concepts disclosed herein are not protocol dependent and the switch fabric need not comply with any particular ATM or non ATM standard.

Still referring to FIG. 4, SAR (segmentation and reassembly) unit 42 has appropriate SAR logic 42a for performing segmentation and reassembly tasks for converting messages to fabric cells and vice-versa as well as message classification and message class-to-queue routing, using memory 42b and 42c for transmit and receive queues. This permits different classes of messages and permits the classes to have different priority. For example, control messages can be classified separately from data messages, and given a different priority. All fabric cells and the associated messages may be self routing, and no out of band signaling is required.

A special memory modification scheme permits one processor module to write directly into memory of another. This feature is facilitated by switch fabric interface 34 and in particular by its message classification capability. Commands and messages follow the same path through switch fabric interface 34, but can be differentiated from other control and data messages. In this manner, processes executing on processor modules can communicate directly using their own memory spaces.

Bus interface 43 permits switch fabric interface 34 to communicate with the processor of the processor module via the module device or I/O bus. An example of a suitable bus architecture is a PCI architecture, but other architectures could be used. Bus interface 43 is a master/target device, permitting interface 43 to write and be written to and providing appropriate bus control. The logic circuitry within interface 43 implements a state machine that provides the communications protocol, as well as logic for configuration and parity.

Referring again to FIG. 1C, network processor 1032 (for example a MOTOROLA C-Port C-5 network processor) of the network interface processing engine 1030 may be coupled directly to an interface converter circuit 1082 as shown. As mentioned above and further shown in FIG. 1C, the network processor 1032 also may be coupled to the network 1020 by using a VITESSE GbE SERDES (serializer-deserializer) device (for example the VSC7123) and an SFP (small form factor pluggable) optical transceiver for LC fibre connection.

The processor modules 1003 include a fibre channel (FC) controller as mentioned above and further shown in FIG. 1C. For example, the fibre channel controller may be the LSI SYMFC929 dual 2 GBaud fibre channel controller. The fibre channel controller enables communication with the fibre channel 1092 when the processor module 1003 is utilized as a storage processing engine 1040. Also illustrated in FIGS. 1C-1F is optional adjunct processing unit 1300 that employs a POWER PC processor with SDRAM. The adjunct processing unit is shown coupled to network processor 1032 of network interface processing engine 1030 by a PCI interface. Adjunct processing unit 1300 may be employed for monitoring system parameters such as temperature, fan operation, system health, etc.

As shown in FIGS. 1C-1F, each processor module of content delivery engines 1030, 1040, 1050, 1060, and 1070 is provided with its own synchronous dynamic random access memory (“SDRAM”) resources, enhancing the independent operating capabilities of each module. The memory resources may be operated as ECC (error correcting code) memory. Network interface processing engine 1030 is also provided with static random access memory (“SRAM”). Additional memory circuits may also be utilized as will be recognized by those skilled in the art. For example, additional memory resources (such as synchronous SRAM and non-volatile FLASH and EEPROM) may be provided in conjunction with the fibre channel controllers. In addition, boot FLASH memory may also be provided on the of the processor modules.

The processor modules 1001 and 1003 of FIG. 1C may be configured in alternative manners to implement the content delivery processing engines such as the network interface processing engine 1030, storage processing engine 1040, transport processing engine 1050, system management processing engine 1060, and application processing engine 1070. Exemplary configurations are shown in FIGS. 1D-1F, however, it will be recognized that other configurations may be utilized.

As shown in FIG. 1D, two Pentium III based processing modules may be utilized as network application processing modules 1070a and 1070b of network application processing engine 1070. The remaining two Pentium III-based processing modules are shown in FIG. 1D configured as network transport/protocol processing modules 1050a and 1050b of network transport/protocol processing engine 1050. The embodiment of FIG. 1D also includes two POWER PC-based processor modules, configured as storage management processing modules 1040a and 1040b of storage management processing engine 1040. A single MOTOROLA C-Port C-5 based network processor is shown employed as network interface processing engine 1030, and a single Pentium III-based processing module is shown employed as system management processing engine 1060.

In FIG. 1E, the same hardware embodiment of FIG. 1C is shown alternatively configured so that three Pentium III-based processing modules function as network application processing modules 1070a, 1070b and 1070c of network application processing engine 1070, and so that the sole remaining Pentium III-based processing module is configured as a network transport processing module 1050a of network transport processing engine 1050. As shown, the remaining processing modules are configured as in FIG. 1D.

In FIG. 1F, the same hardware embodiment of FIG. 1C is shown in yet another alternate configuration so that three Pentium III-based processing modules function as application processing modules 1070a, 1070b and 1070c of network application processing engine 1070. In addition, the network transport processing engine 1050 includes one Pentium III-based processing module that is configured as network transport processing module 1050a, and one POWER PC-based processing module that is configured as network transport processing module 1050b. The remaining POWER PC-based processor module is configured as storage management processing module 1040a of storage management processing engine 1040.

It will be understood with benefit of this disclosure that the hardware embodiment and multiple engine configurations thereof illustrated in FIGS. 1C-1F are exemplary only, and that other hardware embodiments and engine configurations thereof are also possible. It will further be understood that in addition to changing the assignments of individual processing modules to particular processing engines, distributive interconnect 1080 enables the various processing flow paths between individual modules employed in a particular engine configuration in a manner as described in relation to FIG. 11B. Thus, for any given hardware embodiment and processing engine configuration, a number of different processing flow paths may be employed so as to optimize system performance to suit the needs of particular system applications.

Single Chassis Design

As mentioned above, the content delivery system 1010 may be implemented within a single chassis, such as for example, a 2U chassis. The system may be expanded further while still remaining a single chassis system. In particular, utilizing a multiple processor module or blade arrangement connected through a distributive interconnect (for example a switch fabric) provides a system that is easily scalable. The chassis and interconnect may be configured with expansion slots provided for adding additional processor modules. Additional processor modules may be provided to implement additional applications within the same chassis. Alternatively, additional processor modules may be provided to scale the bandwidth of the network connection. Thus, though describe with respect to a 1 Gbps Ethernet connection to the external network, a 10 Gbps, 40 Gbps or more connection may be established by the system through the use of more network interface modules. Further, additional processor modules may be added to address a system's particular bottlenecks without having to expand all engines of the system. The additional modules may be added during a systems initial configuration, as an upgrade during system maintenance or even hot plugged during system operation.

Alternative Systems Configurations

Further, the network endpoint system techniques disclosed herein may be implemented in a variety of alternative configurations that incorporate some, but not necessarily all, of the concepts disclosed herein. For example, FIGS. 2 and 2A disclose two exemplary alternative configurations. It will be recognized, however, that many other alternative configurations may be utilized while still gaining the benefits of the inventions disclosed herein.

FIG. 2 is a more generalized and functional representation of a content delivery system showing how such a system may be alternately configured to have one or more of the features of the content delivery system embodiments illustrated in FIGS. 1A-1F. FIG. 2 shows content delivery system 200 coupled to network 260 from which content requests are received and to which content is delivered. Content sources 265 are shown coupled to content delivery system 200 via a content delivery flow path 263 that may be, for example, a storage area network that links multiple content sources 265. A flow path 203 may be provided to network connection 272, for example, to couple content delivery system 200 with other network appliances, in this case one or more servers 201 as illustrated in FIG. 2.

In FIG. 2 content delivery system 200 is configured with multiple processing and memory modules that are distributively interconnected by inter-process communications path 230 and inter-process data movement path 235. Inter-process communications path 230 is provided for receiving and distributing inter-processor command communications between the modules and network 260, and interprocess data movement path 235 is provided for receiving and distributing inter-processor data among the separate modules. As illustrated in FIGS. 1A-1F, the functions of inter-process communications path 230 and inter-process data movement path 235 may be together handled by a single distributive interconnect 1080 (such as a switch fabric, for example), however, it is also possible to separate the communications and data paths as illustrated in FIG. 2, for example using other interconnect technology.

FIG. 2 illustrates a single networking subsystem processor module 205 that is provided to perform the combined functions of network interface processing engine 1030 and transport processing engine 1050 of FIG. 1A. Communication and content delivery between network 260 and networking subsystem processor module 205 are made through network connection 270. For certain applications, the functions of network interface processing engine 1030 and transport processing engine 1050 of FIG. 1A may be so combined into a single module 205 of FIG. 2 in order to reduce the level of communication and data traffic handled by communications path 230 and data movement path 235 (or single switch fabric), without adversely impacting the resources of application processing engine or subsystem module. If such a modification were made to the system of FIG. 1A, content requests may be passed directly from the combined interface/transport engine to network application processing engine 1070 via distributive interconnect 1080. Thus, as previously described the functions of two or more separate content delivery system engines may be combined as desired (e.g., in a single module or in multiple modules of a single processing blade), for example, to achieve advantages in efficiency or cost.

In the embodiment of FIG. 2, the function of network application processing engine 1070 of FIG. 1A is performed by application processing subsystem module 225 of FIG. 2 in conjunction with application RAM subsystem module 220 of FIG. 2. System monitor module 240 communicates with server/s 201 through flow path 203 and Gb Ethernet network interface connection 272 as also shown in FIG. 2. The system monitor module 240 may provide the function of the system management engine 1060 of FIG. 1A and/or other system policy/filter functions such as may also be implemented in the network interface processing engine 1030 as described above with reference to FIG. 1A.

Similarly, the function of network storage management engine 1040 is performed by storage subsystem module 210 in conjunction with file system cache subsystem module 215. Communication and content delivery between content sources 265 and storage subsystem module 210 are shown made directly through content delivery flowpath 263 through fibre channel interface connection 212. Shared resources subsystem module 255 is shown provided for access by each of the other subsystem modules and may include, for example, additional processing resources, additional memory resources such as RAM, etc.

Additional processing engine capability (e.g., additional system management processing capability, additional application processing capability, additional storage processing capability, encryption/decryption processing capability, compression/decompression processing capability, encoding/decoding capability, other processing capability, etc.) may be provided as desired and is represented by other subsystem module 275. Thus, as previously described the functions of a single network processing engine may be sub-divided between separate modules that are distributively interconnected. The sub-division of network processing engine tasks may also be made for reasons of efficiency or cost, and/or may be taken advantage of to allow resources (e.g. memory or processing) to be shared among separate modules. Further, additional shared resources may be made available to one or more separate modules as desired.

Also illustrated in FIG. 2 are optional monitoring agents 245 and resources 250. In the embodiment of FIG. 2, each monitoring agent 245 may be provided to monitor the resources 250 of its respective processing subsystem module, and may track utilization of these resources both within the overall system 200 and within its respective processing subsystem module. Examples of resources that may be so monitored and tracked include, but are not limited to, processing engine bandwidth, Fibre Channel bandwidth, number of available drives, IOPS (input/output operations per second) per drive and RAID (redundant array of inexpensive discs) levels of storage devices, memory available for caching blocks of data, table lookup engine bandwidth, availability of RAM for connection control structures and outbound network bandwidth availability, shared resources (such as RAM) used by streaming application on a per-stream basis as well as for use with connection control structures and buffers, bandwidth available for message passing between subsystems, bandwidth available for passing data between the various subsystems, etc.

Information gathered by monitoring agents 245 may be employed for a wide variety of purposes including for billing of individual content suppliers and/or users for pro-rata use of one or more resources, resource use analysis and optimization, resource health alarms, etc. In addition, monitoring agents may be employed to enable the deterministic delivery of content by system 200 as described further herein.

In operation, content delivery system 200 of FIG. 2 may be configured to wait for a request for content or services prior to initiating content delivery or performing a service. A request for content, such as a request for access to data, may include, for example, a request to start a video stream, a request for stored data, etc. A request for services may include, for example, a request for to run an application, to store a file, etc. A request for content or services may be received from a variety of sources. For example, if content delivery system 200 is employed as a stream server, a request for content may be received from a client system attached to a computer network or communication network such as the Internet. In a larger system environment, e.g., a data center, a request for content or services may be received from a separate subcomponent or a system management processing engine, that is responsible for performance of the overall system or from a sub-component that is unable to process the current request. Similarly, a request for content or services may be received by a variety of components of the receiving system. For example, if the receiving system is a stream server, networking subsystem processor module 205 might receive a content request. Alternatively, if the receiving system is a component of a larger system, e.g., a data center, system management processing engine may be employed to receive the request.

Upon receipt of a request for content or services, the request may be filtered by system monitor 240. Such filtering may serve as a screening agent to filter out requests that the receiving system is not capable of processing (e.g., requests for file writes from read-only system embodiments, unsupported protocols, content/services unavailable on system 200, etc.). Such requests may be rejected outright and the requestor notified, may be re-directed to a server 201 or other content delivery system 200 capable of handling the request, or may be disposed of any other desired manner.

Referring now in more detail to one embodiment of FIG. 2 as may be employed in a stream server configuration, networking processing subsystem module 205 may include the hardware and/or software used to run TCP/IP (Transmission Control Protocol/Internet Protocol), UDP/IP (User Datagram Protocol/Internet Protocol), RTP (Real-Time Transport Protocol), Internet Protocol (IP), Wireless Application Protocol (WAP) as well as other networking protocols. Network interface connections 270 and 272 may be considered part of networking subsystem processing module 205 or as separate components. Storage subsystem module 210 may include hardware and/or software for running the Fibre Channel (FC) protocol, the SCSI (Small Computer Systems Interface) protocol, iSCSI protocol as well as other storage networking protocols. FC interface 212 to content delivery fiowpath 263 may be considered part of storage subsystem module 210 or as a separate component. File system cache subsystem module 215 may include, in addition to cache hardware, one or more cache management algorithms as well as other software routines.

Application RAM subsystem module 220 may function as a memory allocation subsystem and application processing subsystem module 225 may function as a stream-serving application processor bandwidth subsystem. Among other services, application RAM subsystem module 220 and application processing subsystem module 225 may be used to facilitate such services as the pulling of content from storage and/or cache, the formatting of content into RTSP (Real-Time Streaming Protocol) or another streaming protocol as well the passing of the formatted content to networking subsystem 205.

As previously described, system monitor module 240 may be included in content delivery system 200 to manage one or more of the subsystem processing modules, and may also be used to facilitate communication between the modules.

In part to allow communications between the various subsystem modules of content delivery system 200, inter-process communication path 230 may be included in content delivery system 200, and may be provided with its own monitoring agent 245. Inter-process communications path 230 may be a reliable protocol path employing a reliable IPC (Interprocess Communications) protocol. To allow data or information to be passed between the various subsystem modules of content delivery system 200, inter-process data movement path 235 may also be included in content delivery system 200, and may be provided with its own monitoring agent 245. As previously described, the functions of inter-process communications path 230 and inter-process data movement path 235 may be together handled by a single distributive interconnect 1080, that may be a switch fabric configured to support the bandwidth of content being served.

In one embodiment, access to content source 265 may be provided via a content delivery flow path 263 that is a fibre channel storage area network (SAN), a switched technology. In addition, network connectivity may be provided at network connection 270 (e.g., to a front end network) and/or at network connection 272 (e.g., to a back end network) via switched gigabit Ethernet in conjunction with the switch fabric internal communication system of content delivery system 200. As such, that the architecture illustrated in FIG. 2 may be generally characterized as equivalent to a networking system.

One or more shared resources subsystem modules 255 may also be included in a stream server embodiment of content delivery system 200, for sharing by one or more of the other subsystem modules. Shared resources subsystem module 255 may be monitored by the monitoring agents 245 of each subsystem sharing the resources. The monitoring agents 245 of each subsystem module may also be capable of tracking usage of shared resources 255. As previously described, shared resources may include RAM (Random Access Memory) as well as other types of shared resources.

Each monitoring agent 245 may be present to monitor one or more of the resources 250 of its subsystem processing module as well as the utilization of those resources both within the overall system and within the respective subsystem processing module. For example, monitoring agent 245 of storage subsystem module 210 may be configured to monitor and track usage of such resources as processing engine bandwidth, Fibre Channel bandwidth to content delivery flow path 263, number of storage drives attached, number of input/output operations per second (IOPS) per drive and RAID levels of storage devices that may be employed as content sources 265. Monitoring agent 245 of file system cache subsystem module 215 may be employed monitor and track usage of such resources as processing engine bandwidth and memory employed for caching blocks of data. Monitoring agent 245 of networking subsystem processing module 205 may be employed to monitor and track usage of such resources as processing engine bandwidth, table lookup engine bandwidth, RAM employed for connection control structures and outbound network bandwidth availability. Monitoring agent 245 of application processing subsystem module 225 may be employed to monitor and track usage of processing engine bandwidth. Monitoring agent 245 of application RAM subsystem module 220 may be employed to monitor and track usage of shared resource 255, such as RAM, which may be employed by a streaming application on a per-stream basis as well as for use with connection control structures and buffers. Monitoring agent 245 of inter-process communication path 230 may be employed to monitor and track usage of such resources as the bandwidth used for message passing between subsystems while monitoring agent 245 of inter-process data movement path 235 may be employed to monitor and track usage of bandwidth employed for passing data between the various subsystem modules.

The discussion concerning FIG. 2 above has generally been oriented towards a system designed to deliver streaming content to a network such as the Internet using, for example, Real Networks, Quick Time or Microsoft Windows Media streaming formats. However, the disclosed systems and methods may be deployed in any other type of system operable to deliver content, for example, in web serving or file serving system environments. In such environments, the principles may generally remain the same. However for application processing embodiments, some differences may exist in the protocols used to communicate and the method by which data delivery is metered (via streaming protocol, versus TCP/IP windowing).

FIG. 2A illustrates an even more generalized network endpoint computing system that may incorporate at least some of the concepts disclosed herein. As shown in FIG. 2A, a network endpoint system 10 may be coupled to an external network 11. The external network 11 may include a network switch or router coupled to the front end of the endpoint system 10. The endpoint system 10 may be alternatively coupled to some other intermediate network node of the external network. The system 10 may further include a network engine 9 coupled to an interconnect medium 14. The network engine 9 may include one or more network processors. The interconnect medium 14 may be coupled to a plurality of processor units 13 through interfaces 13a. Each processor unit 13 may optionally be couple to data storage (in the exemplary embodiment shown each unit is couple to data storage). More or less processor units 13 may be utilized than shown in FIG. 2A.

The network engine 9 may be a processor engine that performs all protocol stack processing in a single processor module or alternatively may be two processor modules (such as the network interface engine 1030 and transport engine 1050 described above) in which split protocol stack processing techniques are utilized. Thus, the functionality and benefits of the content delivery system 1010 described above may be obtained with the system 10. The interconnect medium 14 may be a distributive interconnection (for example a switch fabric) as described with reference to FIG. 1A. All of the various computing, processing, communication, and control techniques described above with reference to FIGS. 1A-1F and 2 may be implemented within the system 10. It will therefore be recognized that these techniques may be utilized with a wide variety of hardware and computing systems and the techniques are not limited to the particular embodiments disclosed herein.

The system 10 may consist of a variety of hardware configurations. In one configuration the network engine 9 may be a stand-alone device and each processing unit 13 may be a separate server. In another configuration the network engine 9 may be configured within the same chassis as the processing units 13 and each processing unit 13 may be a separate server card or other computing system. Thus, a network engine (for example an engine containing a network processor) may provide transport acceleration and be combined with multi-server functionality within the system 10. The system 10 may also include shared management and interface components. Alternatively, each processing unit 13 may be a processing engine such as the transport processing engine, application engine, storage engine, or system management engine of FIG. 1A. In yet another alternative, each processing unit may be a processor module (or processing blade) of the processor engines shown in the system of FIG. 1A.

FIG. 2B illustrates yet another use of a network engine 9. As shown in FIG. 2B, a network engine 9 may be added to a network interface card 35. The network interface card 35 may further include the interconnect medium 14 which may be similar to the distributed interconnect 1080 described above. The network interface card may be part of a larger computing system such as a server. The network interface card may couple to the larger system through the interconnect medium 14. In addition to the functions described above, the network engine 9 may perform all traditional functions of a network interface card.

It will be recognized that all the systems described above (FIGS. 1A, 2, 2A, and 2B) utilize a network engine between the external network and the other processor units that are appropriate for the function of the particular network node. The network engine may therefore offload tasks from the other processors. The network engine also may perform “look ahead processing” by performing processing on a request before the request reaches whatever processor is to perform whatever processing is appropriate for the network node. In this manner, the system operations may be accelerated and resources utilized more efficiently.

Deterministic Information Management

In certain embodiments, the disclosed methods and systems may be advantageously employed for the deterministic management of information (e.g., content, data, services, commands, communications, etc.) at any level (e.g., file level, bit level, etc.). Examples include those described in U.S. patent application Ser. No. 09/797,200, filed Mar. 1, 2001 and entitled “Systems And Methods For The Deterministic Management of Information,” by Johnson et al., the disclosure of which is incorporated herein by reference.

As used herein, “deterministic information management” includes the manipulation of information (e.g., delivery, routing or re-routing, serving, storage, caching, processing, etc.) in a manner that is based at least partially on the condition or value of one or more system or subsystem parameters. Examples of such parameters will be discussed further below and include, but are not limited to, system or subsystem resources such as available storage access, available application memory, available processor capacity, available network bandwidth, etc. Such parameters may be utilized in a number of ways to deterministically manage information. For example, requests for information delivery may be rejected or queued based on availability of necessary system or subsystem resources, and/or necessary resources may be allocated or reserved in advance of handling a particular information request, e.g., as part of an end-to-end resource reservation scheme. Managing information in a deterministic manner offers a number of advantages over traditional information management schemes, including increased hardware utilization efficiency, accelerated information throughput, and greater information handling predictability. Features of deterministic information management may also be employed to enhance capacity planning and to manage growth more easily.

Deterministic information management may be implemented in conjunction with any system or subsystem environment that is suitable for the manipulation of information, including network endpoint systems, intermediate node systems and endpoint/intermediate hybrid systems discussed elsewhere herein. Specific examples of such systems include, but are not limited to, storage networks, servers, switches, routers, web cache systems, etc. It will be understood that any of the information delivery system embodiments described elsewhere herein, including those described in relation to FIGS. 1A and 2, may be employed to manage information in a deterministic manner.

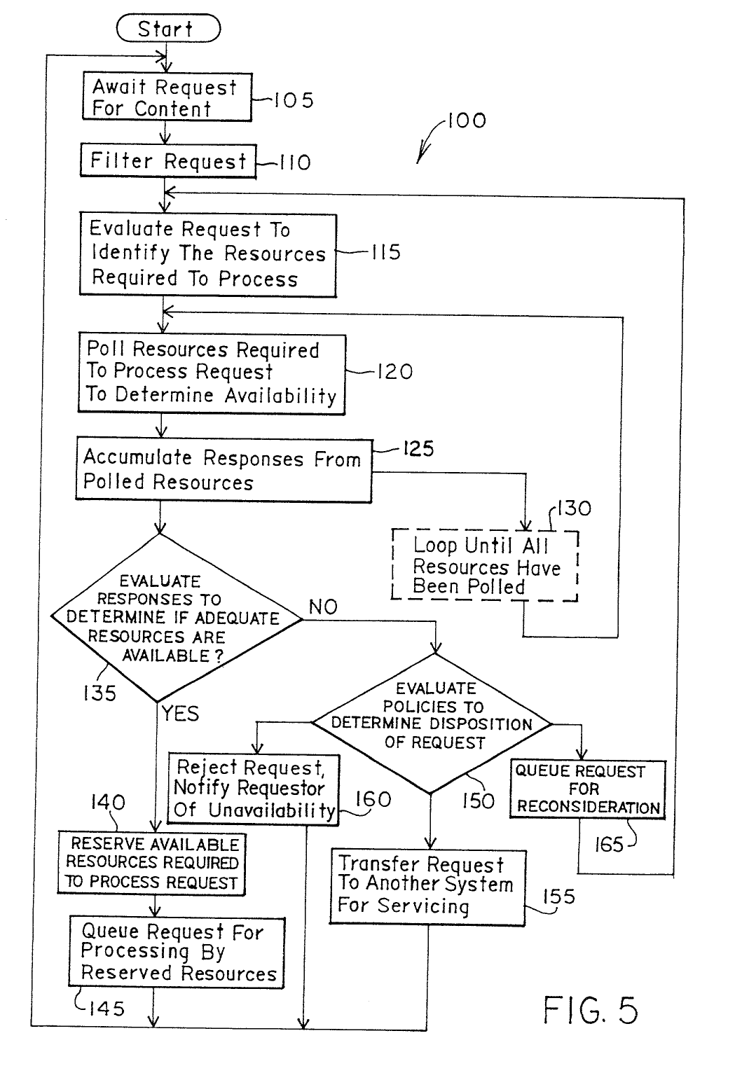

FIG. 5 is a flow diagram illustrating one embodiment of a method 100 for deterministic delivery of content in response to a request for the same. Although FIG. 5 is described in relation to content delivery, it will be understood with benefit of this disclosure that the deterministic methods and systems described herein may be used in a wide variety of information management scenarios, including application serving, and are therefore not limited to only processing requests for content. It will also be understood that the types of content that may be deterministically managed or delivered include any types of content described elsewhere herein, e.g., static content, dynamic content, etc.

With regard to deterministic content delivery methods such as that illustrated in FIG. 5, it will be understood that different types of content may be deterministically managed in different ways to achieved optimum efficiency. For example, when employed to deliver streaming content, such as video or audio streams, the disclosed methods may be advantageously employed to provide increased stability and predictability in stream delivery by, among other things, predicting the capacity of a content delivery system to deliver many long-lived streams. Each such stream requires a certain amount of resources, which may be identified at the time the stream is opened. For web page delivery, such as HTTP serving, requests may be handled as aggregates.

When employed with an information management system such as the content delivery system embodiment illustrated in FIG. 2, method 100 of FIG. 5 may be used to allow a system monitor, a plurality of subsystems and one or more shared resources of a system to effectively interact and provide deterministic delivery of data and services. However, it will be understood that method 100 may be implemented with a variety of other information management system configurations to allow deterministic interaction between system components, for example, between the multiple content delivery engines described in relation to FIG. 1A. Furthermore, FIG. 5 represents just one exemplary set of method steps that may be employed to implement deterministic interaction between system components, with it being understood that any other number, type and/or sequence of method steps suitable for enabling deterministic interaction between two or more components of an information management system may be employed. Selection of suitable steps may be made based on a variety of individual system characteristics, for example, system hardware, system function and environment, system cost and capabilities, etc.

Method 100 of FIG. 5 generally begins at step 105 where a request for content, is awaited. A request for content, as is the case with a request for other information (e.g., data, services, etc.), may be received from a variety of sources. For example, if the system is employed in a stream server environment, the request for content may be received from a client system attached to a computer network or communication network such as the Internet, or any of the other sources of requests described elsewhere herein, including from an overloaded subcomponent of the system which is presently unable to process the current request for content.

Upon receipt of a request for content at step 105, the request for content may be filtered at step 110 by, for example, one or more processing engines or modules that perform the function of a system monitor. Filtering the request for content may serve a variety of purposes. For example, the filtering performed at step 110 may serve as a screening agent to reject requests for content that the receiving system is not capable of processing. Step 110 may also be employed as a first parsing of the received requests for content such that a subsequent level of filtering is employed to further direct the work or requests for content to an appropriate subsystem or system area for processing. It will be understood that other filtering techniques and purposes may also be employed in conjunction with the disclosed systems and methods.

Once the request for content has been filtered, method 100 proceeds to step 115 where the filtered request for content is evaluated. Evaluation of the request for content may be performed by, for example, a system monitor or another subsystem or combination of subsystems capable of evaluating a request for content. With regard to step 115, a request for content may be evaluated in a number of different ways in relation to one or more system or subsystem parameters. For example, a request for content may be evaluated in relation to the requirements for fulfilling the request, e.g., the identified resources that are going to be required to process the particular request for content. As an illustration, a request for access to a streaming video file may be evaluated in relation to one or more of the following requirements: a need for access to storage, a need for processor usage, a need for network bandwidth to enable the data to be streamed from storage, as well as a need for other resources. Evaluation of a request in this manner may be used to enable a system monitor to determine the availability of the required resources, by first identifying what resources will be required to process the request for content. Additional details regarding evaluation of a request for content will be discussed below.

After the resources required to process the current request for content have been identified at step 115, method 100 proceeds to step 120. At step 120, the required resources identified in step 115 may be polled to determine whether the current workload of the required resources is such that the required resources will be available to process the current request for content upon its acceptance. Available resources may be defined, for example, as those required resources that are immediately available to process a request for content, or those resources that will be available within a predefined amount of time. Polling of each of the required resources may occur in parallel or serial manner.

Using the embodiment of FIG. 2 to illustrate, a system operable to process a request for content may include a system monitor 240, a plurality of subsystems (e.g., 210, 215, etc.) and one or more shared resources 255. Each subsystem may include one or more resources 250 that enable that subsystem to perform its respective tasks, and a monitoring agent 245 that is configured to monitor, control, reserve and otherwise manage those resources. In this embodiment, the polling at step 120 may involve the system monitor 240 communicating its resource needs to the monitoring agent 245 of the subsystem having the required resources to process the current request for content. Upon receipt of such communication, the monitoring agent 245 evaluates the workload of the resources 250 for which it is responsible to determine whether there is or there will be enough available resources to process the request for content under consideration.

For example, if the system monitor 240 has indicated that it needs four 4 (four) MB (megabytes) of memory from an application RAM (Random Access Memory) subsystem and the monitoring agent 245 of the application RAM subsystem 220 determines that only 1 MB of memory is available, the system monitor 240 will be notified by the monitoring agent 245 of the unavailability of the application RAM subsystem 220. As a result of the polling of the required resources, a response indicative of the availability of the required resources may be generated by the monitoring agent 245, and transferred to the polling unit, i.e., the system monitor 240. It will be understood that similar interaction between system monitor 240 and respective monitoring agents 245 of other subsystems may occur as appropriate for a given system configuration and a given information request.

In an alternate embodiment, instead of polling the subsystems, a system monitor may receive notifications generated by and transmitted from one or more of the various subsystems. Such notifications may be indicative of the availability of the resources of the various subsystems. For example, if RAM subsystem 220 of FIG. 2 has no available memory, RAM subsystem 220 may automatically notify the system monitor 240 that it is out of memory and therefore unable to take on additional requests for processing. When RAM subsystem resources become or are becoming available, RAM subsystem 220 may automatically generate and transmit a notification to the system monitor 240 indicative of the fact that the RAM subsystem is now or is becoming available to take on additional requests for processing.

Using the above-described automatic notification scheme, a given subsystem may inform a system monitor that the subsystem has reached a threshold of utilization and that the system monitor should slow down on accepting requests. Once a subsystem frees up some of its resources, the given subsystem may then notify the system monitor that it is available or is becoming available and that the system monitor may resume normal operation. Such an implementation allows the system monitor to maintain an awareness of the availability of the subsystems and their resources without requiring the system monitor to poll the subsystems, although it will be understood that both polling and notification functions may be employed together in a given system embodiment. Thus, it will be understood that the various methods and systems disclosed herein may be implemented in various ways to accomplish communication of the status of subsystem resource availability in any manner suitable for accomplishing the deterministic management of information disclosed herein.

At step 125 of method 100, the system monitor accumulates the responses to the resource polls or resource notifications for later evaluation. In one embodiment of method 100, optional step 130 may also be included. At step 130, method 100 loops until all responses or notifications have been received from concerning the identified required resources before allowing method 100 to proceed to step 135.

At step 135, the responses to the resource polls or resource notifications are evaluated, for example, by a system monitor. Evaluation of the resource responses or notifications may involve evaluation of any one or more desired characteristics of the resources including, but not limited to, current availability or estimated time until availability of adequate resources, capability of available resources in relation to a particular request, etc. In one embodiment, evaluation may involve determining whether adequate resources are available, or will be available within a specific time, to process the request for content under consideration. For example, method 100 may require that all of the resources required to process a request for content be immediately available, prior to proceeding toward acceptance of a content request.

Alternatively, evaluation of the responses from the polled resources may entail ensuring that a defined minimum portion of the required resources are immediately available or will become available in a specified amount of time. Such a specified amount of time may be defined on a system-level basis, automatically set by policy on a system-level basis, and/or automatically set by policy on a request-by-request basis. For example, a policy may be implemented to set a maximum allowable time frame for delivery of content based on one or more parameters including, but not limited to, type of request, type of file or service requested, origin of request, identification of the requesting user, priority information (e.g., QoS, Service Level Agreement (“SLA”), etc.) associated with a particular request, etc. A specified maximum allowable time frame may also be set by policy on a system level basis based on one or more parameters including, but not limited to, workload of the present system, resource availability or workload of other linked systems, etc. It will be understood that other guidelines or definitions for acceptable resource availability may be employed.

If, at step 135, the required resources are determined to be available within the guidelines specified for method 100 by one or more system policies, method 100 may proceed to step 140. At step 140, the resources required to process the request for content under consideration may be reserved. For example, using FIG. 2 as an illustration again, reservation of identified required resources 250 may be accomplished by the system monitor 240 or, alternatively, by a combination of the system monitor 240 and the appropriate monitoring agents 245 responsible for each of the identified required resources 250. In one embodiment, reservation of resources includes setting aside that portion of the available resources, or of the resources that will become available within a given time, that has been determined to be required to process the request for content, e.g., a block of memory, a portion of processor power, a portion of network and storage access bandwidth, etc. Reservation of the required resources may be employed to ensure that the current request for content will be readily processed.

Once the required resources have been reserved at step 140, method 100 proceeds to step 145. At step 145, the request for content may be queued for processing by the reserved resources. Upon queuing the request for content at step 145, method 100 returns to step 105 where receipt of a subsequent request for content is awaited by the system.

If, at step 135, it is determined that the required resources are not available to process the request for content, method 100 may proceed to step 150. At step 150, one or more handling policies may be evaluated to determine the proper disposition of the request for content. In this regard, a variety of handling policies (e.g., steps 155, 160 and 165 of FIG. 5) may be made available to properly dispose of requests for content for which the identified resources required to process a request are not available. A given handling policy may be implemented according to one or more system or subsystem parameters in any manner appropriate for the given system environment.

Examples of possible parameters that may be evaluated at step 150 to determine the appropriate handling policy for a given request include, but are not limited to, resource availability and capability of other content delivery systems (e.g., one or more other clustered systems), capability and/or anticipated time until availability of resources in the present content delivery system, the source of the request, the request priority (e.g., SLA, QoS bit set), etc.

In one exemplary embodiment, it is possible at step 150 to select a given policy (e.g., 155, 160 or 165) on a request-by-request or user-by-user basis, for example, based on a specified maximum allowable content delivery time frame that may vary for each request according to one or more parameters such as type of request, type of file or service requested, origin of request, identification of the requesting user, priority information (e.g., QoS, Service Level Agreement (“SLA”), etc.) associated with a particular request, etc. For example, requests from different users and/or requests having different priority codes may be individually associated with different maximum time frame values for delivery of content. When it is determined at step 135 that system resources for the current system won't be available for a given period of time, this given period of time may be compared with the maximum allowable content delivery time frame associated with each request to determine disposition of that request on an individualized basis. Thus, depending on the maximum allowable time frame associated with each request, it is possible that individual requests may be disposed of at step 150 via different policies even when the resource availability time determined at step 135 is the same for each request, e.g., some requests may be immediately transferred to another system via step 155, some requests may be rejected via step 160 and/or some requests may be re-considered via step 165. It will be understood that combinations of different policies and/or maximum content delivery time frames may be implemented in a variety of ways as necessary to achieve desired disposition of different requests.

As illustrated in FIG. 5, evaluation of the handling policies may lead to step 155 where disposal of the requests for content entails transferring the request to another system for processing when identified required resources of the present system are not immediately available or will not become available within a specified period of time. For example, the request for content may be transferred, i.e., by the system monitor, to a separate content delivery system that is known to have resources immediately available or available within a specified period of time. Alternatively, the request for content may be transferred to the next sequential system in a chain of content delivery systems, and where the next system proceeds through a method similar to method 100 to determine its ability to process the request for content.

Upon transferring the request for content to another system at step 155, method 100 of the system returns to step 105 where a subsequent request for content is awaited. It will be understood that a request for content may be transferred to another system that is similarly configured as the present system (e.g., as in a cluster of similar content delivery systems), or to another type of system that is configured differently (e.g., with differing resource types and/or capabilities). In the case of clustered systems, system monitors (or other appropriate subsystem modules) of the individual systems of a cluster may be configured to communicate with each other for purposes of sharing system capability and/or resource availability information with other systems to facilitate efficient transference and handling of requests within a system cluster.

It will also be understood that inter-system transfer of information (e.g., data, content, requests for content, commands, resource status information, etc.) between two or more clustered systems may be managed in a deterministic fashion in a manner similar to that described herein for the intra-system transfer of information between individual processing engines within a single information management system. Deterministic management of intersystem information transfer may be enhanced by distributive interconnection of multiple clustered systems, either internally (e.g., by distributive interconnection of individual distributed interconnects as shown in FIG. 1J) or externally (e.g., by distributive interconnection of individual system network interface processing engines as shown in FIG. 1H). In either case, deterministic transfer of information between individual systems may be managed in a deterministic fashion using any suitable management processing configuration, for example, by using a separate dedicated inter-system management processing module or by using one or more of the existing system monitor processing modules of the individual clustered systems. Individual clusters of systems may in turn be distributively interconnected and information transfer therebetween deterministically managed in a similar fashion, with the number of superimposed levels of deterministic information management being virtually unlimited. Thus, the disclosed methods and systems for deterministic management of information may be advantageously implemented on a variety of scales and/or at multiple system levels as so desired.

Another exemplary policy that may be implemented to address situations in which the current system is unable to process a request for content is illustrated at step 160 where the request for content may be rejected. Similar to step 155, a request for content may be so rejected when the identified required resources of the present system are not immediately available or will not be available within a specified period of time. Such a policy may be implemented, for example, where no other separate clustered system is known to be capable of handling the request, and/or is known to have the necessary resources immediately available or available within a specified period of time. In addition to rejecting the request for content, step 155 may also include notifying the source of the request for content of the rejection and of the inability of the present system to process the request for content. Once the request for content has been rejected at step 160, method 100 returns to step 105 where a subsequent request for content is awaited.

Yet another exemplary policy that may be implemented based on the evaluation step 150 is indicated generally at step 165. At step 165, a request for content may be re-queued for reconsideration by the present system. Re-queuing of a request may include returning to step 115 where the request for content is re-evaluated to identify the resources required for its processing. Such a re-queue may be desirable, for example, when the identified required resources of the present system and of other systems are not immediately available or will not be available within a specified period of time, but when such resources are anticipated to become available at some point in the future. Furthermore, selected types of requests may also be targeted for re-queue rather than rejection when resources are not available. For example, higher priority requests (e.g., based on SLA or QoS bit set) may be re-queued for expedited processing, while similar but lower priority requests are rejected.

It will be understood with benefit of this disclosure that the three handling policies described above in relation to step 150 are exemplary only, and that not all three need be present at step 150. Further, it will be understood that other types of handling policies may be implemented at step 150 as desired to fit the needs of a particular application environment, including additional or alternative policies for treatment of requests other than those described above, and policies that consider alternate or additional system or subsystem parameters.

Turning now to FIG. 2 in greater detail, it will be understood in view of the above discussion that the subsystems of content delivery system 200 may be configured to interact in a deterministic manner if so desired. The ability to manage information in a deterministic fashion may be made possible by virtue of the fact that each subsystem module has a monitoring agent 245 that is aware of one or more subsystem module resources 250 and the utilization of those resources within the respective subsystem and/or overall system 200.

As mentioned above, monitoring agents 245 of each subsystem may be configured to be capable of evaluating the current workload of the resources 250 of the respective subsystem and of reporting the availability of such resources to system monitor 240, either automatically or upon a polling by system monitor 240. Upon receipt of a request, system monitor 240 and one or more individual monitoring agents 245 may individually or together function to either accept the request and reserve the required resources 250 for the request if the resources are available, or to reject the request if one or more subsystem resources 250 required to process the request are not available.

In one embodiment, content delivery system 200 of FIG. 2 may be configured to deterministically deliver content (e.g., one or more video streams) by employing individual monitoring agents 245 in the following roles. Monitoring agent 245 of storage subsystem module 210 may be configured to monitor and reserve such resources as processing engine bandwidth, Fiber Channel bandwidth to content delivery flow path 263, number of available storage devices 265, number of IOPS available per device, and taking into account RAID levels (hardware or software). Monitoring agent 245 of file system caching subsystem module 215 may be configured to monitor and reserve such resources as processing engine bandwidth and memory available for caching blocks of data. Monitoring agent 245 of networking subsystem processing module 205 may be configured to monitor and reserve such resources as processing engine bandwidth, table lookup engine bandwidth, availability of RAM for connection control structures and outbound network bandwidth availability. Monitoring agent 245 of application processing subsystem module 225 may be configured to monitor and reserve processing engine bandwidth. Monitoring agent 245 of other subsystem module 275 may be configured to monitor and reserve resources appropriate to the processing engine features provided therein.

With regard to shared resources 255 of FIG. 2, it will be understood that in a deterministic content delivery embodiment, shared resources 255 may be provided and controlled by individual monitoring agents 245 of each subsystem module sharing the resources 255. Specifically, monitoring agents 245 of each subsystem may be configured to be capable of determining the workload of shared resources 255, and of reserving at least a portion of shared resources 255 that is to be employed by the reserving subsystem to process a request for content. For example, monitoring agent 245 of application RAM subsystem module 220 may be configured to monitor and reserve shared resource 255, such as RAM, for use by streaming application on a per-stream basis as well as for use with connection control structures and buffers. In addition to deterministic interaction between individual subsystem modules of FIG. 2, communications (e.g., IPC protocol) and data movement between the modules may also be deterministic. In this regard, control messaging and data movement between subsystems may be configured to exhibit deterministic characteristics, for example, by employing one or more distributive interconnects (e.g., switch fabrics) to support deterministic data delivery and communication across the range of delivered loads. In one embodiment, separate distributive interconnects may be employed, for example, to deterministically perform the separate respective functions of inter-process communications path 230 and inter-process data movement path 235 of FIG. 2. In another embodiment, these separate functions may be combined and together deterministically performed by a single distributive interconnect, such as a single distributive interconnect 1080 of FIG. 1A. In either case, a distributive interconnect may be configured to support the bandwidth of communications and/or data (e.g., content) being transmitted or served so that added latency is not incurred.

As shown in FIG. 2, a separate monitoring agent 245 may be employed for each distributive interconnect present in a given system, with each interconnect being treated as a separate subsystem module. For example, in the exemplary embodiment of FIG. 2, monitoring agent 245 of inter-process communication path 230 may be configured to monitor and reserve such resources as the bandwidth available for message passing between subsystems while monitoring agent 245 of inter-process data movement path 235 may be configured to monitor and reserve the bandwidth available for passing data between the various subsystems. In another example, multiple distributive interconnects may be provided with monitoring agents to monitor and reserve either communication or data movement flow paths on an assigned or as-needed basis between subsystem modules, or between other distributive interconnects (e.g., in the case of internally clustered systems). Alternatively, a monitoring agent of a single distributive interconnect may be configured to monitor and reserve message-passing and data-passing bandwidth when these functions are handled by a single distributive interconnect, such as a single switch fabric.

Still referring to FIG. 2, method 100 of FIG. 5 may be implemented by system 200 as follows. System 200 begins by waiting for a request at step 105. In this regard, networking subsystem module 205 or some other subsystem module of system 200 may receive a request for content or a request for services from source 260, or from any of the other possible sources previously mentioned. As previously described, a request for content may include such requests as a request to start a video stream, a request for stored data, etc. A request for services may include, for example, a request for a database query, a request for a process to start, a request for an application to be run, etc.

At step 110, system monitor 240 filters the request for content as previously described. In this capacity, system monitor 240 may be configured to coordinate deterministic actions of system 200 by acting as a central clearing house or evaluator of content requests, and by directing the disposition of same. Although described in relation to system monitor 240, it will be understood that coordination of deterministic tasks may be performed by any subsystem module or combination of subsystem modules suitable for performing one or more of the tasks described herein as being performed by system monitor 240. For example, filtering tasks may be performed in whole or in part by application processing subsystem module 225. Furthermore, it will also be understood that one or more deterministic coordination tasks may be performed by processors or combinations of processors that are integral and/or external to a given system 200. For example, a processing module (e.g., system monitor 240) integral to a single system 200 may perform the deterministic coordination tasks for a cluster of linked systems. In an alternate example, a separate dedicated external processing module may be employed to perform the deterministic coordination tasks for a single system 200, or a cluster of such systems.

Once a request has been filtered at step 110 and the resources 250 required to process the request have been identified at step 115, system monitor 240 proceeds to step 120 and polls all of the monitoring agents 245 of the subsystem modules having the resources 250 that have been identified as being required to interact to process the given request, and accumulates responses from monitoring agents 245 at step 125. In response to this polling, a given subsystem module may be configured to refuse to take on additional requests unless it currently has, or will have within a specified period of time, the resources 250 available to process the new request without degradation to requests that it is already processing.

The monitoring tasks of monitoring agents 245 may be performed by any processor or combination of processors suitable for performing one or more of the monitoring tasks as described elsewhere herein. In this regard, monitoring tasks may be performed by one or more processors integral to a given monitored subsystem module as illustrated in FIG. 2, or may alternatively be performed by one or more processors external to the given subsystem module, or even external to system 200 itself. Furthermore, it is possible that a combination of monitoring tasks and deterministic coordination tasks may be performed by the same individual processor (e.g., both functions performed by system monitor 240), or by a combination of processors. Thus, it will be understood that the disclosed methods and systems may be implemented using a wide variety of hardware and/or logical configurations suitable for achieving the deterministic management of information as described herein.

After the responses from monitoring agents 245 are accumulated in step 125, system monitor 240 evaluates the responses at step 135 to determine if adequate resources are available as previously described, although evaluation may be accomplished in any other suitable manner, such as by using a different processing module or a combination of processing modules. For example, application processing subsystem module 225 may communicate with system monitor 240 and evaluate responses based on the resource responses or notifications that have been accumulated by system monitor 240 in step 125.

As previously mentioned, system monitor 240 may then participate in reserving and queuing the resources of each subsystem at steps 140 and 145 if the monitoring agents 245 of the appropriate subsystems have indicated that they have the identified resources 250 available that are required to process the request. Alternatively, individual monitoring agents 245 may reserve the required resources based upon requirements communicated to monitoring agents 245 by system monitor 240 or other processing module/s. An individual processing queue for each subsystem module may be maintained by its appropriate monitoring agent, and/or a centralized processing queue may be maintained for one or more modules by the system monitor.

As previously mentioned with respect to step 150, disposition of requests that a information management system is immediately unable to process or will not be able to process within a specified period of time may be determined by consulting one or more handling policies. For example, a request for content may be rejected in step 160, re-directed to another server 201 with capacity to spare in step 155, or queued for later processing in step 165. As with other exemplary steps of method 100, handling policy evaluation step 150 may be performed by system monitor 240, and/or other suitable processing module/s (e.g., application processing subsystem module 225).

The disclosed methods of deterministic information management may be accomplished using a variety of control schemes. For example, in one embodiment an application itself (e.g., video streaming) may be configured to have intimate knowledge of the underlying hardware/resources it intends to employ so as to enable identification, evaluation and reservation of required hardware/resources. However, in another embodiment the operating system employed by an information management system may advantageously be configured to maintain the necessary knowledge of the information management system hardware and hide such details from the application. In one possible embodiment, such an approach may be implemented for more general deployment in the following manner. An operating system vendor or a standards body may define a set of utilization metrics that subsystem vendors would be required to support. Monitoring and reservation of these resources could then be ‘built-in’ to the operating system for application developers to use. As one specific example, network interface card vendors might be required to maintain percent utilization of inbound and outbound bandwidth. Thus, if a request is received by a content delivery system for delivery of an additional 300 kb/s (kilobit per second) video stream, and the outbound networking path is already 99% utilized, such a request for content may be rejected.

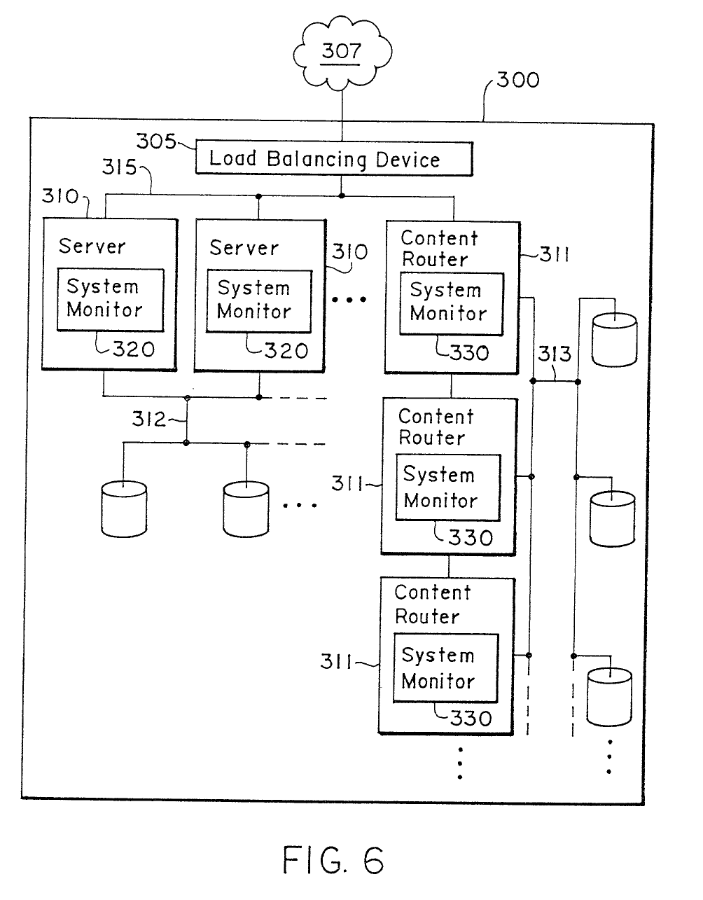

Deterministic management of information has been described herein in relation to particular system embodiments implemented with multiple subsystem modules distributively interconnected in a single chassis system, or in relation to embodiments including a cluster of such systems. However, it will be understood that information may be deterministically managed using a variety of different hardware and/or software types and may be implemented on a variety of different scales. FIG. 6 illustrates just one example of such an alternate embodiment in which the concept of a series of distributively interconnected subsystems may be extrapolated from optimization of resources within a single chassis information management system (e.g., server, router, etc.) to optimization of server resources in a data center 300. Such an implementation may involve deterministically managing communications and information flow between a number of separate devices within data center 300, although it may also be implemented to deterministically manage communication and information flow between similar-type devices integrated into the same chassis.

As shown in FIG. 6, data center 300 may include a device or blade, such as load balancing device 305, that is responsible for load-balancing traffic requests received from network 307 across a number of servers 310 and/or content routers 311 (e.g., within the same chassis or a number of chassis), and in which load-balancing device 305 communicates with servers 310 and/or content routers 311 over a distributively interconnected control/data path 315. In such an embodiment, load balancing device 305 may communicate with system monitors 320 and 330 of respective servers 310 and content routers 311 to determine whether servers 310 or content routers 311 have resources available. Such resources may include, for example, available bandwidth of storage area networks 312 and/or 313 to handle additional requests. In this regard, load balancing device 305 may filter and evaluate requests, poll data center 300 resources, evaluate the responses and dispose of the requests in a deterministic manner similar to that described elsewhere herein, e.g., for system monitor 240 of FIG. 2.

In a further possible embodiment, one or more of servers 310 and/or content routers 311 may be internally configured with subsystem modules that are distributively interconnected and deterministically managed, for example, in a manner as described in relation to FIGS. 1A and 2. In such an implementation, each server 310 and content router 311 itself (in terms of delivering streams or pages) is capable of monitoring its resources and interacting with an external agent in a way that is analogous to the way that the internal subsystems of individual servers 310 and/or content routers 311 are interacting.

In other further embodiments, the disclosed deterministic information management concept may be applied to many different technologies where the concept of a server may be generalized. For example, implementation of the present invention may apply to a device that routes data between a gigabit Ethernet connection to a Fiber Channel connection. In such an implementation, the subsystems may be a networking subsystem, a Fiber Channel subsystem and a routing subsystem. An incoming request for a SCSI (Small Computer System Interface) block would appear at the networking subsystem. The system monitor would then poll the system devices to determine if resources are available to process the request. If not, the request is rejected, or else the necessary resources are reserved and the request is subsequently processed.

Finally, although various embodiments described herein disclose monitoring each individual processing engine of an information management system, such as each subsystem module of content delivery system 200 of FIG. 2, such extensive monitoring may not be necessary in particular application environments. For example, if one or more processing engines has sufficient resources to handle virtually any workload that the information management system is able to provide, it may be unnecessary to track the availability of those resources. In such an implementation, the processing power that may have been utilized to monitor, poll, track, etc. the resources of such a processing engine may be conserved or eliminated. Such a reduction in monitoring and processing power may reduce the overall system cost as well as reduce system design costs.

Differentiated Services

The disclosed systems and methods may be advantageously employed to provide one or more differentiated services in an information management environment, for example, a network environment. In this regard, examples of network environments in which the disclosed systems and methods may be implemented or deployed include as part of any node, functionality or combination of two or more such network nodes or functionalities that may exist between a source of information (e.g., content source, application processing source, etc.) and a user/subscriber, including at an information source node itself (e.g., implemented at the block level source) and/or up to a subscriber node itself. As used herein, the term “differentiated service” includes differentiated information management/manipulation services, functions or tasks (i.e., “differentiated information service”) that may be implemented at the system and/or processing level, as well as “differentiated business service” that may be implemented, for example, to differentiate information exchange between different network entities such as different network provider entities, different network user entities, etc. These two types of differentiated service are described in further detail below. In one embodiment, either or both types of differentiated service may be further characterized as being network transport independent, meaning that they may be implemented in a manner that is not dependent on a particular network transport medium or protocol (e.g., Ethernet, TCP/IP, Infiniband, etc.), but instead in a manner that is compatible with a variety of such network transport mediums or protocols.

As will be described further herein, in one embodiment the disclosed systems and methods may be implemented to make possible session-aware differentiated service. Session-aware differentiated service may be characterized as the differentiation of information management/manipulation services, functions or tasks at a level that is higher than the individual packet level, and that is higher than the individual packet vs. individual packet level. For example, the disclosed systems and methods may be implemented to differentiate information based on status of one or more parameters associated with an information manipulation task itself, status of one or more parameters associated with a request for such an information manipulation task, status of one or more parameters associated with a user requesting such an information manipulation task, status of one or more parameters associated with service provisioning information, status of one or more parameters associated with system performance information, combinations thereof, etc. Specific examples of such parameters include class identification parameters, system performance parameters, and system service parameters described further herein. In one embodiment, session-aware differentiated service includes differentiated service that may be characterized as resource-aware (e.g., content delivery resource-aware, etc.) and, in addition to resource monitoring, the disclosed systems and methods may be additionally or alternatively implemented to be capable of dynamic resource allocation (e.g., per application, per tenant, per class, per subscriber, etc.) in a manner as described further herein.

Deterministic capabilities of the disclosed systems and methods may be employed to provide “differentiated information service” in a network environment, for example, to allow one or more tasks associated with particular requests for information processing to be provisioned, monitored, managed and/or reported differentially relative to other information processing tasks. The term “differentiated information service” includes any information management service, function or separate information manipulation task/s that is performed in a differential manner, or performed in a manner that is differentiated relative to other information management services, functions or information manipulation tasks, for example, based on one or more parameters associated with the individual service/function/task or with a request generating such service/function/task Included within the definition of “differentiated information service” are, for example, provisioning, monitoring, management and reporting functions and tasks as described elsewhere herein. Specific examples include, but are not limited to, prioritization of data traffic flows, provisioning of resources (e.g., disk IOPs and CPU processing resources), etc.

As previously mentioned, business services (e.g., between network entities) may also be offered in a differentiated manner. In this regard, a “differentiated business service” includes any information management service or package of information management services that may be provided by one network entity to another network entity (e.g., as may be provided by a host service provider to a tenant and/or to an individual subscriber/user), and that is provided in a differential manner or manner that is differentiated between at least two network entities. In this regard, a network entity includes any network presence that is or that is capable of transmitting, receiving or exchanging information or data over a network (e.g., communicating, conducting transactions, requesting services, delivering services, providing information, etc.) that is represented or appears to the network as a networking entity including, but not limited to, separate business entities, different business entities, separate or different network business accounts held by a single business entity, separate or different network business accounts held by two or more business entities, separate or different network ID's or addresses individually held by one or more network users/providers, combinations thereof, etc. A business entity includes any entity or group of entities that is or that is capable of delivering or receiving information management services over a network including, but not limited to, host service providers, managed service providers, network service providers, tenants, subscribers, users, customers, etc.

A differentiated business service may be implemented to vertically differentiate between network entities (e.g., to differentiate between two or more tenants or subscribers of the same host service provider/ISP, such as between a subscriber to a high cost/high quality content delivery plan and a subscriber to a low cost/relatively lower quality content delivery plan), or may be implemented to horizontally differentiate between network entities (e.g., as between two or more host service providers/ISPs, such as between a high cost/high quality service provider and a low cost/relatively lower quality service provider). Included within the definition of “differentiated business service” are, for example, differentiated classes of service that may be offered to multiple subscribers. Although differentiated business services may be implemented using one or more deterministic and/or differentiated information service functions/tasks as described elsewhere herein, it will be understood that differentiated business services may be provided using any other methodology and/or system configuration suitable for enabling information management or business services to be provided to or between different network entities in a differentiated manner.

As described herein above, the disclosed methods and systems may be implemented to deterministically manage information based at least in part on parameters associated with particular processed information, or with a particular request for information such as a request for content or request for an information service. Examples of such parameters include, but are not limited to, priority level or code, identity of the requesting user, type of request, anticipated resources required to process the request, etc. As will be further described herein below, in one embodiment these deterministic features may be implemented to provide differentiated information service, for example, in the provisioning of resources and/or prioritization of resources for the processing of particular requests or for performing other tasks associated with management of information. In such an implementation, deterministic management may be configured to be user programmable and/or may be implemented at many system levels, for example, below the operating system level, at the application level, etc. Such deterministic features may be advantageously implemented, for example, to bring single or multi subscriber class of service and/or single or multi content class of service capability to both single and multi-tenant (e.g., shared chassis or data center) environments.

In one differentiated information service embodiment disclosed herein, differentially managing an individual information processing request relative to other such requests allows provisioning of shared resources on a request-by-request, user-by-user, subscriber-by-subscriber or tenant-by-tenant basis based on SLA terms or other priority level information. Differentially monitoring or tracking resource usage for a particular request or particular user/customer allows reporting and verification of actual system performance relative to SLA terms or other standards set for the particular user or customer, and/or allows billing for shared resource usage to be based on the differential use of such resources by a particular user/customer relative to other users/customers. Thus, differentiation between information requests may be advantageously employed to increase efficiency of information management by allowing processing of a particular request to be prioritized and/or billed according to its value relative to other requests that may be simultaneously competing for the same resources. By providing the capability to differentiate between individual information management/manipulation tasks, maximum use of shared resources may be ensured, increasing profitability for the information management system operator and providing users with information management services that are predictable and prioritized, for example, based on the user's desired service level for a given request. In this way, deterministic information management may be employed to enable service providers to differentiate and optimize customer service levels (i e., the customer experience) by allocating content delivery resources based on business objectives, such as bandwidth per connection, duration of event, quality of experience, shared system resource consumption, etc.

The ability to differentiate between information requests may be especially advantageous during periods of high demand, during which it is desirable that an e-business protect its most valuable customers from unpredictable or unacceptable service levels. As described elsewhere herein, system resources (bandwidth, storage processing, application processing, network protocol stack processing, host management processing, memory or storage capacity, etc.) may be adaptively or dynamically allocated or re-allocated according to service level objectives, enabling proactive SLA management by preserving or allocating more resources for a given customer when service levels are approaching SLA thresholds or when system resource utilization is approaching threshold levels, thus assuring SLA performance and generating substantial savings in SLA violation penalties.

Capability to deliver differentiated information service may be implemented using any suitable system architectures, such as one or more of the system architecture embodiments described herein, for example, asymmetrical processing engine configuration, peer-to-peer communication between processing engines, distributed interconnection between multiple processing engines, etc. For example, when implemented in an embodiment employing asymmetrical multi-processors that are distributively interconnected, differentiated management and tracking of resource usage may be enabled to deliver predictable performance without requiring excessive processing time. Furthermore, management and tracking may be performed in real-time with changing resource and/or system load conditions, and the functions of management and tracking may be integrated so that, for example, real time management of a given information request may be based on real time resource usage tracking data.

The disclosed differentiated service capability may be implemented in any system/subsystem network environment node that is suitable for the manipulation of information, including network endpoint systems, intermediate node systems and endpoint/intermediate hybrid systems discussed elsewhere herein. Such capability may also be implemented, for example, in single or multiple application environments, single or multi CoS environments, etc. It will also be understood that differentiated service capability may be implemented across any given one or more separate system nodes and/or across any given separate components of such system nodes, for example, to differentially provision, monitor, manage and/or report information flow therebetween. For example, the disclosed systems and methods may be implemented as a single node/functionality of a multi-node/functionality networking scheme, may be implemented to function across any two or more multiple nodes/functionalities of a multi-node/functionality networking scheme, or may be implemented to function as a single node/functionality that spans the entire network, from information source to an information user/subscriber.

As will be further described herein, the disclosed differentiated services may be advantageously provided at one or more nodes (e.g., endpoint nodes, intermediate nodes, etc.) present outside a network core (e.g., Internet core, etc.). Examples of intermediate nodes positioned outside a network core include, but are not limited to cache devices, edge serving devices, traffic management devices, etc. In one embodiment such nodes may be described as being coupled to a network at “non-packet forwarding” or alternatively at “non-exclusively packet forwarding” functional locations, e.g., nodes having functional characteristics that do not include packet forwarding functions, or alternatively that do not solely include packet forwarding functions, but that include some other form of information manipulation and/or management as those terms are described elsewhere herein.

Examples of particular network environment nodes at which differentiated services (i.e., differentiated business services and/or differentiated information services) may be provided by the disclosed systems and methods include, but are not limited to, traffic sourcing nodes, intermediate nodes, combinations thereof, etc. Specific examples of nodes at which differentiated service may be provided include, but are not limited to, switches, routers, servers, load balancers, web-cache nodes, policy management nodes, traffic management nodes, storage virtualization nodes, node between server and switch, storage networking nodes, application networking nodes, data communication networking nodes, combinations thereof, etc. Specific examples of such systems include, but are not limited to, any of the information delivery system embodiments described elsewhere herein, including those described in relation to FIGS. 1A and 2. Further examples include, but are not limited to, clustered system embodiments such as those illustrated in FIGS. 1G through 1J. Such clustered systems may be implemented, for example, with content delivery management (“CDM”) in a storage virtualization node to advantageously provide differentiated service at the origin and/or edge, e.g., between disk and a client-side device such as a server or other node.

Advantageously, the disclosed systems and methods may be implemented in one embodiment to provide session-aware differentiated information service (e.g., that is content-aware, user-aware, request-aware, resource-aware, application aware, combinations thereof, etc.) in a manner that is network transport independent. For example, differentiated information service may be implemented at any given system level or across any given number of system levels or nodes (e.g., across any given number of desired system components or subsystem components) including, but not limited to, from the storage side (spindle) up to the WAN edge router level, from the storage side up to the service router level, from the storage side up to the core router level, from server to router level (e.g., service router, edge router, core router), etc. Furthermore, the disclosed systems and methods may be implemented to provide differentiated information service in such environments on a bi-directional information flow basis (e.g., they are capable of differentially managing both an incoming request for content as well as the outgoing delivery of the requested content), although uni-directional differentiated information service in either direction is also possible if so desired. The disclosed differentiated services not only may be provided at any given system level or across any given number of system levels or nodes as described above, but as described further herein also may be implemented to provide functions not possible with conventional standards or protocols, such as Ethernet priority bits, Diffserv, RSVP, TOS bits, etc. TCP/IP and Ethernet are conventional communication protocols that make use of priority bits included in the packet, e.g., Ethernet has priority bits in the 802.1 p/q header, and TCP/IP has TOS bits.

In one specific implementation, a serving endpoint may be provided with the ability to not only distinguish between a number of service classes of traffic/application/service, but also to make admission-control and other decisions based on this information. In such a case, policies may be employed to direct the operational behavior of the server endpoint.

In another specific implementation, statistical data gathering and logging may be employed to track resource provisioning and/or shared resource usage associated with particular information manipulation tasks such as may be associated with processing of particular requests for information. Data collected on resource provisioning and shared resource usage may in turn be employed for a number of purposes, including for purposes of billing individual users or suppliers according to relative use of shared resources; tracking actual system performance relative to SLA service guarantees; capacity planning; activity monitoring at the platform, platform subsystem, and/or application levels; real time assignment or reassignment of information manipulation tasks among multiple sub-systems and/or between clustered or linked systems; fail-over subsystem and/or system reassignments; etc. Such features may be implemented in accordance with business objectives, such as bandwidth per subscriber protection, other system resource subscriber protection, chargeable time for resource consumption above a sustained rate, admission control policies, etc.

It will be understood that differentiated information service functions, such as resource management and other such functions described herein, may be performed at any system level or combination of system levels suitable for implementing one or more of such functions. Examples of levels at which differentiated information service functions may be implemented include, but are not limited to, at the system BIOS level, at the operating system level, service manager infrastructure interface level. Furthermore, differentiated information service capability may be implemented within a single system or across a plurality of systems or separate components.

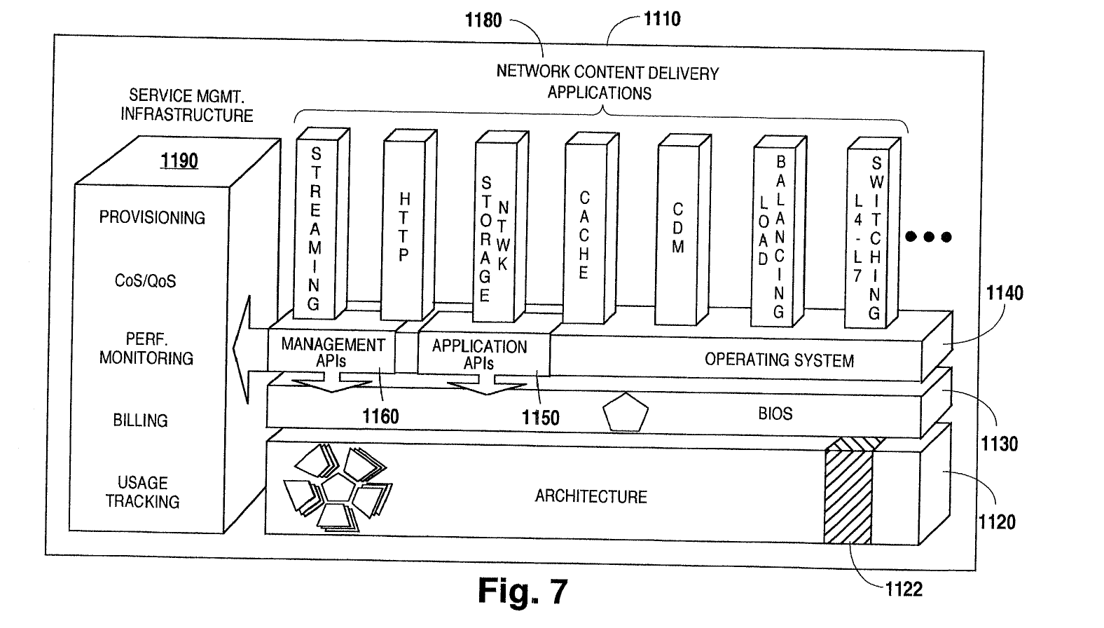

A simplified representation showing the functional components of one exemplary embodiment of an information management system 1110 capable of delivering differentiated information service is shown in FIG. 7. Functional components of system 1110 include hardware system architecture 1120, system BIOS 1130, operating system 1140, management application program interface API 1160, application API 1150, network content delivery applications 1180, and differentiated service management infrastructure 1190. System architecture 1120 may be any information system architecture having deterministic and/or asymmetric processing capabilities, for example, as described elsewhere herein.

In one embodiment, system architecture 1120 may include multiple system engines that are distributively interconnected, for example, in a manner as illustrated and described relation to FIG. 1A or FIG. 2. System architecture 1120 may also include system software that has state knowledge of resource utilization within the architecture and that is capable of imparting deterministic capabilities (e.g., instructions) to system architecture 1120, for example, by deterministically controlling interaction between distributively interconnected system engines of system architecture 1120. As described in relation to FIG. 2, monitoring agents 245 may be provided within each subsystem module and the system architecture 1120 may include a system monitor 240 that performs system management functions, such as maintaining service policies, collecting real-time utilization data from all subsystem modules, etc. System architecture 1120 may be capable of supporting a discrete family of applications or multiple concurrent applications (e.g., streaming applications such as QuickTime, RealNetwork and/or Microsoft Media, edge cache-related, NAS-related, etc.).

System calls may be employed to OS-extensions to determine characteristics of one or more parameters associated with processing engines/resources of a system architecture 1120 (e.g., as in FIGS. 1A and 2) so as to enable deterministic information management and/or to provide differentiated information service functions in a manner described elsewhere herein. In one embodiment, calls to OS-extensions may be made to implement necessary system resource utilization and user priority information. As an example, referring back to FIG. 2, monitoring agent 245 of storage subsystem module 210 may be employed to monitor the workload on each content source 265, as well as the status of other resources 250 of module 210 such as workload on the system CPU doing the caching and block operations, as well as the available memory for caching. Monitoring of this information makes possible calls to storage processing subsystem module 210, for example, to determine availability of IOPs on the drive(s) upon which a requested content stream resides. Similarly, calls may be made to networking subsystem processor module 205 having its own monitoring agent 245 to determine how much bandwidth on the outbound connection is already being used, as well as to determine if sufficient additional resources are available to add another connection. A call may also be made to determine whether sufficient RAM is available in file system cache subsystem module 215 to support this operation, which is also provided with a monitoring agent 245.

As will be described in further detail below, system calls may also be employed to understand parameters, such as priority, associated with individual connections, requests for information, or specific content sets. Examples of such parameters include, but are not limited to, those associated with classes based on content, classes based on application, classes based on incoming packet priority (e.g., utilizing Ethernet priority bits, TCP/IP TOS bits, RSVP, MPLS, etc.), classes based on user, etc. It will be understood that the possible system calls described above are exemplary only, and that many other types of calls or combinations thereof may be employed to deterministically manage information and/or to provide differentiated information service capability in a manner as described elsewhere herein. It will also be understood that where a system monitor 240 collects and maintains monitored subsystem module information, system calls may be handled by system monitor 240 rather than by the individual subsystem modules as described above.

Thus, the capability of monitoring individual subsystem or processing engine resources provided by the disclosed deterministic information management systems may be advantageously implemented in one embodiment to make possible policy-based management of service classes and guarantees in a differentiated manner from a server endpoint. One possible implementation of such an embodiment may be characterized as having the following features. All subsystems that represent a potential bottleneck to complete the requested information management are configured to support prioritized transactions. Any given transaction (e.g., video stream, FTP transfer, etc.) is provided a unique ID that is maintained in the OS or in the application, which includes a priority indicator (or other class of service indicator). OS extensions or other API's are provided for applications to access this information, and an I/O architecture configured to support prioritized transactions.

As further illustrated in FIG. 7, optional system BIOS 1130 may be present to manage system calls made to processing engines of architecture 1120 from applications 1180 through optional APIs 1160 and/or 1150 and through operating system 1140. In this regard system BIOS 1130 enables applications 1180 to utilize architecture 1120 in a deterministic manner by providing access to data presented by individual engines or subsystem modules of architecture 1120, and by ensuring calls are made properly to individual engines or subsystem modules of architecture 1120 in a manner as described above. System BIOS 1130 may make this possible, for example, by responding to application requests for resources with availability information, rerouting information, or SLA choice information. System BIOS 1130 may be implemented as hardware, software or a combination thereof, and may include the IPC.

In one embodiment, operating system 1140 may be a conventional operating system (e.g., Linux-based operating system), to which applications 1180 may be directly ported or may be ported through optional application APIs 1150 and/or 1160 as described below. In this regard, optional APIs 1150 may be provided to enhance performance of one or more applications on system 1110, including, but not limited to, network content delivery applications 1180 as illustrated in FIG. 7. As shown, examples of network content delivery applications include, but are not limited to, applications related to HTTP, streaming content, storage networking, caching, protocol software level switching (e.g., Layer 3 through Layer 7), load balancing, content delivery management (CDM), etc. It will be understood that these listed applications are exemplary only, and that other applications or other combinations of applications (e.g., greater or lesser number, and/or combinations of different applications and/or types of applications, etc.) are also possible. Just a few example of other possible network content delivery applications or internet applications include, but are not limited to, applications related to database, FTP, origin, proxy, other continuous content, etc Although some performance advantages are possible when conventional applications 1180 are directly ported to conventional operating system 1140, application and operating system functions are thus executed in a manner that is essentially unaware of the asymmetric and deterministic capabilities of architecture 1120. Thus, optional application APIs 1150 may be configured as system and/or subsystem-aware functional components that when present at the application/operating system interface may provide significant enhancement and accelerated system performance by streamlining communication and data flow between the application level and the other levels of system 1110 in a manner as described elsewhere herein. Optional management APIs 1160 may also be present to perform a similar function at the operating system/BIOS interface. Although illustrated in FIG. 7 as separate functional components from conventional operating system 1140, it will be understood that functionality of BIOS 1130, API 1160 and/or API 1150 may be built-into or resident within an operating system.

In yet another embodiment, one or more of applications 1180 may be written as system and/or subsystem-aware components themselves, further enhancing and accelerating system performance. For example, code may be included in a selected application that not only utilizes calls into operating system 1140 that indicate the relative priority of each connection or request, but that also utilizes calls indicating the availability of necessary resources or subsystems in architecture 1120 to support each stream. In this manner, the application is enabled to make smart decisions about how to handle various classes of customers in times of system congestion.

Although not illustrated, an operating system may be configured to enable deterministic/differential system performance through a direct interface between applications 1180 and system architecture 1120, e.g., without the need for BIOS 1130. In such a case, system calls may be implemented and managed in the operating system itself. Advantageously, the unique deterministic nature of the system architectures disclosed herein (e.g., FIGS. 1A and 2) make possible such operating system features by enabling monitoring on the subsystem level without excessive processing overhead.

Still referring to FIG. 7, differentiated service management infrastructure 1190 may be provided to enable differentiated service functions or tasks including, but not limited to, service provisioning, service level agreement protocols, QoS and CoS policies, performance monitoring, reporting/billing, usage tracking, etc. These particular management functions will be described in further detail herein, however it will be understood that any other information management function/s that act in a way to differentiate service and/or flow of information may also be implemented using the disclosed systems and methods.

Individual differentiated information service functions of service management infrastructure 1190 may be performed within system 1110 (e.g., by a system management processing engine 1060 described elsewhere herein) and/or may be performed a separate network-connected management system/s (e.g., via interface support to an external data center for service management), such as a separate system running IBM Tivoli, HP Open View, etc. For example, in one embodiment service provisioning, QoS, and performance monitoring functions may be performed by a host processing unit 1122 (e.g., a system management processing engine 1060 as described elsewhere herein) within architecture 1120, while billing and usage tracking functions may be performed by a separate externally connected network component/system based on performance monitoring data supplied by system 1110 (e.g., via a management interface 1062). When information is so provided to an external system for further processing, such information may be output (e.g., such as flat file, SNMP, web-based, CLI, etc.), or selected management APIs 1160 may be present to interface and enhance communications between system 1110 and the external system by providing performance monitoring/usage data in an optimized format for the particular application type/s running on the external system.

It will be understood that FIG. 7 illustrates only one exemplary functional representation of an information management system capable of delivering differentiated service, and that differentiated service capability may be implemented in a variety of other ways, using other combinations of the functional components illustrated in FIG. 7, and/or using different functional components and various combinations thereof. For example, operating system 1140 and/or BIOS 1130 may be extended beyond the boundary of system 1110 to deterministically interface with systems, subsystems or components that are external to system 1110, including systems, subsystems or components that are physically remote from system 1110 (e.g., located in separate chassis, located in separate buildings, located in separate cities/countries etc.) and/or that are not directly coupled to system 1110 through a common distributed interconnect. Examples of such external systems, subsystems or components include, but are not limited to, clustered arrangements of geographically remote or dispersed systems, subsystems or components.

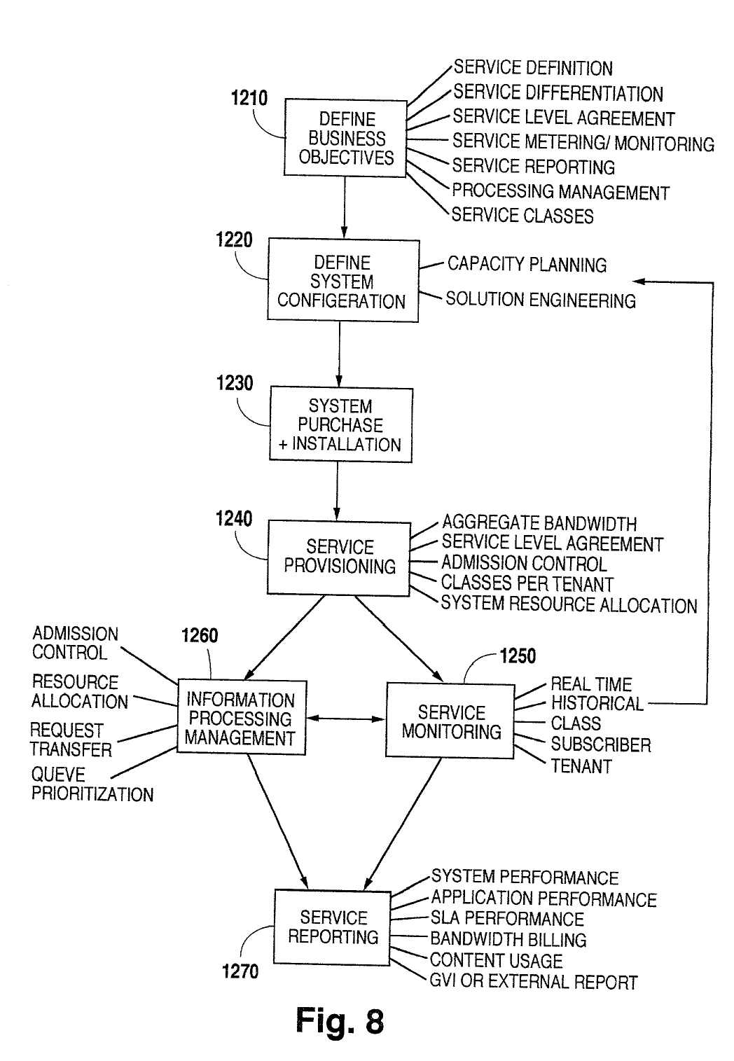

FIG. 8 illustrates one embodiment of a method for implementing differentiated service capability based on defined business objectives, for example, in a competitive service differentiation implementation. As shown, the method includes defining business objectives in step 1210, defining a system configuration in step 1220, purchasing and installing the configured system in step 1230, provisioning service in step 1240, monitoring/tracking service in step 1250, managing information processing in step 1260 and/or reporting service information in step 1270. It will be understood that the method steps of FIG. 8 are exemplary only, and that embodiments of the disclosed systems and methods may be implemented with any one of the steps, or with any combination of two or more of the steps illustrated in FIG. 8. It will be further understood that the disclosed methods and systems may be implemented with other steps not illustrated in FIG. 8, or with combinations of such other steps with any one or more of the steps illustrated in FIG. 8.

The embodiment of FIG. 8 may be implemented, for example, to allow a host service provider (“HSP”) to use the disclosed methods and systems to provide one or more differentiated business services for one or more tenants, who in turn may provide services to subscribers. Examples of HSP's include, but are not limited to, a data center owner who provides co-located or managed services to one or more tenants. Examples of tenants include, but are not limited to, xSPs (such as ISP, ASP, CDSP, SSP, CP or Portal), Enterprise providers providing service to employees, suppliers, customers, investors, etc. A tenant may be co-located or under HSP Managed Service. Subscribers include, for example, residential and/or business customers who access a network content delivery system to play audio/video streams, read web pages, access data files, etc. It will be understood that these examples are exemplary only, and that the embodiment of FIG. 8 may be implemented to allow entities other than an HSP to provide differentiated business services using the disclosed methods and systems.

Referring now to FIG. 8 in more detail, business objectives may be defined in step 1210 and may include objectives such as service definition objectives (e.g., delivery of continuous broadcast, non-continuous and/or stored information, management of unique/non-unique information, anticipated number of simultaneous subscribers and/or simultaneous streams, event (e.g., stream) duration, system resources (e.g. bandwidth) per subscriber, etc.), service differentiation objectives (e.g., horizontal and/or vertical differentiation between different entities, differentiation based on quality/cost plan, differentiation based on type of information request, differentiation based on user/subscriber and/or user/subscriber characteristics, etc.), service level agreement objectives (e.g., CoS priority, QoS etc.), service metering objectives and/or service monitoring objectives (e.g., subscriber flow performance, tenant class performance or individual tenant performance, aggregate system performance, individual subsystem performance, etc.), service reporting objectives (e.g., billing log generation, tracking adherence to SLA, tracking utilization of system and/or subsystems, tracking subscriber and/or content activity, etc.), information processing management objectives (e.g., admission and/or prioritization of requests based on tenant class or individual tenant identity, overflow treatment, etc.), and/or service classes (e.g., desired number and/or types of service classes, etc.). Such objectives may be defined in any manner suitable for communicating the same, for example, from a system purchaser/user to an information management system supplier. Types of objectives that may be defined include one or more pre-defined types of variables, and/or may include one or more custom objective aspects.

Still referring to FIG. 8, a system configuration may be defined in step 1220 based at least partly on business objectives defined in step 1210, for example, by a system manufacturer based on system objectives provided by a purchaser in step 1210. In this regard step 1220 may include, but is not limited to, planning a system configuration to meet objectives such as anticipated capacity, and engineering system characteristics to implement the defined configuration, etc. For example, a system configuration may be planned to meet capacity objectives including, but not limited to, anticipated system throughput objectives, service level protection objectives, maximum number of customer objectives, etc. Examples of solution engineering parameters include, but are not limited to, implementing the system configuration by engineering types and number of system and subsystem hardware components, quality of service objectives, billing and metering objectives, etc. In one exemplary embodiment, specific examples of information system characteristics that may be so configured for a content delivery system include, but are not limited to, storage characteristics (e.g., storage capacity, mirroring, bandwidth attach rate, protocol, etc.); compute characteristics (e.g., CPU speed, management responsibility, application processing capability, etc.); and network characteristics (e.g., admission control, policy management, number of classes, etc.), combinations thereof, etc.

Advantageously, embodiments of the disclosed systems may be configured in consideration of many factors (e.g., quality of service capability, desired SLA policies, billing, metering, admission control, rerouting and other factors reflective of business objectives) that go beyond the simple capacity-oriented factors considered in traditional server design (e.g., anticipated number of requests per hour, duration of stream event, etc.). An information management system may be so configured in this manner based on verbal or written communication of such factors to a system supplier and system configuration accomplished by the supplier based thereupon, and/or a system may be configured using an automated software program that allows entry of such factors and that is, for example, running locally on a supplier's or customer's computer or that is accessible to a customer via the Internet.

In one exemplary embodiment, possible system configurations that may be provided in step 1220 based on business objectives or other defined variables include, but are not limited to, configuration of subsystem components within a single box or chassis (e.g., using subsystem modules that are pluggable into a distributed interconnect backplane), configuration of a cluster of systems in a box to box manner (e.g., internally or externally clustered systems), configuration of data system components using distributively interconnected data center components, etc. Possible system configurations include, but are not limited to, data center system configurations or other content points of presence (“POPs”) suitable for providing delivery traffic management policies and/or for implementing SLA policies to multiple components of a data center concurrently (e.g., switch, storage, application server, router, etc.), and to any selected point/s therebetween. Examples of such content POPs include, but are not limited to, telephone central offices, cable head-ends, wireless head-ends, etc. Thus a system such as shown in FIGS. 1A or 2 may be configured with an optimization of the allocation of resources between processor engines, the types and quantity of processor modules per engine, etc.

As further shown in FIG. 8, system configuration may be defined or modified in step 1220 based at least partly on service monitoring information obtained in step 1250. For example, an existing system configuration may be modified at least partly on service monitoring information obtained for that same system while in actual operation. A new system may be configured based on service monitoring information obtained for one or more existing system/s while in actual operation (e.g., for existing systems similar to the new system and/or for systems operating under network conditions similar to the anticipated network conditions for the new system). Service monitoring step 1250 is described in further detail below, and includes, but is not limited to, historical tracking of system performance parameters such as resource availability and/or usage, adherence to provisioned SLA policies, content usage patterns, time of day access patterns, etc. In this regard step 1220 may include, but is not limited to, capacity planning and/or solution engineering based on historically monitored system throughput, service level adherence, maximum number of concurrent subscribers, etc.

It will be understood that a system configuration definition may be based on any desired combination of business objective information and service monitoring information. In this regard, one or more individual monitored performance parameters (e.g., resource availability and/or usage, adherence to provisioned SLA policies, content usage patterns, time of day access patterns, or other parameters anticipated to be similar for the new system) may be combined with one or more individual business objectives (e.g., objectives reflecting performance parameters expected to differ for the new system, new service differentiation objectives, new service level agreement objectives, new service metering objectives, new service monitoring objectives, new service reporting objectives new information processing management objectives, and/or new service class information, etc.). Further, it will be understood that such service monitoring information and/or business objective information may be varied and/or combined in many ways, for example, to “trial and error” model different implementation scenarios, e.g., for the optimization of the final configuration.

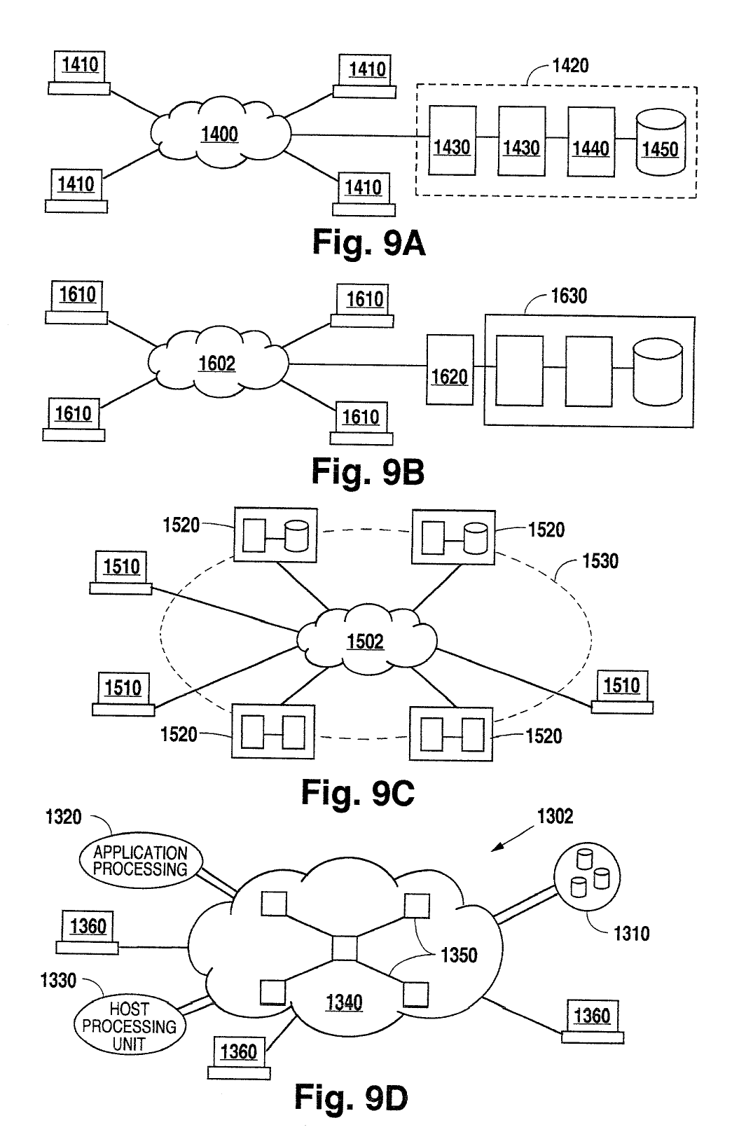

Turning temporarily from FIG. 8 to FIGS. 9A-9D, illustrated are exemplary embodiments of information management configurations of the many different configurations that are possible using the disclosed systems and methods. These exemplary embodiments serve to illustrated just a few of the many configurations in which the disclosed systems and methods may be employed to provide deterministic information management and/or delivery of differentiated services, such as differentiated information services or differentiated business services. In addition to the illustrated embodiments, It will be understood that the disclosed methods and systems described herein (e.g., including the embodiments of FIGS. 9A-9D) may be employed in a variety of network and/or information management environments including, but not limited to, in edge network environments, direct broadcast network environments, etc. For example, the disclosed methods and systems may be implemented in endpoint, intermediate and/or edge node devices that are interconnected to or form a part of an edge network, as well as in one or more nodes within an edge node backbone. In this regard, an edge network may be wired, wireless, satellite-based, etc.

As an example, FIG. 9A illustrates multiple users 1410 that are connected to a network 1400, which may be a LAN or a WAN such as the Internet. An endpoint information management node 1440 (e.g., network endpoint content delivery system) is shown connected to network 1400 via intermediate nodes 1430 that may be, for example, routers, load balancers, web switches, etc. Optional content source 1450 is also shown connected to endpoint information management node 1440. In the embodiment of FIG. 9A, differentiated information services and/or differentiated business services may be delivered to one or more of users 1410 from an origin serving point (e.g., endpoint information management node 1440), for example, when system 1440 is configured as a deterministic system such as that described in relation to FIGS. 1A and 2. In such an embodiment, endpoint information management node controls the information source and may be configured to be capable of handling incoming packets and/or outgoing traffic generated by the incoming packets in a differentiated manner based on parameters or classifications associated with the packets. Such an endpoint information management node may also be capable of marking or tagging outgoing packets with classification information for use by other intermediate or core network nodes.

In an alternate embodiment of FIG. 9A, nodes 1430, 1440 and 1450 of FIG. 9A may be components of an information management data center 1420 or other system capable of performing one or more of the indicated functions in a deterministic manner, for example, as described in relation to FIG. 6. In such a case, differentiated information services and/or differentiated business services may be provided through the data center and delivered to the network core with no other intermediate equipment. Both of the described embodiments of FIG. 9A (i.e., endpoint information management node 1440 or information management data center node 1420) may be configured to manage information (e.g., control system behavior, and serve and deliver content) in a differentiated fashion. Thus, as FIG. 9A indicates, the disclosed systems and methods may be implemented, for example, to provide differentiated service in a content delivery system/server role, or in a device that converges from the content source (e.g., storage disk) to the network.

FIG. 9B illustrates multiple users 1610 that are connected to a network 1602, which may be a LAN or a WAN such as the Internet. Also shown is an intermediate traffic management node 1620 that is present between a conventional data center/content server 1630 and the core of network 1602, and which may be configured to have one more distributive and/or deterministic features of an information management system as described elsewhere herein (e.g., network interface processing engine, etc.). In this embodiment, traffic management node 1620 does not control the information source (e.g., content source) but may be configured as a “gate keeper” to perform such session-aware differentiated service functions or tasks as session-aware service level management, session-aware classification and logging of traffic between the network core and conventional data center/content server 1630. Specific examples of differentiated service functions or tasks that may be performed by such a traffic management node include, but are not limited to, redirection decisions, packet classification, tracking and billing functions relative to traffic flow through traffic management node 1620, policy-equipped router, policy-based switch, etc. Although not shown, it will be understood that other optional intermediate nodes (e.g., edge routers, etc.) may be present between traffic management node 1620 and network 1602 if so desired, that traffic management node 1620 may be subsystem component of a router, etc.

FIG. 9C illustrates multiple edge information management nodes 1520 that are connected to a network 1502, which may be a LAN or a WAN such as the Internet. Also shown are multiple users 1510 that may be connected to network 1502 in a manner similar to that shown in FIGS. 9A and 9B. Edge information management nodes 1520 may be of any system configuration suitable for performing information management functions/tasks, for example, as described elsewhere herein. Specific examples of types of edge information management nodes that are possible include, but are not limited to, edge content delivery nodes, edge application processing nodes, content delivery and/or application processing nodes associated with an edge network, edge content cache and/or replication nodes, etc. As shown, an edge information management node may be configured to interface with network 1502 to receive and fulfill requests for information management, such as content delivery or application processing. In this regard, an edge content delivery node may be configured to have a content source, as well as other processing engines, such as those described in relation to FIGS. 1A and 2, and/or may be configured to perform differentiated service functions or tasks as described elsewhere herein.

In FIG. 9C, multiple edge information management nodes 1520 are shown interconnected with an intelligent signal path or network IPC 1530 that links nodes 1520 in a clustered configuration, for example, in a manner to achieve the benefits and functionalities of clustered configurations described elsewhere herein. In this regard, signal path 1530 represents any communication device or method that is suitable for linking multiple nodes 1520 including, but not limited to, wired connection path, wireless communication path, virtual connection path across network 1502, standards-based signaling techniques, proprietary signaling techniques, combinations thereof, etc. Signal path 1530 may be present as shown to enable deterministic and intelligent communication between the clustered nodes 1520 of FIG. 9C, thus enabling differentiated information services and differentiated business services to be delivered from edge endpoint to the core of network 1502 without the need for intermediate nodes such as routers, load balancers, servers, etc.

It will be understood that two or more nodes 1520 may be physically remote components located in a common facility, such as phone or communication system office with access to various forms of communication, e.g., DSL, wireless, etc. Alternatively, or in addition to physically remote nodes located in a common facility, one or more of nodes 1520 may be physically remote from one or more other nodes located, in separate facilities of the same building, facilities in different buildings within the same campus, etc. Nodes that are physically remote from each other may also include nodes in locations that are geographically remote from each other (e.g., facilities in different buildings within the same city, facilities in different cities, facilities in different states, facilities in different countries, ground and space satellite facilities, etc.) In any case, it is possible that two or more nodes 1520 may be interconnected as part of an edge network configuration.

In one example, the information management embodiment of FIG. 9C may function in a manner that enables a given user 1510 to be served from the particular information management node 1520 that corresponds, for example, to a node containing the specific information requested by the user, a node assigned to particular SLA policies associated with the user or the user's request (e.g., allowing particular nodes 1520 to maintain excess resources for immediately and quickly serving requests associated with high cost/high quality SLA policies), and other nodes 1520 having oversubscribed resources that must be allocated/queued for more slowly serving requests associated with lower cost/lower quality SLA policies, etc.

Also possible are configurations of separate processing engines, such as those of FIG. 1A or 2, that are distributively interconnected across a network, such as a LAN or WAN (e.g., using the disclosed distributed and deterministic system BIOS and/or operating system) to create a virtual distributed interconnect backplane between individual subsystem components across the network that may, for example, be configured to operate together in a deterministic manner as described elsewhere herein. This may be achieved, for example, using embodiments of the disclosed systems and methods in combination with technologies such as wavelength division multiplexing (“WDM”) or dense wavelength division multiplexing (“DWDM”) and optical interconnect technology (e.g., in conjunction with optic/optic interface-based systems), INFINIBAND, LIGHTNING I/O or other technologies. In such an embodiment, one or more processing functionalities may be physically remote from one or more other processing functionalities (e.g., located in separate chassis, located in separate buildings, located in separate cities/countries etc.). Advantageously such a configuration may be used, for example, to allow separate processing engines to be physically remote from each other and/or to be operated by two or more entities (e.g., two or more different service providers) that are different or external in relation to each other. In an alternate embodiment however, processing functionalities may be located in a common local facility if so desired.

FIG. 9D illustrates one possible embodiment of deterministic information management system 1302 having separate processing engines 1310, 1320 and 1330 distributively interconnected across network 1340 that is equipped with fiber channel-based DWDM communication equipment and flow paths 1350 in combination with optic/optic interfaces. In this embodiment, functions or tasks of a system management processing engine may be performed by host processing functionality 1330 located in city A and may include, for example, billing, metering, service level management (SLM) and CDM functions or tasks. Functions or tasks of a storage management processing engine may be performed by storage service provider (SSP)/storage farm functionality 1310 located in city B, functions or tasks of an application processing engine may be performed by application service provider (ASP)/compute farm functionality 1320 located in city C, etc. For example, a request for content may be received from a user 1360 by host processing functionality 1330. Host processing functionality 1330 may then process the request and any SLA-related information associated with the request, and then notify the appropriate storage service provider functionality 1310 to deliver the requested content directly to user 1360. In a similar manner, asymmetric, deterministic and/or direct path information management flow may advantageously occur between any two or more processing engines that may be present on a network and interconnected via a virtual distributed interconnect backplane.

Advantages offered by the network-distributed processing engines of the embodiment of FIG. 9D include the ability of a service provider to focus on one or more particular aspects of service delivery/utility (e.g., content storage, application processing, billing/metering, etc.) without having to worry about other infrastructure components that are maintained by other service providers. Thus, shared resources (e.g., storage capacity, processing capacity, etc.) may be purchased and virtually exchanged (e.g., with usage tracking of same) between service providers on an as-needed basis, thus allowing real time maximization of resource utilization and efficiency, as well as facilitating real time allocation of resources based on relative value to the network community. Advantageously then, a service provider need only consume an amount of a given resource as needed at any given time, and without having to maintain and waste excess resources that would otherwise be required to ensure adequate performance during periods of peak resource demand. Further, a given provider is enabled to sell or exchange any excess resources maintained by the provider during periods of lower demand, if the characteristics of the provider's business change, etc.

It will be understood that the individual components, layout and configuration of FIG. 9D is exemplary only, and that a variety of different combinations and other system configurations are possible. Thus, any number and/or type of system components suitable for performing one or more types of processing engine functions or tasks, may be provided in communication across a network using any connection/interface technology suitable for providing distributed interconnection therebetween, e.g., to allow deterministic information management and/or differentiated services to be provided as described elsewhere herein.

In one embodiment a virtual distributively interconnected system may be configured to allow, for example, system management functions (e.g., such as billing, data mining, resource monitoring, queue prioritization, admission control, resource allocation, SLA compliance, etc.) or other client/server-focused applications to be performed at one or more locations physically remote from storage management functions, application processing functions, single system or multi network management subsystems, etc. This capability may be particularly advantageous, for example, when it is desired to deterministically and/or differentially manage information delivery from a location in a city or country different from that where one or more of the other system processing engines reside. Alternatively or in addition, this capability also makes possible existence of specialized facilities or locations for handling an individual processing engine resource or functionality, or subset of processing engine resources or functionalities, for example, allowing distributed interconnection between two or more individual processing engines operated by different companies or organizations that specialize in such commodity resources or functionalities (e.g., specialized billing company, specialized data mining company, specialized storage company, etc.).

It will be understood that in the delivery of differentiated services using the disclosed systems and methods, including those illustrated in FIGS. 9A-9D, any packet classification technology (e.g., WAN packet classification technology) that is suitable for classifying or differentiating packets of data may be employed to enable such delivery of differentiated services. Such technologies may be employed to allow the disclosed systems and methods to read incoming packet markings/labels representative of one or more policy-indicative parameters associated with information management policy (e.g., class identification parameters, etc.), to allow the disclosed systems and methods to mark or tag outgoing packets with markings/labels representative of one or more policy-indicative parameters associated with information management policy, or a combination thereof. With regard to packet classification technologies, the disclosed differentiated service functionalities may be implemented using principals that are compatible with, or that apply to, any suitable types of layer two through layer seven packet classification technologies including, but not limited to, Ethernet 802.1 P/Q, Diffserv, IPv6, MPLS, Integrated Services (RSVP, etc.), ATM QoS, etc. In one embodiment, the disclosed systems and methods may be advantageously enabled to perform such packet classification functionalities by virtue of the presence and functionality of a network interface processing engine as is described in relation to FIGS. 1A and 2 herein.

Thus, the disclosed systems and methods may be implemented to not only provide new and unique differentiated service functionalities across any given one or more separate network nodes (e.g., in one or more nodes positioned outside a network core), but may also be implemented in a manner that interfaces with, or that is compatible with existing packet classification technologies when applied to information traffic that enters a network core. However, it will be understood that the disclosed systems and methods may be advantageously implemented to deliver session-aware differentiated service in information management environments that is not possible with existing packet classification technologies and existing devices that employ the same (e.g., that function at the individual packet level, or at the individual packet vs. individual packet level).

It is possible to employ packet classification technologies in a variety of different ways to perform the desired differentiated service functions or tasks for a given implementation, including each of the embodiments illustrated in FIGS. 9A-9D. For example, an endpoint information management system 1440 of FIG. 9A may search incoming packets for tags or markings representative of one or more parameters and handle each such packet according to a policy associated with the parameter/s. In this regard, each incoming packet may be differentially handled, for example, in a deterministic manner as previously described.

Similarly, outgoing packets may be classified by the endpoint information management system 1440 by marking the outgoing packets with labels or tags that are related, for example, to service and/or application information or other parameters associated with the packet, and that indicate how the packet should be handled by one or more other components of the edge and/or core of network 1400. An endpoint information management system 1440 may then deliver the labeled packets to the intermediate nodes 1430 and core of network 1400, where the packet labels may be read by other nodes, such as routers, and routed/treated in a manner dictated by the individual labels or markings associated with each packet (e.g., queue position dictated by MPLS tag, Diffserv tag, IPv6 tag, etc.). Advantageously, when endpoint information management system 1440 is configured to be application-aware (e.g., as described in relation to the systems of FIGS. 1A and 2), packet classification may advantageously be made in way that is application-aware. A similar packet classification methodology may be employed in data center embodiments, such as data center 1420 of FIG. 9A. In such embodiments, classified outgoing packets may be delivered directly to core components of network 1400. It will also be understood, however, that the disclosed systems and methods may be practiced in which one or more conventional types of packet classification functions are performed by external intermediate nodes (e.g., conventional intermediate edge routing nodes), rather than the above-described packet classification functions of the disclosed information management systems, or a combination of the two may be employed.

Similar packet classification methodology may be employed for incoming and/or outgoing packets by edge information management nodes 1520 of FIG. 9C, or by any other information management system of the disclosed systems and methods. It will be understood with benefit of this disclosure that classification methodology may be selected to fit the needs or characteristics of a particular network configuration. For example, outgoing packet classification as described above may be particularly desirable in the case of a network having limited core resources. On the other hand, outgoing packet classification may not be as desirable in the case of network having substantially unlimited core resources.

Returning now to FIG. 8, once objectives and system configuration have been defined in steps 1210 and 1220, an information management system may be assembled/manufactured according to the system configuration, purchased and installed as shown in step 1230 of FIG. 8. As previously described, a system may be installed in an HSP facility to provide differentiated business services for one or more tenants.

After an information system has been purchased and installed in step 1230, provisioning of system service parameters may be made in step 1240. Examples of such parameters include, but are not limited to, aggregate bandwidth ceiling, internal and/or external service level agreement (“SLA”) policies (e.g., policies for treatment of particular information requests based on individual request and/or individual subscriber, class of request and/or class of subscriber, including or based on QoS, CoS and/or other class/service identification parameters associated therewith, etc.), admission control policy, information metering policy, classes per tenant, system resource allocation (e.g., bandwidth, processing and/or storage resource allocation per tenant and/or class for a number of tenants and/or number of classes, etc.), etc.

Any parameter or combination of parameters suitable for partitioning system capacity, system use, system access, etc. in the creation and implementation of SLA policies may be considered. In this regard, the decision of which parameter(s) is/are most appropriate depends upon the business model selected by the host utilizing the system or platform, as well as the type of information manipulation function/s or applications (e.g., streaming data delivery, HTTP serving, serving small video clips, web caching, database engines, application serving, etc.) that are contemplated for the system.

Examples of capacity parameters that may be employed in streaming data delivery scenarios include, but are not limited to delivered bandwidth, number of simultaneous N kbit streams, etc. Although delivered Mbit/s is also a possible parameter upon which to provision and bill non-streaming data applications, an alternate parameter for such applications may be to guarantee a number (N) of simultaneous connections, a number (N) of HTTP pages per second, a number (N) of simultaneous video clips, etc. In yet another example, an network attached storage (“NAS”) solution may be ported to an information management system platform. In such a case, files may be delivered by NFS or CIFS, with SLA policies supplied either in terms of delivered bandwidth or file operations per second. It will be understood that the forgoing examples are exemplary and provided to illustrate the wide variety of applications, parameters and combinations thereof under with which the disclosed systems and methods may be advantageously employed.

Referring to FIG. 8 in more detail, a description of exemplary system service parameters that may be defined and provisioned in step 1240 follows. System bandwidth ceiling may be provisioned at step 1240, and may represent a desired bandwidth ceiling defined by a Tenant or HSP that is below the actual system bandwidth ceiling capability. For example, a system may be capable of supporting a maximum bandwidth of from 335 Mbps (20 Kbps×16,800 connections) to 800 Mbps (1 Mbps×800 connections), but the Tenant or HSP may elect to place a bandwidth ceiling underneath these maximums.

SLA policies that may be created at step 1240 may be based on any parameter or combination of parameters suitable, for example, for the creation of a useful business model for ISP/enterprise. Examples of SLA policies include, but are not limited to, class/service identification parameters such as CoS, QoS, combinations thereof, etc. A combination or sum of CoS and QoS may be used to define an SLA per class or flow (subscriber) within a system. Thus, in one embodiment, policy options may be stored in the system, and acted upon relative to state information within the system architecture, such as information on resource availability and/or capability. Examples of other SLA policies that may that may be created in step 1240 include, but are not limited to, protocols for receipt, adherence and acknowledgment of requests for information such as content. For example, a content delivery system may be configured to receive an SLA request from another network element (e.g., including, for example, CoS and QoS requirements), and to respond back to the external entity with available service alternatives based on the available system resources and the SLA requirements of the request. The system may then be configured to receive explicit selection of alternative from the external entity, and to take action on the connection request based thereon.

SLA policies may be internally maintained (e.g., database policy maintained within an information management system), may be externally maintained (e.g., maintained on external network-connected user policy server, content policy server, etc.), or may be a combination thereof. Where external SLA information is employed or accessed by one or more processing engines of an information management system, suitable protocols may be provided to allow communication and information transfer between the system and external components that maintain the SLA information.

SLA policies may be defined and provisioned in a variety of ways, and may be based on CoS and QoS parameters that may be observed under a variety of congestion states. For example, both single class-based and multiple class-based SLAs (e.g., three SLAs per class, etc.) are possible. Alternatively, an SLA may be defined and provisioned on a per-subscriber or per-connection basis. Furthermore, SLA policy definition and adherence management may be applied to subscribers or content, for example, in a manner that enables a content owner to force a particular SLA policy to all sessions/flows requesting access to a particular piece of content or other information.

SLA policies may also be implemented to distinguish different CoS's based on a variety of different basis besides based on content (e.g., content-aware service level agreements). For example, in the case of platform serving applications, the CoS may be based upon application. For a platform serving HTTP as multiple hosts, the CoS may be based upon host. NAS applications may also be based easily on content, or upon host (volume) in the case of one platform serving many volumes. Other CoS basis may include any other characteristic or combination of characteristics suitable for association with CoS, e.g., time of day of request, etc.

Further, it is also possible to direct a system or platform to create classes based on subscriber. For example, a system login may be required, and a user directed to a given URL reflective of the class to which the user belongs (e.g., gold, silver, bronze, etc.). In such an implementation, the login process may be used to determine which class to which the user belongs, and the user then directed to a different URL based thereon. It is possible that the different URL's may all in fact link ultimately to the same content, with the information management system configured to support mapping the different URL's to different service levels.

In yet other examples, more simplistic CoS schemes may be employed, for example, defining CoSs through the use of access control lists based on IP address (e.g. ISP service log-ins, client side metadata information such as cookies, etc.),. This may be done manually, or may be done using an automated tool. Alternatively, a service class may be created based on other factors such as domain name, the presence of cookies, etc. Further, policies may be created that map priority of incoming requests based on TOS bits to a class of service for the outbound response. Similarly, other networking methods may be used as a basis for CoS distinction, including MPLS, VLAN's, 802.1P/Q, etc. Thus, it will be understood that the forgoing examples are exemplary only, and that SLAs may be implemented by defining CoSs based on a wide variety of different parameters and combinations thereof, including parameters that are content-based, user-based, application-based, request-based, etc.

In one exemplary embodiment, a number n of single Tenant per system classes of service (COS) may be defined and provisioned at step 1240 (e.g., where n=from about 1 to about 32). In this regard, a single CoS may be considered an aggregate amount of bandwidth to be allocated to a number of connections when congestion dictates that bandwidth and system resource allocation decisions must be made. For example, a single CoS may be an aggregate bandwidth allocated to a number of connections m, e.g., where m=from about 1 to about 16,800. QoS may be considered a packet loss/latency provision that may, for example, be assigned or provisioned on a per subscriber or per CoS basis, either alone or in combination with other QoS policies, as will be described in more detail below. For content delivery embodiments, characteristics of QoS policy may also be selected based on type of content (e.g., minimum loss/latency policy for non-continuous content delivery, zero loss/latency policy for continuous content delivery, etc.).

Policies such as per flow even egress bandwidth consumption (traffic shaping) may be defined and provisioned in step 1240, for example, for each CoS according to one or more possible network class types: Three specific examples of such possible class types are as follows. 1) Sustained rate (bps) provisioned to be equal to peak rate, i.e., so that available bandwidth is not oversubscribed within the CoS so that packets do not see any buffer delay. This may be described as being analogous to a continuous bit rate (“CBR”) connection. 2) Sustained rate (bps) allocated below its peak rate and oversubscribed within the CoS, i.e., bandwidth is allocated statistically. This may be described as being analogous to a variable bit rate (“VBR”) connection. In such a VBR embodiment, over-subscription may be controlled through the review of sustained and peak rate provisioning for individual connections, as well as the system aggregate of sustained and peak rate within the class. 3) No provisioned sustained or peak bandwidth per connection where class aggregate bandwidth is the only parameter provisioned and controlled, i.e., any number of connections, up to the maximum number set for a given class, are allowed to connect but must share the aggregate bandwidth without sustained or peak protection from other connections within the same class. This may be described as being analogous to a “best effort” class connection. It will be understood that the possible class types described above are exemplary only, and that other class types, as well as combinations of two or more class types may be defined and provisioned as desired.

In another exemplary embodiment, bandwidth allocation, e.g., maximum and/or minimum bandwidth per CoS, may be defined and provisioned in step 1240. In this regard, maximum bandwidth per CoS may be described as an aggregate policy defined per CoS for class behavior control in the event of overall system bandwidth congestion. Such a parameter may be employed to provide a control mechanism for connection admission control (“CAC”), and may be used in the implementation of a policy that enables CBR-type classes to always remain protected, regardless of over-subscription by VBR-type and/or best effort-type classes. For example, a maximum bandwidth ceiling per CoS may be defined and provisioned to have a value ranging from about 0 Mbps up to about 800 Mbps in increments of about 25 Mbps. In such an embodiment, VBR-type classes may also be protected if desired, permitting them to dip into bandwidth allocated for best effort-type classes, either freely or to a defined limit.

Minimum bandwidth per CoS may be described as an aggregate policy per CoS for class behavior control in the event of overall system bandwidth congestion. Such a parameter may also be employed to provide a control mechanism for CAC decisions, and may be used in the implementation of a policy that enables CBR-type and/or VBR-type classes to borrow bandwidth from a best effort-type class down to a floor value. For example, a floor or minimum bandwidth value for a VBR-type or for a best effort-type class may be defined and provisioned to have a value ranging from about 0 Mbps up to 800 Mbps in increments of about 25 Mbps.

It will be understood that the above-described embodiments of maximum and minimum bandwidth per CoS are exemplary only, and that values, definition and/or implementation of such parameters may vary, for example, according to needs of an individual system or application, as well as according to identity of actual per flow egress bandwidth CoS parameters employed in a given system configuration. For example an adjustable bandwidth capacity policy may be implemented allowing VBR-type classes to dip into bandwidth allocated for best effort-type classes either freely or to a defined limit. Other examples of bandwidth allocation-based CoS policies that may be implemented may be found in Examples 1-3 disclosed herein.

As previously mentioned, a single QoS or combination of QoS policies may be defined and provisioned on a per CoS, or on a per subscriber basis. For example, when a single QoS policy is provisioned per CoS, end subscribers who “pay” for, or who are otherwise assigned to a particular CoS are treated equally within that class when the system is in a congested state, and are only differentiated within the class by their particular sustained/peak subscription. When multiple QoS policies are provisioned per CoS, end subscribers who “pay” for, or who are otherwise assigned to a certain class are differentiated according to their particular sustained/peak subscription and according to their assigned QoS. When a unique QoS policy is defined and provisioned per subscriber, additional service differentiation flexibility may be achieved. In one exemplary embodiment, QoS policies may be applicable for CBR-type and/or VBR-type classes whether provisioned and defined on a per CoS or on a per QoS basis. It will be understood that the embodiments described herein are exemplary only and that CoS and/or QoS policies as described herein may be defined and provisioned in both single tenant per system and multi-tenant per system environments.

Further possible at step 1240 is the definition and provisioning of CAC policies per CoS, thus enabling a tenant or HSP to define policies for marginal connection requests during periods of system congestion. In this regard, possible policy alternatives include acceptance or rejection of a connection within a particular requested class. For example, a particular request may be accepted within a class up to a sustained bandwidth ceiling limitation for that class. As previously described, sustained bandwidth allocation may be equal to peak bandwidth allocated for a CBR-type class. For a VBR-type class, sustained bandwidth allocation may be less than allocated peak bandwidth and may be defined as a percentage of total bandwidth allocated. In the event the sustained bandwidth limitation has been exceeded, one or more different CAC policies may be implemented. For example, a connection may be rejected altogether, or may be rejected only within the requested class, but offered a lower class of service. Alternatively, such a connection may be accepted and other active connections allowed to service degrade (e.g., unspecified bit rate “UBR”, etc.). As described elsewhere herein, resource state information (e.g., resource availability, capability, etc.) may be considered in the decision whether to accept or reject particular requests for information, such as particular subscriber requests for content. Resources may also be re-allocated or exchanged as desired to support particular requests, e.g., borrowed from lower class to support higher class request, stolen from lower class to support higher class request, etc. Alternatively, requests may be redirected to alternative systems or nodes.

Summarizing with respect to step 1240, priority-indicative class/service identification parameters may be assigned to indicate the priority of service that a client on an external network is to receive, and a system may be provided with policies in step 1240 to prioritize and manage incoming and/or outgoing data and communication traffic flow through the system based on the characteristics of the class/service identification parameters associated therewith. Examples of such policies include, but are not limited to, policies capable of directing priority of system information retrieval from storage to satisfy a particular request having a class/service identification parameter relative to other pending requests for information, policies associating maximum time frame values for delivery of content based on class/service identification parameters associated with a particular request, and disposal of such a request based on the availability of system resources and the characteristics of the particular class/service identification parameters associated with the request.

Further, admission control policies may be provisioned in step 1240 as previously described to consider, for example, the above-described class/service identification parameters, separate admission control policy priority parameters associated with particular information requests, current resource availability of the system, and/or may be implemented to consider one or more inherent characteristics associated with individual requests (e.g., type of information requested, resources required to satisfy a particular information request, identity of information requester, etc.).

In one embodiment, an optional provisioning utility may be provided that may be employed to provide guidance as to the provisioning of a system for various forms of service level support. For example, a host may initially create SLA policies in step 1240 using the optional provisioning tool which identifies provisioning issues during the process. In such an implementation, the provisioning tool may be provided to inform the host if policies have been selected that conflict, that exceed the capacity of the system platform as currently configured, etc. For example, a host may be defining policies based on bandwidth allocation, but fail to recognize that the system storage elements lack the capacity to handle the guaranteed rates. The optional provisioning utility may inform the host of the conflict or other provisioning issue. Further, the utility may be configured to provide suggestions to resolve the issue. For example, under the above scenario the utility may suggest adding more mirrors, adding another FC loop, etc. In addition, a provisioning utility may be further configured to function in real time, for example, to assist and guide a host in making changes in service level provisioning after a system is placed in operation. Such real time provisioning may include optimization of SLA policies based on actual system performance and/or usage characteristics, changes to SLA policies as otherwise desired by user and/or host, etc. Specific examples include, but are not limited to, configuration of service quality per subscriber, class, tenant, box, etc.; decisions to allow over-provisioning; decisions to allow over-provisioning in combination with re-direction of new requests, etc. In yet a further embodiment, such a provisioning utility may be adapted to analyze and provide suggested changes to service level provisioning based on actual system performance.

Step 1250 of FIG. 8 illustrates how system performance parameters related to information management, such as content delivery, may be differentially monitored. As indicated, monitoring may include both real time and historical tracking of system performance. System performance parameters that may be so monitored or tracked include, but are not limited to, resource availability and/or usage, adherence to provisioned SLA policies, content usage patterns, time of day access patterns, etc. As will be further described, such parameters may be monitored on the basis of the characteristics of a particular hardware/software system configuration, characteristics of an individual session, characteristics of a particular class, characteristics of a particular subscriber, characteristics of a particular tenant, subsystem or system performance, individual resource consumption, combinations thereof, etc. For example, service monitoring step 1250 may be performed on a system basis (e.g., single box/chassis configuration, data center configuration, distributed cluster configuration, etc.), performed on a per tenant basis (e.g., in the case of multiple tenants per system), performed on a per class basis (e.g., in the case of multiple classes per tenant), performed on a per subscriber basis (e.g., in the case of multiple subscribers per class), or a combination thereof. Thus, in one embodiment, service monitoring may be performed in a manner that considers each of the forgoing levels (i.e. service monitoring for a particular subscriber of particular class of a particular tenant of a particular system).

Adherence to SLA policies may be monitored for an individual session or flow in real time and/or on a historical basis. In one exemplary embodiment, SLA adherence may be monitored or tracked by measuring packet throughput relative to sustained and peak rates per connection. For example, throughput statistics may be captured in specified time intervals (e.g., five-minute increments). In another example, behavior of a particular class relative to aggregate assigned sustained and peak bandwidth allocation may be monitored or tracked in real time, or may be monitored or tracked over a period of time (e.g., ranging from one hour to one day in one hour increments). In yet another example, behavior of an individual subsystem or an entire system relative to aggregate assigned sustained and peak bandwidth allocation may be monitored or tracked in real time, or may be monitored or tracked over a period of time (e.g., ranging from one hour to one day in one hour increments).

It will be understood that the forgoing examples of adherence monitoring are exemplary only, and that a variety of other parameters and combinations of parameters may be monitored or tracked in step 1250 of FIG. 8. Furthermore, it will be understood that monitored parameters may be displayed or otherwise communicated or recorded in any suitable manner. For example, current bandwidth consumption may be monitored in real time and presented, for example, via graphical user interface (“GUI”), data file, external report, or any other suitable means.

Also illustrated in FIG. 8 is information processing management step 1260, which may include managing disposition and/or prioritization of information manipulation tasks, such as any those of those information manipulation tasks described elsewhere herein. In this regard, information processing management step 1260 may involve system, inter-system and/or subsystem management of tasks including, but not limited to, admission control, resource allocation, queue prioritization, request transfer, etc. Furthermore, information manipulation tasks may be managed based on class/service identification parameters associated with particular information and/or requests for the same including, but not limited to, SLA policies or CoS/QoS parameters that may be defined and provisioned, for example, as described in relation to step 1240. As described elsewhere herein, such parameters may be defined and provisioned based on virtually any characteristic or combinations of characteristic associated with a particular information manipulation task including, but not limited to, identity or class of user or request, type of request, resource requirement associated with a particular request, etc.

As illustrated in FIG. 8, information processing management step 1260 may optionally utilize performance monitoring information obtained in step 1250, for example, to help make real time information processing management decisions (e.g., based on subsystem, resource, and/or overall system behavior or usage), to adjust processing management behavior based on real time or historical monitored service levels (e.g., to bring service level into adherence with SLA policy), etc.

In service reporting step 1270, a wide variety of performance and/or resource usage information may be collected and reported or otherwise communicated for the use of HSP, Tenants, Subscribers, etc. Such information may be utilized, for example, for purposes related to billing, demonstrating SLA policy adherence, system performance optimization, etc. and may be reported via GUI, data file, external report, or using any other suitable means (e.g., reports viewable through in-system WEB-based GUI or through external Report Writer/Viewer utility). Information that may be reported in step 1270 includes virtually any type of information related to operating or usage characteristics of an information management system, its subsystems and/or its resources, as well as information related to processing of individual requests or classes of requests, such as application and/or SLA performance.

Reporting functions possible in step 1270 include, but are not limited to, generation of any type of billing report based at least in part on collected performance and/or resource usage information, from generation of intermediate level reports (e.g., flat file reports, etc.) that third party entities may use to convert to desired billing format, to generation of finalized billing reports that may be forwarded directly to customers. Also possible are third party agents or client devices configured to receive billing information from the disclosed systems and configured to convert the information into desired format for passing onto a billing server. Such a scheme is also possible in which the disclosed systems are configured to output the billing information in desired format for transmittal to a billing server, without the need for a third party client.

In one example, service configuration information may be reported, and may include all configured attributes such as CoSs and their parameters, QoSs and their parameters, individual subscriber SLAs, system resource consumption, etc. System performance information may also be reported and may include, for example, periodic (e.g., hourly, daily, monthly, etc.) totals of system resource utilization metrics. Application or SLA performance data may also be reported and may include information related to SLA activity, such as packets transmitted, packets dropped, latency statistics, percentage of time at or below sustained level, percentage of time above sustained and at or below peak level, etc. In this regard, application or SLA performance data may also be reported on a periodic basis (e.g., hourly, daily, monthly totals, etc.). SLA performance data may also be reported, for example, as aggregate performance statistics for each QoS, CoS and system as whole.

Types of billing information that may be reported in step 1270 includes, but is not limited to, any type of information related to consumption or use of one or more system resources. In this regard, billing information may be generated on any desired detail level, for example, anywhere from a per-subscriber, per-request or per transaction basis to a per-class or per-tenant basis. Billing information may also be generated based on any desired fee basis, e.g., fixed per use basis, relative resource consumption basis, percentage-service guarantee basis, time of day basis, SLA conformance basis, performance level basis, combinations thereof, etc. Advantageously, billing basis may be static and/or dynamic as described further herein.

Examples of static resource consumption based billing include both application level billing information and system resource level billing information. Specific examples include, but are not limited to, static billing parameters such as fixed or set fees for processing cycles consumed per any one or more of subscriber/class/tenant/system, storage blocks retrieved per any one or more of subscriber/class/tenant/system, bandwidth consumed per any one or more of subscriber/class/tenant/system, combinations thereof, etc. Advantageously, resource consumption based billing is possible from any information source location (e.g., content delivery node location, application serving node location, etc.) using the disclosed systems and methods, be it a origin or edge storage node, origin or edge application serving node, edge caching or content replication node, etc.

Examples of dynamic billing basis include, but are not limited to, SLA conformance basis billing such as standard rate applied for actual performance that meets SLA performance guarantee with reduced billing rate applied for failure to meet SLA performance guarantee, sliding scale schedule providing reductions in billing rate related or proportional to the difference between actual performance and SLA performance guarantee, sliding scale schedule providing reductions in billing rate related or proportional to the amount of time actual performance fails to meet SLA performance guarantee, combinations thereof, etc. Other examples of dynamic billing basis include performance level basis billing, such as sliding scale schedule providing multiple billing rate tiers that are implicated based on actual performance, e.g., higher rates applied for times of higher system performance and vice-versa.

Furthermore, SLA performance information may be used as a billing basis or used to generate a fee adjustment factor for billing purposes. As is the case for other types of information, information necessary for generating billing information and billing information itself, may be reported on a periodic basis (e.g., hourly, daily, monthly totals, etc.) if so desired.

In one embodiment, standard bandwidth information may be reported as billing data and may reflect, for example, allocated sustained and peak bandwidth per subscriber, percentage of time at or below sustained bandwidth level, percentage of time above sustained bandwidth level and at or below peak bandwidth level, etc. In another embodiment, content usage information may be tracked and reported including, but not limited to, information on identity and/or disposition of content requests. Specific examples of such information includes, for example, record of content requests honored/rejected, record of content requests by subscriber, content request start time and content request fulfillment finish time, etc.

Among the many advantages offered by the differentiated service methodology of the embodiment illustrated in FIG. 8 is the capability of providing value-added and flexible SLA policies and “no penalty” service management capabilities that may make possible, among other things, competitive service differentiation and enhanced revenue generation. As used herein, “no penalty” is used to describe a capability (e.g., differentiated service infrastructure capability) that may be offered in conjunction with basic information management functions (e.g., content delivery, service delivery) with little or substantially no increase in required application/subsystem processing time relative to processing time required to perform the basic information management function alone. Just a few examples of specific flexible SLA policies that may be so provided include, but are not limited to, guaranteed system and/or subscriber capacity support, QoS assurance, CoS, adaptive CoS, etc. Examples of real time “no penalty” service management capabilities include, but are not limited to, configuration, capacity planning, system and application performance monitoring, billing, usage tracking, etc.

In one embodiment, these advantageous characteristics are made possible by employing system-aware and/or subsystem-aware application program interfaces (“APIs”), so that state and load knowledge may be monitored on a system and/or subsystem basis and application decisions made with real time, intimate knowledge concerning system and/or subsystem resources, for example, in a deterministic manner as described elsewhere herein. In this regard, “no penalty” state and load management may be made possible by virtue of API communication that does not substantially consume throughput resources, and may be further enhanced by conveyance IPC communication protocol that supports prioritized I/O operations (i.e., so that higher priority traffic will be allowed to flow in times of congestion) and overcomes weaknesses of message-bus architectures. Furthermore, features such as application offloading, flow control, and rate adaptation are enhanced by the true multi-tasking capability of the distributively interconnected asymmetrical multi-processor architectures described elsewhere herein. Among other things, these extensible and flexible architectures make possible optimized application performance including allowing application-aware scalability and intelligent performance optimization. Other advantages that may be realized in particular implementations of systems with these architectures include, but are not limited to, reduced space and power requirements as compared to traditional equipment, intelligent application ports, fast and simple service activation, powerful service integration, etc.

As previously described, differentiated business services, including those particular examples described herein, may be advantageously provided or delivered in one embodiment at or near an information source (e.g., at a content source or origin serving point or node, or at one or more nodes between a content source endpoint and a network core) using system embodiments described herein (e.g., FIGS. 1A or 2), or using any other suitable system architecture or configuration. In one embodiment, a network core may be the public Internet and an associated information source may be, for example, a capacity-constrained content source such as storage network, storage virtualization node, content server, content delivery data center, edge content delivery node, or similar node in communication with the network core. In this embodiment, differentiated business services may be provided to allocate resources and/or costs at the content source and/or at a point or node anywhere between the content source and the network core, even in those cases where the core and last mile of the network provide relatively inexpensive and unlimited bandwidth and other resources for content delivery. Thus, a method of differentiating business services outside of a network core, and/or at a location upstream of the core is advantageously provided herein. The ability to differentiate business services under such circumstances provides a method for allocating resources and enhancing revenue generation that is not available using conventional network systems and methods.

Although the delivery of differentiated business services may be described herein in relation to exemplary content delivery source embodiments, the practice of the disclosed methods and systems is not limited to content delivery sources, but may include any other type of suitable information sources, information management systems/nodes, or combinations thereof, for example, such as application processing sources or systems. For example, the description of content delivery price models and content delivery quality models is exemplary only, and it will be understood that the same principals may be employed in other information management embodiments (e.g., application processing, etc.) as information management price models, information management quality models, and combinations thereof. Further, the disclosed systems and method may be practiced with information sources that include, for example, one or more network-distributed processing engines in an embodiment such as that illustrated in FIG. 9D, for example. Such network-distributed information sources may also be described as being outside the network core.

In one differentiated content delivery embodiment, the disclosed differentiated business services may be implemented to provide differentiated services at a content source based on one or more priority-indicative parameters associated with an individual subscriber, class of subscribers, individual request or class of request for content, etc. Such parameters include those types of parameters described elsewhere herein (e.g., SLA policy, CoS, QoS, etc.), and may be user-selected, system-assigned, pre-determined by user or system, dynamically assigned or re-assigned based on system/network load, etc. Further, such parameters may be selected or assigned on a real time basis, for example, based on factors such as subscriber and/or host input, network and/or system characteristics and utilization, combinations thereof, etc. For example, a content subscriber may be associated with a particular SLA policy or CoS for all content requests (e.g., gold, silver, bronze, etc.) in a manner as previously described, or may be allowed to make real time selection of desired SLA policy or CoS on a per-content request basis as described further herein. It will be understood that the forgoing description is exemplary only and that priority indicative parameters may be associated with content delivery or other information management/manipulation tasks in a variety of other ways.

In one exemplary implementation of user-selected differentiated content delivery, a user may be given the option of selecting content delivery (e.g., a theatrical movie) via one of several pre-defined quality models, price/payment models, or combination thereof. In such an example, a high quality model (e.g., gold) may represent delivery of the movie to the subscriber with sufficient stream rate and QoS to support a high quality and uninterrupted high definition television (“HDTV”) presentation without commercials or ad insertion, and may be provided to the subscriber using a highest price payment model. A medium quality model (e.g., silver) may be provided using a medium price payment model and may represent delivery of the movie to the subscriber with a lower stream rate and QoS, but without commercials or ad insertion. A lowest quality model (e.g., bronze) may be provided using a lowest price payment model and may represent delivery of the movie to the subscriber with a lower stream rate and QoS, and with commercials or ad insertion. Quality/price models may so implemented in a multitude of ways as desired to meet needs of particular information management environments, e.g., business objectives, delivery configurations (e.g., movie download delivery rather than streaming delivery), etc.

When user selectable quality/price models are offered, a subscriber may choose a particular quality model based on the price level and viewing experience that is desired, e.g., gold for a higher priced, high quality presentation of a first run movie, and bronze for a lower priced, lower quality presentation of a second run movie or obscure sporting event, e.g. such as will be played in the background while doing other things. Such a selection may be may be based on a pre-defined or beforehand choice for all content or for particular types or categories of content delivered to the subscriber, or the subscriber may be given the option of choosing between delivery quality models on a real time or per-request basis. In one example, a GUI menu may be provided that allows a subscriber to first select or enter a description of desired content, and that then presents a number of quality/payment model options available for the selected content. The subscriber may then select the desired options through the same GUI and proceed with delivery of content immediately or at the desired time/s. If desired, a subscriber may be given the opportunity to change or modify quality/price model selection after content delivery is initiated. Examples of categories of content that may be associated with different quality and/or price models include, but are not limited to, news shows, situation comedy shows, documentary films, first run movies, popular or “hot” first run movies, old movies, general sports events, popular or “hot” sports events, etc.). Delivery of content at the selected quality/price model may be tracked and billed, for example, using system and method embodiments described elsewhere herein.

In another exemplary embodiment, multiple-tiered billing rates may be offered that are based on information management resource consumption that is controllable or dictated by the user. For example, a user may be offered a first billing rate tier linked to, for example, maximum amount of resource consumption for non-streaming or non-continuous content (e.g., maximum number of website hits/month, maximum number of HTTP files downloaded per month, maximum number of bytes of content streamed/month or downloaded/month from NAS, maximum amount of processing time consumed/month, etc.). In such an embodiment, resource consumption below or up to a defined maximum consumption rate may be delivered for a given flat fee, or may be delivered at a given cost per unit of resource consumption. One or more additional billing rate tiers (e.g., incremental flat fee, higher/lower cost per unit of resource consumption, etc.) may be triggered when the user's resource consumption exceeds the first tier maximum resource consumption level. It will be understood that such an embodiment may be implemented with a number of different billing rate tiers, and that more than two such billing rate tiers may be provided.

In another exemplary embodiment for content delivery, content delivery options may be offered to subscribers that are customized or tailored based on network and/or system characteristics such as network infrastructure characteristics, system or subsystem resource availability, application mix and priority, combinations thereof, etc. For example, a subscriber's last mile network infrastructure may be first considered so that only those content delivery options are offered that are suitable for delivery over the particular subscriber's last mile network infrastructure (e.g., subscriber's local connection bandwidth, computer processor speed, bandwidth guarantee, etc.). Such infrastructure information may be ascertained or discovered in any manner suitable for gathering such information, for example, by querying the subscriber, querying the subscriber's equipment, querying metadata (e.g., cookies) contained on the subscriber's computer, xSP, policy server, etc.

In one example, this concept may be applied to the user selectable quality/price model embodiment described above. In such a case, a subscriber with relatively slow dial-up or ISDN network access, and/or having a relatively slow computer processor, may only be given the option of a lowest quality model (e.g., bronze) due to restricted maximum stream rate. In another example, a subscriber may be provided with a plurality of content delivery options and recommendations or assessments of, for example, those particular content delivery options that are most likely to be delivered to the individual subscriber at high performance levels given the particular subscriber's infrastructure, and those that are not likely to perform well for the subscriber. In this case, the subscriber has the option of making an informed choice regarding content delivery option. The above approaches may be employed, for example, to increase the quality of a subscriber's viewing experience, and to reduce possible disappointment in the service level actually achieved.

In another example, customized or tailored content delivery options may be offered to subscribers based on characteristics associated with a particular request for content. In such an implementation, payment model and/or quality model may be host-assigned, system-assigned, etc. based on characteristics such as popularity of the requested content, category/type of the requested content (e.g., first run movie, documentary film, sports event, etc.), time of day the request is received (e.g., peak or off-time), overall system resource utilization at the time of the requested content delivery, whether the request is for a future content delivery event (e.g., allowing pre-allocation of necessary content delivery resources) or is a request for immediate content delivery (e.g., requiring immediate allocation of content delivery resources), combinations thereof, etc. For example, “hot” content such as highly popular first run movies and highly popular national sporting events that are the subject of frequent requests and kept in cache memory may be assigned a relatively lower price payment model based on the cost of delivery from cache or edge content delivery node, whereas more less popular or obscure content that must be retrieved from a storage source such as disk storage may be assigned a higher price payment model to reflect higher costs associated with such retrieval. Alternatively, it may be desirable to assign payment models and/or quality models based on a supply and demand approach, i.e., assigning higher price payment models to more popular content selections, and lower price payment models to less popular content selections. Whatever the desired approach, assignment of payment models may advantageously be made in real time based on real time resource utilization, for example, using the differentiated service capabilities of the disclosed systems and methods.

By offering customized or tailored content delivery options as described above, content may be made available and delivered on price and quality terms that reflect value on a per-request or per-content selection basis, reducing transaction costs and allowing, for example, content providers to recover costs required to maintain large libraries of content (e.g., a large number of theatrical movies) for video on demand or other content delivery operations. The disclosed methods thus provide the ability to match price with value and to recover content storage/delivery costs. This ability may be advantageously implemented, for example, to allow a large number of content selections to be profitably stored and made available to subscribers, including highly popular content selections as well as obscure or marginally popular content selections.

Utilizing the systems and methods disclosed herein makes possible the delivery of differentiated service and/or deterministic system behavior across a wide variety of application types and system configurations. Application types with which the disclosed differentiated service may be implemented include I/O intensive applications such as content delivery applications, as well as non-content delivery applications.

Advantageously, the disclosed systems and methods may be configured in one embodiment to implement an information utility service management infrastructure that may be controlled by an information utility provider that provides network resources (e.g., bandwidth, processing, storage, etc.). Such an information utility provider may use the capabilities of the disclosed systems and methods to maintain and optimize delivery of such network resources to a variety of entities, and in a manner that is compatible with a variety of applications and network users. Thus, network resources may be made available to both service providers and subscribers in a manner similar to other resources such as electricity or water, by an information utility provider that specializes in maintaining the network infrastructure and its shared resources only, without the need to worry or to become involved with, for example, application-level delivery details. Instead, such application-level details may be handled by customers of the utility (e.g., application programmers, application developers, service providers, etc.) who specialize in the delivery and optimization of application services, content, etc. without the need to worry or to become involved with network infrastructure and network resource details, which are the responsibility of the utility provider.

The utility provider service management characteristics of the above-described embodiment is made possible by the differentiated service capabilities of the disclosed systems and methods that advantageously allow differentiated service functions or tasks associated with the operation of such a utility (e.g., provisioning, prioritization, monitoring, metering, billing, etc.) to be implemented at virtually all points in a network and in a low cost manner with the consumption of relatively little or substantially no extra processing time. Thus, optimization of network infrastructure as well as applications that employ that infrastructure is greatly facilitated by allowing different entities (e.g., infrastructure utility providers and application providers) to focus on their individual respective specialties.

In one exemplary content delivery embodiment, such a utility provider service management infrastructure may be made possible by implementing appropriate content delivery management business objectives using an information management system capable of delivering the disclosed differentiated information services and that may be configured and provisioned as disclosed herein, for example, to have a deterministic system architecture including a plurality of distributively interconnected processing engines that are assigned separate information manipulation tasks in an asymmetrical multi-processor configuration, and that may be deterministically enabled or controlled by a deterministic system BIOS and/or operating system.

Uses of Distributed Interconnects

As previously described, one or more distributed interconnects may be employed in information management environments to distribute functionality, for example, among processing engines of an information management system and/or processing modules thereof. Distributive interconnects such as switch fabrics and virtual distributed interconnect backplanes, may be employed to establish independent paths from node to node and thus may be used to facilitate parallel and independent operation of each processing engine of a multi-processing engine information management system, e.g., to provide peer-to-peer communication between the engines on an as-needed basis. Besides data, a distributed interconnect may also transfer command and control information between the various peers via the distributed interconnect, and may be implemented to allow communication from one peer to multiple peers through a broadcast or multicast communication which is provided from one peer to multiple peers coupled to the interconnect (e.g., broadcast to all peers coupled to the interconnect). These and other features of distributed interconnects may be advantageously employed to optimize information management systems operations in a variety of system configurations, such as is described in the exemplary embodiments which follow. It will be understood that any description or illustration herein of embodiments employing single distributed interconnects are exemplary only, and that multiple interconnected distributed interconnects may be alternatively employed therein.

In one exemplary embodiment, a distributed interconnect may be employed to download or otherwise communicate an executable image from one or more image sources to one or more image receivers, such as one or more processing engines of an information management system. Examples of such executable images include, but are not limited to, initial images including one or more components such as boot code, operating system, management or application API's, applications, etc. One example of the interrelation of such components in an information management system environment is illustrated and described herein in relation to FIG. 7. The capability of communicating and downloading initial images to a processing engine or other type of image receiver across a distributed interconnect eliminates the need for providing each image receiver component of a multi-component system with separate storage (e.g., disk drive, additional FLASH memory, etc.) for storing its initial image. Instead, initial images for multiple image receivers may be accessible via a single image source or a relatively small number of image sources (e.g., stored and maintained for access by a single image source or by a relatively small number of image sources). Depending on system configuration, this capability may translate into one or more significant advantages such as fewer required system components, simplified system architecture and operation, increased ease of image update/revision, and cost savings.

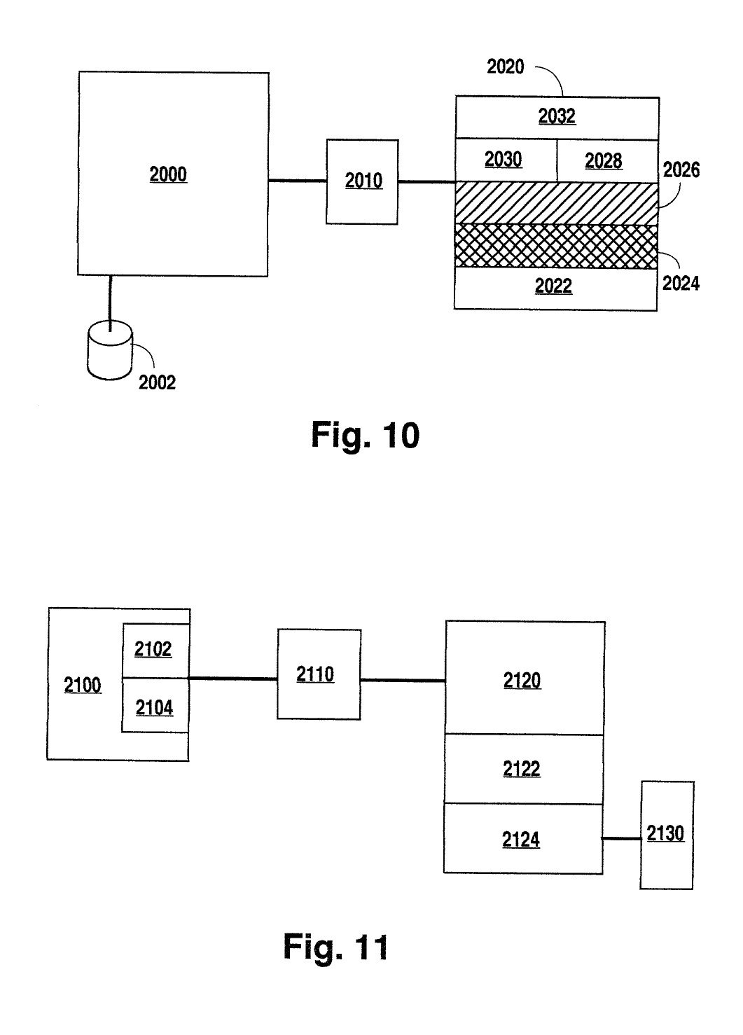

FIG. 10 shows an initial image source 2000 that may be, for example, a management processing (or host) engine 1060 as described elsewhere herein, or any other processing engine or other entity suitable for storing or otherwise accessing and communicating executable images to other processing engines or entities. Image source 2000 is shown distributively interconnected to image receiver 2020 via distributed interconnect 2010 that may be, for example, a switch fabric or other distributed interconnect 1080 as described elsewhere herein, and that may be coupled to a plurality of processing engines (not shown). Image receiver 2020 may be any processing engine or other entity that is capable of receiving and loading an executable image from image source 2000. Examples of processing engines that may be an image receiver 2020 include, but are not limited to, those processing engines of an information management system described elsewhere herein, such as application processing engine 1070, storage processing engine 1040, network processing engine 1030, transport processing engine 1050, combinations thereof, etc.

Although not illustrated, it is possible that multiple image sources 2000 and/or multiple image receivers 2020 (e.g., of same and/or differing types) may be distributively coupled together by one or more distributed interconnects 2010. For example, executable images for multiple image receivers 2020 and/or multiple types of image receivers may be stored/consolidated or otherwise accessible via a single image source 2000 or a fewer corresponding number of image sources 2000. Such a configuration may be implemented, for example, to minimize image storage requirements and/or to facilitate ease of image update/revision by allowing such to be performed on a single system or fewer number of systems. Also possible are multiple image sources 2000 that are capable of communicating executable images across distributed interconnect 2010 on an as-needed basis to one or more image receivers 2020. Such a configuration may be implemented, for example, to allow images of different types to be stored on (or to be otherwise accessible by) different image sources 2000, and to be selected and communicated to an appropriate image receiver 2020 when needed. In one such implementation, images may be selected and communicated without delay or with minimized delay from an available image source 2000 to an image receiver 2020, for example, when other image sources 2020 are busy or not capable of handling image download operations.

It will be understood that image receiver/s and corresponding image receiver/s may be implemented as components of any of the information management configuration embodiments described elsewhere herein. For example, image source/s and corresponding image receiver/s may be implemented as part of the same information management system, may reside in separate information management systems (e.g., clustered systems), may be separate components of a data center, may be separate components of an information management system that are in communication across a network via a virtual distributed interconnect, may be combinations thereof, etc.

Still referring to the exemplary embodiment of FIG. 10, image source 2000 is shown provided with an optional storage device 2002 that may be, for example, an Integrated Drive Electronics (“IDE”) disk, or other storage device/s and/or storage media suitable for storing and providing access to image source/s for one or more image receivers 2020. As shown in FIG. 10, image receiver 2020 may be provided with optional minimal boot code 2022 that may be stored locally on image receiver 2022, for example, in read-only memory (e.g., FLASH memory, etc.). Minimal boot code 2022 may be employed to provide image receiver 2022 with the knowledge required to listen for and receive further code from image source 2000 across distributed interconnect 2010. Upon start up, image receiver 2020 may load minimal boot code 2022 and enter a listen state in which it then begins listening for further information from image source 2000. In one embodiment, minimal boot code 2022 may include, or make up a portion of, system BIOS 1130 described in relation to FIG. 7.

As shown in FIG. 10, after minimal boot code 2022 is loaded, interim operating system 2024 may be communicated or sent from image source 2000 across distributed interconnect 2010 and loaded by image receiver 2020 on top of minimal boot code 2022.

Interim operating system 2024 may be loaded to provide image receiver 2020 with a transition from boot state to operating state (i.e., after loading operating system 2026). In this regard, an interim operating system 2024 may be any code suitable for providing image receiver 2020 with additional functionality required to download further code, such as operating system 2026 and optional management/application API's 2028 and 2030, across distributed interconnect 2010. Examples of suitable interim operating system codes include, but are not limited to, real time operating system codes based on “Thread-X” available from Express Logic, “Vx Works” and “pSOS” available from WindRiver, embedded systems such as “EMBEDDED NT” and “WINDOWS CE” available from Microsoft, etc.

In one exemplary implementation, image receiver 2020 may optionally notify image source 2000 of receipt and download of an executable image such as interim operating system 2024 or any other executable image described herein. Such a downloaded executable image received from image source 2000 may then remain quiescent on image receiver 2020 until receipt of an execution signal sent across distributed interconnect 2010 to image receiver 2020. An execution signal may be transmitted by image source 2000 or any processing engine or other entity capable of communicating such a signal to image receiver 2020 over distributed interconnect 2010. Upon receipt of such an execution signal, image receiver 2020 begins execution of the executable image.

After interim operating system 2024 is downloaded, operating system 2026 may be communicated from image source 2000 across distributed interconnect 2010 and loaded by image receiver 2020 to replace interim operating system 2024, as shown in FIG. 10.

Operating system 2026 may be any operating system suitable for providing an operating environment that enables image receiver 2020 to perform its desired role (e.g., to interface/port one or more applications, API's, etc.). Examples of suitable operating systems 2026 include, but are not limited to, operating systems based on Linux, Windows NT, FreeBSD, etc. Optional management API's 2028 and/or optional application API's 2030 may be downloaded with operating system 2026, or may downloaded on top of operating system 2026. Examples and further information on suitable operating systems and API's are described elsewhere herein, for example, in relation to FIG. 7.

After downloading of operating system 2026 (and optional management and/or application API's 2028 and 2030 if desired) to image receiver 2020, one or more applications 2028 may be downloaded on top of operating system 2026. Examples of such applications include, but are not limited to, one or more of those network content delivery applications 1180 described herein in relation to FIG. 7. One specific example of application 2028 is “RealServer” available from RealNetworks.

As previously mentioned, one or more components of an initial image may be updated or revised. In this regard, image update/revision may be performed on an image that is maintained on image source 2000, for example, by modifying an image stored on storage device/s 2002. The updated/revised image may then be loaded by image receiver 2020 on the next system start-up, for example, in a manner as previously described. Alternatively, an updated/revised image may be communicated from image source 2000 to image receiver 2020 across distributed interconnect 2010 on a real time basis. When performed on a real time basis, some components of the image (e.g., one or more applications 2032, one or more API's 2030 or 2028) may be communicated and loaded by image receiver 2010 without rebooting. Update/revision of other components on image receiver 2020 (e.g., operating system 2026) may require re-boot, although it is possible to selectively re-boot only those image receivers which require update/revised images without rebooting all components of a given information management system. It will also be understood that minimal boot code 2022 residing on image receiver 2022 may be updated across distributed interconnect 2010.

Whether or not re-boot is required, image source 2000 may initiate real time update/revision of an image stored on a image receiver by notifying or instructing image receiver 2020 that an image update/revision is pending. Depending on the desired implementation, image receiver 2020 may respond by immediately taking steps to receive the image update/revision (e.g., including re-boot if necessary) or by waiting until image update/revision is possible without interruption to ongoing operations. Alternatively, image source 2000 may be aware of ongoing operations performed by image receiver 2020 and/or the overall system and wait until update/revision is possible without interrupting ongoing operations. In another case, image receiver 2020 may become aware of internal problems and/or need for updated/revised images, and may notify image source 2000 of the same. A wide variety of other image update/revision policies are also possible including, but not limited to, only performing image update/revision during designated periods or systems downtime, performing critical updates/revisions on an expedited or immediate basis even if system interruptions are incurred and performing non-critical image updates/revisions as system activity levels permit so that system interruptions are not incurred, using image source 2000 as a management processing engine that manages system activity (e.g. content requests) by selectively diverting activity from a given image receiver 2020 to other image receivers 2020 or to other systems so that image update/revision to the given image receiver 2020 may be accomplished without interruptions to users (e.g., content viewers), etc.

In an alternate embodiment, one or more diagnostic features may be loaded by image receiver 2020 as executable images and then executed, rather than loading operating system 2026 to replace interim operating system 2024. Such diagnostic images may be part of interim operating system 2024 (e.g., THREAD-X diagnostics, etc.), or may be loaded on top of interim operating system 2024 instead of operating system 2026. In a manner similar to image updates/revisions, such diagnostic images may be communicated from image source 2000 to image receiver 2020 across distributed interconnect 2010 on a real-time or as-needed basis, and may be initiated by image source 2000 and/or image receiver 2020, for example, when a problem or other need for diagnostics are recognized by image source 2000 and/or image receiver 2020. Diagnostic image-loading policies may also be implemented, and may be similar to those policies described in the preceding paragraph for loading of image updates/revisions, i.e., using the same policies described above for image update/revisions but applied instead to diagnostic image-loading.

In another exemplary embodiment, a second processing object that is specific to a first processing object (e.g., a second processing object configured, selected or otherwise designated to work with a particular first processing object/s or type of first processing object/s) may be interfaced (e.g., accessed and/or managed, etc.) by such a first processing object/s across a distributed interconnect. In the practice of this embodiment, a first processing object may be any processing object that is suitable for interacting with a second processing object (e.g. suitable for interchanging data, commands, or other information with a second processing object, suitable for coordinating together to accomplish one or more information manipulation tasks, etc.) Specific examples of first processing objects include, but are not limited to application objects, file system objects, etc. Examples of second processing objects include, but are not limited to, buffer/cache objects, logical volume management objects, etc.

In an exemplary implementation, an application specific buffer/cache (e.g., a buffer/cache based on an algorithm optimized to work with the access pattern of a certain type of application) and/or file system specific logical volume management object (e.g., a logical volume manager configured to work with a certain type of file system) may be interfaced with a respective selected or otherwise designated application or file system across a distributed interconnect. It will be understood that these examples of first and second processing objects are exemplary only, and that a given processing object may be specific to two or more other processing objects. For example, a logical volume management object may be application specific (e.g., a logical volume manager implementing one or more RAID levels that are particular to, or address the needs of, a given application) and/or may be both file system specific and application specific.

In the exemplary embodiment of FIG. 11, a first processing engine 2100 is shown distributively interconnected to a second processing engine 2120 via distributed interconnect 2110 that may be, for example, a switch fabric or other distributed interconnect 1080 as described elsewhere herein, and that may be coupled to a plurality of processing engines (not shown). Second processing engine 2120 may be coupled via a storage device or disk controller (not shown) to one or more storage devices/content sources 2130 which may be, for example, any one or more of those storage devices or content sources described elsewhere herein. First processing engine 2100 may be any processing engine that is capable of executing an application and/or implementing a file system, such as application processing engine 1070 described elsewhere herein. Second processing engine 2120 may be any processing engine that is capable of providing access to storage device/content source 2130, executing buffer/cache algorithms, and/or executing logical volume management tasks. In one implementation, second processing engine 2120 may be, for example, a storage processing engine 1040 as described elsewhere herein.

Still referring to FIG. 11, first processing engine 2100 is shown executing an application 2102. Application 2102 may be any application that may reside on and be executed by an application processing engine. Examples of such applications include, but are not limited to, streaming media application (e.g., applications for Real Networks, Quick Time or Microsoft Windows Media streaming formats), an HTTP service application (e.g., web cache, web server or web proxy application such as “APACHE”, “NETSCAPE”, “MICROSOFT IIS”, etc.), a network attached storage (NAS) application, etc. First processing engine 2100 is also shown having a file system 2104 that may be, for example, “LINUX EXT-2”, “NTFS”, “HPFS”, etc.

As shown in FIG. 11, second processing engine 2120 may be provided with a buffer/cache 2122 that may be application specific to application 2102, and/or may be provided with a logical volume manager 2124 that may be file system specific to file system 2104. As used herein, “application specific” means that a particular buffer/cache 2122 is designed for, designated for, or is otherwise more suitable for use with, at least one corresponding application 2102 than is another given buffer/cache 2122 (e.g., non-application specific cache such as a conventional general purpose/generic disk cache, or a disk cache that is designed or designated for use with a different given application 2102). For example, a buffer/cache 2122 tailored to the access pattern of one or more streaming media content applications may be considered application specific for use with such streaming media application/s. Similarly, a buffer/cache 2122 designed for database applications may be considered application specific for use with database applications, and a buffer/cache 2122 designed for an HTTP Service application may be considered application specific for use with web cache, web server or web proxy applications.

By “file system specific” it is meant that a particular logical volume manager 2124 is designed for, designated for, or is otherwise more suitable for use with, at least one corresponding file system 2104 than is another given buffer/cache or logical volume manager 2124 (e.g., non-file system specific logical volume manager such as a conventional general purpose/generic logical volume manager, or a logical volume manager that is designed or designated for use with a different file system 2104). Implementing logical volume manager capability on second processing engine 2120 and accessing same across distributed interconnect 2110 advantageously allows processing workload to be offloaded from first processing engine 2100, which may be for example, an application processing engine as described elsewhere herein.

In the embodiment illustrated in FIG. 11, second processing engine 2120 may be implemented to provide first processing engine 2100 (and application 2102 running thereon) with access to data (e.g., cached data) or other information available from storage device/content source 2130. Buffer/cache 2122 may reside on and be implemented on processing engine 2130 using any suitable method, e.g. algorithm, etc. In this regard, buffer/cache 2122 may include, for example, any memory management method, system or structure suitable for logically or physically organizing and/or managing memory.

Examples of the many types of memory management environments with which the disclosed methods and systems may be employed include, but are not limited to, integrated logical memory management structures such as those described in U.S. patent application Ser. No. 09/797,198 filed on Mar. 1, 2001 which is entitled SYSTEMS AND METHODS FOR MANAGEMENT OF MEMORY; and in U.S. patent application Ser. No. 09/797,201 filed on Mar. 1, 2001 which is entitled SYSTEMS AND METHODS FOR MANAGEMENT OF MEMORY IN INFORMATION DELIVERY ENVIRONMENTS, each of which is incorporated herein by reference. Such integrated logical memory management structures may include, for example, at least two layers of a configurable number of multiple memory queues (e.g., at least one buffer layer and at least one cache layer), and may also employ a multi-dimensional positioning algorithm for memory units in the memory that may be used to reflect the relative priorities of a memory unit in the memory, for example, in terms of both recency and frequency. Memory-related parameters that may be may be considered in the operation of such logical management structures include any parameter that at least partially characterizes one or more aspects of a particular memory unit including, but are not limited to, parameters such as recency, frequency, aging time, sitting time, size, fetch (cost), operator-assigned priority keys, status of active connections or requests for a memory unit, etc.

Besides being suitable for use with integrated memory management structures having separate buffer and cache layers, the disclosed methods and systems may also be implemented with memory management configurations that organize and/or manage memory as a unitary pool, e.g., implemented to perform the duties of buffer and/or cache and/or other memory task/s. In one exemplary embodiment, such memory management structures may be implemented, for example, by a second processing engine 2120 in a manner such that read-ahead information and cached information are simultaneously controlled and maintained together by the processing engine. In this regard, “buffer/cache” is used herein to refer to any type of memory or memory management scheme that may be employed to store retrieved information prior to transmittal of the stored information to a first processing engine 2100. Examples include, but are not limited to, memory or memory management schemes related to unitary memory pools, integrated or partitioned memory pools, memory pools comprising two or more physically separate memory media, memory capable of performing cache and/or buffer (e.g., read-ahead buffer) tasks, etc.

Other examples of suitable systems and methods (e.g., using algorithms) that may be implemented as cache 2122 in first processing engine 2100 include, but are not limited to, systems and methods such as are described in U.S. patent application Ser. No. 09/947,869 filed on Sep. 6, 2001 and entitled “SYSTEMS AND METHODS FOR RESOURCE MANAGEMENT IN INFORMATION STORAGE ENVIRONMENTS”, by Chaoxin C. Qiu et al., which is incorporated herein by reference. Such methods may be employed to manage information management system I/O resources based on modeled and/or monitored I/O resource information and may be implemented to optimize information management system I/O resources for the delivery of a variety of data object types, including continuous streaming media data files. These methods and systems may be implemented in an adaptive manner that is capable of optimizing information management system I/O performance by dynamically adjusting information management system I/O operational parameters to meet changing requirements or demands of a dynamic application or information management system I/O environment using a resource management architecture. The resource management architecture may include, for example, a resource manager, a resource model, a storage device workload monitor and/or a storage device capacity monitor. The resource model may be configured to generate system performance information based on monitored storage device workload and/or storage device capacity information. The resource manager may be configured to manage information management system I/O operation and/or resources using the system performance information.

It will be understood that first processing engine/s 2100 and second processing engine/s 2120 may be implemented as components of any of the information management configuration embodiments described elsewhere herein. For example, first processing engine/s 2100 and second processing engine/s 2120 may be implemented as part of the same information management system, may be implemented in separate information management systems (e.g., clustered systems), may be separate components of a data center, may be separate components of an information management system that are in communication across a network via a virtual distributed interconnect, may be combinations thereof, etc. Although not illustrated in FIG. 11, one or more buffer/cache algorithms may reside on one or more second processing engines 2120 (e.g., on one or more storage processing engines), and one or more applications 2102 may reside on one or more first processing engines 2100 (e.g., on one or more application processing engines). For example, it is possible that multiple first processing engines 2100 and/or multiple second processing engines may be coupled together by one or more distributed interconnects 2110.

In operation of the embodiment of FIG. 11, a particular buffer/cache 2122 or logical volume manager 2124 that is application or file system specific to a corresponding respective application 2102 or file system 2104 may be selected or otherwise configured for use with the corresponding respective application 2102 or file system 2104 in any suitable manner, including by pre-assignment, and/or by assignment or reassignment on a real time basis. Although, the following example describes an example of the selection of a particular buffer/cache 2122 that is application specific for use with a given application 2102, it will be understood that the same or similar methodology may be followed for selection of a particular logical volume manager 2124 that is file specific for use with a given file system 2104. In this example, a single first processing engine 2100 executing an application 2102 may be coupled across a distributed interconnect 2110 to a single second processing engine 2120 having a buffer/cache 2122 that is assigned or otherwise designated to be application specific to the application 2102 running on the first processing engine 2100. In this example, application 2102 and buffer/cache 2122 may be pre-assigned or installed initially on respective first processing engine 2100 and second processing engine 2120 (e.g., during original system configuration and installation).

In the preceding example, it is also possible that application 2102, file system 2104, buffer/cache 2122, and/or logical volume manager 2124 may be replaced or modified after original configuration/installation on respective processing engine 2100 and/or second processing engine 2120, for example, on a real time or dynamic basis over distributed interconnect 2110. For example, a buffer/cache 2122 or logical volume manager 2124 may be modified or replaced so as to be application specific or file system specific to a new or modified respective application 2102 or file system 2104, or vice-versa. Alternatively, both buffer/cache 2122 and corresponding application 2102 and/or both logical volume manager 2124 and corresponding file system 2104 may be replaced or modified together in a manner that maintains the application specific or file system specific relationship. Exemplary methods of configuration and/or provisioning, including real time/dynamic reconfiguration and/or re-provisioning, may be found described and illustrated elsewhere herein, for example, in relation to steps 1220 through 1250 of FIG. 8.

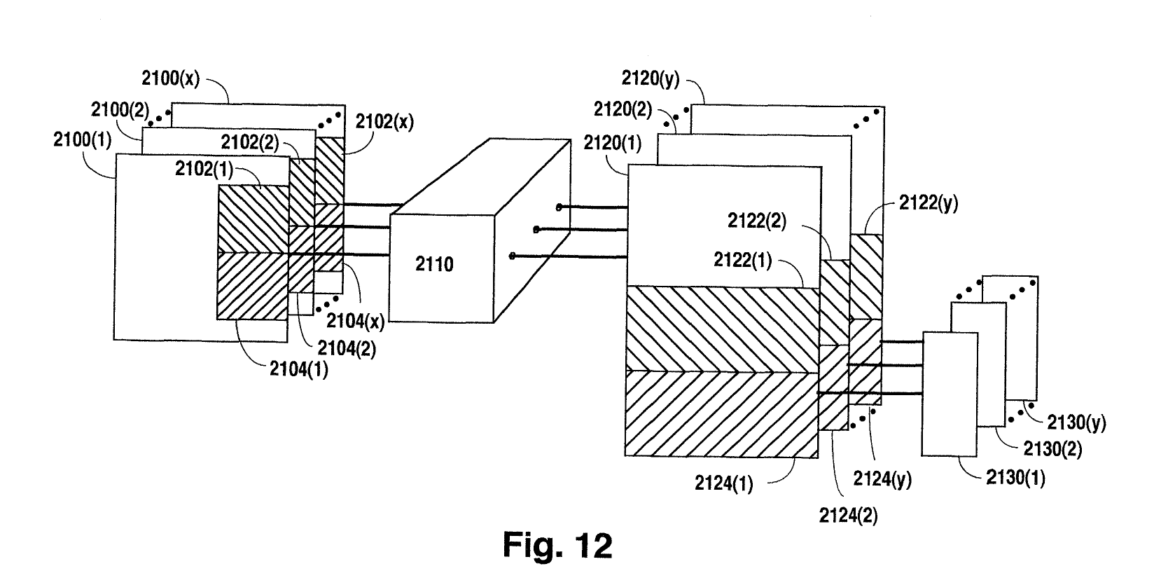

In the exemplary embodiment illustrated in FIG. 12, multiple first processing engines 2100₍₁₎ to 2100₍ₓ₎, each executing at least one respective application 2102₍₁₎ to 2102₍ₓ₎, may be distributively interconnected to multiple second processing engines 2120₍₁₎ to 2120_{(y)}, each having at least one respective buffer/cache algorithm 2102₍₁₎ to 2102_{(y)}, via distributed interconnect 2110. As shown, each of multiple first processing engines 2100₍₁₎ to 2100₍ₓ₎ may also be provided with at least one respective file system 2104₍₁₎ to 2104₍ₓ₎ and each of multiple second processing engines 2120₍₁₎ to 2120_{(y)} may also be provided with at least one respective logical volume manager algorithm 2124₍₁₎ to 2124_{(y)}. In FIG. 12, each of multiple second processing engines 2120₍₁₎ to 2120_{(y)} is also shown coupled to a respective storage device/content source 2130₍₁₎ to 2130_{(y)}.

In the embodiment of FIG. 12, the number of first processing engines may be at least two (i.e., x≧2), the number of second processing engines may be at least two (i.e., y≧2), and the number of first processing engines may be different than the number of second processing engines (i.e., the value of x may differ from the value of y). Although not illustrated, it is also possible that a single first processing engine 2100 may be distributively interconnected to two or more second processing engines 2120, or that a single second processing engine 2120 may be distributively interconnected to two or more first processing engines 2100 via distributed interconnect 2110. It is also possible that first processing engine/s 2100 may be distributively interconnected to second processing engine/s 2120 by more than one distributed interconnect 2110. Furthermore, it is possible that one or more second processing engines 2120 may be distributively interconnected to two or more storage device/content sources 2130, and/or that two or more second processing engines 2120 may be distributively interconnected to one or more of the same storage device/content sources 2130 (e.g., so that the same storage device/content sources 2130 may be selectably accessed by two or more second processing engines 2120 using different buffer/cache algorithms 2122 and/or logical volume management algorithms 2124).

The embodiment of FIG. 12 may be implemented so that the characteristics of the buffer/cache and/or logical volume management algorithms of at least one of the multiple second processing engines 2120 differs from the characteristics of the buffer/cache and/or logical volume management algorithms of at least one of the other second processing engines 2120, but is at the same time assigned or otherwise designated to be application specific or file system specific to at least one of the respective applications 2102 and/or file systems 2104 residing on multiple first processing engines 2100. Such a configuration may be implemented, for example, to allow a particular first processing engine 2100 that is executing a given application 2102 to retrieve information/data (e.g., content) from a particular storage device/content source 2130 using a selected second processing engine 2120 having a buffer/cache algorithm 2124 optimized for the particular access pattern of the given application 2102 running on the particular first processing engine 2120, and/or having a given logical volume management algorithm 2124 that is optimized for the given file system 2104 residing on the particular first processing engine 2120.

With regard to FIG. 12, it will be understood that one or more first processing engines 2100 may be selectably interconnected to one or more selected second processing engines 2120 using one or more distributed interconnects 2110, and that selective interconnection of first and second processing engines in the previously described manner may occur on a real time or as-needed basis depending on a variety of different criteria including, but not limited to, depending on the characteristics of a given application 2102 and/or file system 2104 residing on a particular first processing engine 2100 and the corresponding availability of application specific buffer/cache 2122 and/or file system specific logical volume manager 2124 residing on a particular second processing engine 2120, depending on the characteristics of data/content to be retrieved from a particular storage device/content source 2130, depending on the performance of a particular processing object residing on a given processing engine (e.g., performance of a particular buffer/cache and/or logical volume management object residing on a particular second processing engine 2120), depending on the storage functionality of a particular second processing engine 2120 (e.g. RAID functionality), depending on the data/content access characteristics of a particular second processing engine 2120 (e.g., access speed), depending on the capability of a particular processing object and/or processing engine (e.g., audio processing capability for building a web page having audio characteristics), combinations thereof, etc. It is also possible that two or more first processing engines 2100 may simultaneously each be selectably interconnected in the previously described manner to respective selected second processing engine/s 2120 (e.g., multiple first processing engines each being selectably interconnected to different second processing engines or being selectably interconnected to the same second processing engine), and vice-versa.

Furthermore, differentiated information management methodology described elsewhere herein may be employed to manage selective interconnection of one or more first processing engines 2100 to one or more selected second processing engines 2120 using one or more distributed interconnects 2110. For example, selective interconnection between any given first processing engine/s 2100 and any given second processing engine/s 2120 to access particular information/data from a given storage device/content source/s 2130 to satisfy a first need or request for information management (e.g. request for content delivery) may be managed relative to (e.g. prioritized relative to) other such selective interconnection operations required to satisfy a second need or request for information management based on one or more parameters associated with the individual first and second needs/requests for information management. Such parameters may include any of those parameters described elsewhere herein as suitable for differentiating information management tasks and may specifically include, for example, priority-indicative parameters associated with prioritizing communications across distributed interconnect 2110 that are extended or transferred so as to prioritize operations performed by first processing engine/s 2100 and/or second processing engine/s 2120 (e.g., the services/functions/tasks performed thereon).

As described in relation to FIG. 11, one or more applications 2102, one or more file systems 2104, one or more buffer/cache algorithms 2122, and/or one or more logical volume managers 2124 may be replaced or modified after original configuration/installation on a real time or dynamic basis over distributed interconnect 2110, for example, using the exemplary methods of configuration and/or provisioning described and illustrated in relation to steps 1220 through 1250 of FIG. 8.

In addition to selectably interconnecting particular first processing engine/s 2100 to particular second processing engine/s 2120 using one or more distributed interconnect/s 2110, it is also possible to manage operations of an application specific buffer/cache 2122 and/or a file system specific logical volume manager 2124 over one or more distributed interconnect/s 2110 via a separate reserved or dedicated communication path across the distributed interconnect 2110. In this regard, operations of a buffer/cache 2122 that may be so managed include, but are not limited to, configuration, gathering performance characteristics or data (e.g., to verify proper functioning), specifying security levels/gates (e.g., passwords, etc.). Operations of a logical volume manager 2124 that may be so managed include, but are not limited to, configuration (e.g., defining logical volumes and/or characteristics of logical volumes, such as defining number of RAID mirrors and size), loading content on to the logical volume manager (e.g., without interfering with user-access to data), etc. Advantageously, this embodiment may be used to provide a separate or reserved communication path for buffer/cache and/or logical volume manager management communication between a first processing engine 2100 and a second processing engine 2120 (e.g., inter-processor command communication between an application processing engine and a storage processing engine) that does not interfere with or reduce bandwidth for data/information (e.g., content) exchange between the first processing engine 2100 and the second processing engine 2120.

Still referring to FIGS. 11 and 12, management of one or more processing objects (e.g., buffer/cache algorithms 2122 and/or logical volume management algorithms 2124) may be implemented over a distributed interconnect 2110 using any processing engine configuration/methodology and/or information management system configuration/methodology suitable for effecting such management including, for example, any such configuration or methodology described elsewhere herein. In this regard, management of one or more processing objects such as buffer/cache algorithms 2122 and/or logical volume management algorithms 2124 over a distributed interconnect 2110 may be provided using any management entity suitable for managing a given processing object. Examples of suitable management entities include, but are not limited to, a separate processing engine, combination of processing engines, a separate system, combination of systems, manual/operator input, combinations thereof, etc.

In one exemplary embodiment, buffer/cache algorithms 2122 and/or logical volume management algorithms 2124 may be managed across a distributed interconnect 2110 by a management processing engine (host) (not illustrated in FIGS. 11 and 12) coupled to distributive interconnect 2110 in a manner such as described elsewhere herein. One example of such an embodiment may be implemented as follows using the system embodiments of FIGS. 1A or 1B. Referring to FIGS. 1A and 1B in conjunction with FIGS. 11 and 12, first processing engine/s 2100 may be application processing engine/s 1070 and second processing engine/s 2120 may be storage processing engine/s 1040, with management of buffer/cache algorithms 2122 and/or logical volume management algorithms 2124 being supplied by management processing engine 1060 over distributed interconnection 1080.

In another alternative embodiment, a distributed interconnect may be advantageously employed to facilitate coordination between multiple processing engines, e.g., in the performance of one or more operating tasks. In this regard, an operating task may be any task suitably performed in a coordinated manner between two or more members of a group of processing engines distributively interconnected by one or more distributed interconnects. Examples of operating tasks include, but are not limited to, fail over operations, load balancing operations, debugging operations, status monitoring operations, etc.

In one example, this capability may be advantageously employed between multiple processing engines executing the same or similar-type of applications, e.g., to implement operating tasks such as those employed for fail over and/or load-balancing purposes. In another example, a processing engine/s may utilize a distributed interconnect to monitor or query for the status of other needed resources (e.g., other applications or services), for example, on which the processing engine/s depends. In this embodiment, multiple processing engines may be distributively interconnected by a distributed interconnect in a variety of system configurations, including those described elsewhere herein. For example, multiple application processing engines of an information management system (e.g., content delivery system) may be distributively interconnected by a distributed interconnect, as illustrated and described in relation to FIGS. 1A through 1F. Multiple processing engines of multiple information management systems may be distributively interconnected by one or more distributed interconnects in clustered configurations, such as illustrated and described in relation to FIGS. 1G-1J. Multiple processing engines or one or more information management systems may also be distributively interconnected by virtual distributed interconnections, such as across a network as illustrated and described in relation to FIG. 9D.

In the presently described embodiment, multiple processing engines and/or processing modules thereof may coordinate across one or more distributed interconnections in any suitable manner that takes advantage of the distributive nature of the interconnection including, but not limited to, by employing multi-cast messaging between individual processing engines and/or modules thereof across the distributed interconnection/s. In such an example, communication, command and/or control information may be multicast from one peer to multiple peers (e.g. a multicast to all peers or to a selected or defined group of peers coupled to the distributed interconnect). This capability may be advantageously employed to facilitate failover operations, for example, upon the loss of one or more members of a group of multiple processing engines and/or modules thereof that are distributively interconnected by a distributed interconnect. In such a case, a group of multiple processing engines or modules thereof may include components of the same information management system, may include components of multiple information management systems (e.g., two or more clustered information management systems), and/or may include individual components operating in stand-alone manner.

In one example, a group of multiple processing engines may include multiple processing engines performing the same or similar information management tasks, and/or capable of performing the same or similar information tasks. One example of such a group may include two or more processing modules of a processing engine as described and illustrated in relation to FIG. 1A (e.g., a group of two or more network interface processing modules 1030a and 1030b, a group of two or more storage processing modules 1040a and 1040b, a group of two or more transport processing modules 1050a and 1050b, a group of two or more system management processing modules 1060a and 1060b, a group of two or more application processing modules 1070a and 1070b).

In another example, a group of multiple processing modules may include two or more processor modules capable of performing the same or similar information tasks as described and illustrated in relation to FIGS. 1C through 1F (e.g., a group of two or more processor modules 1003 capable of performing tasks of either a storage processing engine 1040 or a transport processing engine 1050, a group of two or more processor modules 1001 capable of performing tasks of either a transport processing engine 1050 or an application processing engine 1070). In this regard, such processor modules may be capable of being reconfigured or re-assigned (e.g., on a real time basis) to implement different processing engine functionalities upon failover of another processor module/s, and/or to implement load balancing among the processor modules.

In yet another example, a group of multiple processing engines may include two or more processing engines as described and illustrated in relation to FIG. 1J (e.g., a group of two or more processing engines 1030 distributively interconnected by distributed interconnects 1600 and 1080, etc.). Yet another example of such a group may include two or more processing engines as described and illustrated in relation to FIG. 9D (e.g., a group of two or more processing engines 1310 that are distributively interconnected across network 1340, etc.). It will be understood that the preceding examples are exemplary only, and that a group of multiple processing engines and/or processing modules thereof may include other processing engine configurations.

To facilitate failover operations among a group of multiple processing engines and/or modules thereof, the group may be kept apprised of the status of one or more individual members of the group (i.e., individual processing engines and/or modules) using a variety of multicasting techniques over one or more distributed interconnects. For example, each member of the group may stay in contact with other members of the group during normal operations, for example, by periodic multicast communications between members of the group. Alternatively, a failed processing engine or module may broadcast a failure alarm by multicast communication to other members of the group that indicates it has already failed or that failure is imminent. Upon loss of contact with a given processing engine or module (e.g., due to failure of the given processing engine or module), or upon receipt of a multicast failure alarm, one or more of the other members of the group may be configured to pick up or otherwise assume the load or tasks of the failed engine or module. In either case, protocol may be implemented to designate or otherwise select which remaining member/s pick up the tasks of the failed processing member (e.g., based on relative magnitude of the existing workload of each of the remaining members, based on a pre-designated failover sequence assigned to the remaining members, combinations thereof, etc.).

Alternatively, one or more designated members of a group (e.g., one or more designated processing engines/modules of the group, a designated processing engine/module separate from the group such as a system management processing engine, etc.) may monitor operations of one or more other members of the group (e.g., by periodic query, periodic notification received from other members of the group, by failure alarm received from a failed or failing member of the group, etc.). Upon notice of failure or imminent failure of a given member of the group, the designated member may broadcast a failure alarm by multicast communication across a distributed interconnect to other members of the group indicating the failure of the given member.

When implemented to facilitate load balancing among the individual members of a group of multiple processing engines and/or modules thereof, similar methodologies as employed for failover operations may be implemented. However, instead of multicast failure alarms, one or more individual members of the group may broadcast processing engine workload level details by multicast communication over one or more distributed interconnects to other members of the group, which may then act accordingly to balance the information management load among the members of the group. For example, such multicast workload level communications may be broadcast by a given processing engine or processing module to notify other members of the group that the given processing engine/module has a relatively light workload, a relatively heavy workload, to otherwise indicate the magnitude of the workload, etc. Upon receipt of such a multicast workload level communication, one or more other members of the group may then act in a manner similar to that described for failover operations as appropriate to achieve load balancing among the processing engines by transferring workload, e.g., to assume or take over additional information management workload from a heavily loaded member, to offload information management workload to a lightly loaded member, etc.

As with failover operations, protocols may be implemented to direct how information management loads are transferred or redistributed among members of a group of multiple processing engines and/or processing modules (e.g., based on relative magnitude of the existing workload of each member of the group, based on a pre-designated load balance sequence assigned to the members of the group, combinations thereof, etc.). Furthermore, it is also possible that a designated member of the group may monitor operations of one or more other members of the group, and may implement load balancing among the members of the group by multicast communication in a manner similar to that described for failover operations.

In addition to the above-described failover and load balancing embodiments, it is also possible to employ broadcast of multicast communications among multiple processing engines and/or processing modules across one or more distributed interconnects to establish or otherwise identify other processing engines and/or processing modules having one or more certain defined characteristic/s. Such characteristic/s may include, but are not limited to, common processing characteristics (e.g., an application running on a given processing engine/module may query for another instance/s of itself running on other processing engines/modules by sending a multicast message over a distributed interconnect), different but related processing characteristics (e.g., an application running on a given processing engine/module may query for services or other applications on which it depends and which are running on other processing engines/modules by sending a multicast message over the distributed interconnect), combinations thereof, etc. In some embodiments, use of multicast communications to establish/identify other members of a group having defined characteristic/s may be employed in conjunction with load balancing and/or failover operations as described above (e.g., to establish one or more members of a group of multiple processing engines/modules having common characteristics such as application being executed, processing capability, etc.). In other embodiments, use of multicast communications to establish/identify other members of a group having defined characteristic/s may be employed in a stand-alone manner, without using multicast communications for load balancing or failover operations.

When implemented together with load balancing and/or failover operations, it is possible in yet another embodiment that a heavily loaded and/or failing processing engine and/or processing module may broadcast a multicast query communication to other processing engines/modules of a group that requests certain information from the other members of the group (e.g., identity of application running on each processing engine/module, capability of each processing engine/module, workload of each processing engine/module, etc.). Upon receipt of information from other members of the group in response to the multicast query, the heavily loaded and/or failing processing engine/module may offload some or all of its workload to one or more of the other processing engines/modules of the group in any suitable manner, for example, based on pre-defined protocol, based on relative magnitude of workload of the other members of the group (e.g., more work offloaded to members with relatively lighter loads), combinations thereof, etc.

Applying a similar methodology under different circumstances, it is possible that a lightly loaded or newly added processing engine/module may issue a multicast query communication to other processing engines/modules of a group that requests information from the other members of the group (e.g., application identity, processing capability, processing workload, etc.). Upon receipt of information from other members of the group, the lightly loaded or newly added processing engine/module may assume workload from one or more of the other members of the group in any suitable manner, for example, based on pre-defined protocol, based on relative magnitude of workload of the other members of the group (e.g., more work assumed from members with relatively heavier loads), combinations thereof, etc.

In yet another embodiment, a specialized processing engine capable of performing specialized processing tasks my issue a multicast communication to other processing engines to signal the availability of its specialized processing capabilities. One or more other processing engines (e.g., less specialized processing engines) may respond by forwarding processing workload that can benefit from the specialized capabilities of the specialized processing engine. Such workload may be transferred by, for example, less specialized processing engines that are capable of performing the specialized processing tasks but in a less efficient manner, or by less specialized processing engines that are incapable of performing the specialized processing tasks. In an alternate embodiment, a less specialized processing engine may issue a multicast query asking for notification of specialized capability and/or an alert indicating need for specialized processing capability. In response, specialized processing engine/s may respond by indicating availability of specialized processing capability, and may then assume processing workload transferred from the less specialized processing engine.

Thus, it will be understood with benefit of this disclosure that multicast communications broadcast across one or more distributed interconnects among a group of multiple processing engines and/or processing modules may be implemented in a wide variety of ways and combinations thereof in order to identify processing characteristics and/or capabilities, to share processing workloads, to implement load balancing and/or failover operations, to identify need for additional type of processing capability and to increase the availability of that type of needed capability (e.g., including the identification of need for increased capability of performing a particular type of information management task, and achieving an increase in the capability for performing that particular type of information management task by notifying one or more processing engines capable of multiple information management functionalities of the need to switch to the information management type for which additional capability is needed), combinations thereof, etc. In each case, transfer of processing workload and/or processing capability among multiple processing engines/modules using multicast communications between the multiple processing engines/modules across one or more distributed/s may be advantageously implemented in real time and/or on an as-needed basis, for example, to continuously optimize system utilization, efficiency, and/or performance.

In yet another embodiment, code running on a first processing engine (e.g., running on an application processing engine or at least one module thereof) may be debugged or otherwise analyzed by sending debug messages/information from the first processing engine across one or more distributed interconnects to a second processing engine (e.g., a management processing engine or host), where the debug messages/information may be viewed, analyzed, and/or stored. Examples of such debug information include, but are not limited to, interprocessor communications and/or messages that are not otherwise visible beyond the communicating processors themselves and which may be analyzed to diagnose problems in code execution, “state” information (e.g., data structure state in RAM memory), information on program-type events that have occurred (e.g., programming level language, functions called, data structure changes, etc.), etc. In one implementation of this embodiment, debug information for a given processing engine of an information management system may be made accessible on the second processing engine, e.g., for analysis by human operator and/or for further external processing and analysis. In this regard, debug information may be retrieved from or otherwise communicated from the second processing engine, which may optionally store the debug information and/or communicate it in real time. Alternatively or additionally, debug information may be analyzed by the second processing engine itself, for example, using algorithms capable of performing protocol analysis to detect problems, capable of processing the information into human-readable form for manual viewing and diagnosis, combinations thereof, etc.

In one exemplary debugging configuration, a first processing engine may be, for example, an application processing engine 1070, and a second processing engine may be a management processing engine (or host) 1060 of an information management system (e.g., content delivery system) 1010 such as illustrated and described in relation to FIG. 1A and FIGS. 1C through 1F. In such a configuration, debug information may be transmitted or otherwise communicated externally from management processing engine 1060 using management interface 1062. In another exemplary debugging configuration, a first processing engine may be, for example, an application processing functionality 1320, and a second processing engine may be a host processing functionality 1330 of an information management system 1302, such as illustrated and described in relation to FIG. 9D.

In other embodiments, the disclosed systems and methods may utilize distributed interconnects to facilitate debugging tasks in additional ways. For example communications or messaging between two or more processing engines (e.g., between an application processing engine and a storage management processing engine or transport processing engine) may be multicast across one or more distributed interconnects and monitored or retrieved by a third processing engine (e.g., management processing engine). In one embodiment this may occur, for example, in response to a command or request issued by the third processing engine that instructs the first and/or second processing engine to multicast event-based and/or state-based debug information, and then listens for same. In this regard the third processing engine may also optionally specify the particular type/s of debug information to be broadcast. The third processing engine may in turn store, analyze and/or communicate externally these inter-processing engine communications, for example, in a manner as described above in relation to debug information. Inter-processing engine communications may be analyzed externally and/or by a third processing engine, for example, in a diagnostic manner to debug and/or optimize the code running on the two or more communicating processing engines. In this regard, a third processing engine may be configured to identify problems and/or inefficiencies between the communicating processing engines, to take corrective action to address problems and/or inefficiencies, to report an external alarm or other notification of problems, or a combination thereof.

In the practice of one embodiment of the disclosed systems and methods, one or more distributed interconnects may be utilized to selectably vary processing flow path configurations used, for example, to perform one or more information manipulation tasks associated with a given request for information management relative to another given request for information management. The capability of selecting processing flowpaths may be used to tailor or select the identity of processing engines, and the combination of information manipulation tasks, that are implemented to satisfy a given request for information processing. Advantages that may be realized by so tailoring flow path configurations include, for example, reduction in bandwidth between processing engines that do not need to communicate to satisfy a given request for information processing, acceleration of processing by eliminating such unnecessary communication steps, and/or the ability to tailor combinations of information manipulation tasks on a request by request basis in order to efficiently handle varying types of such requests using the processing engines of a common information system.

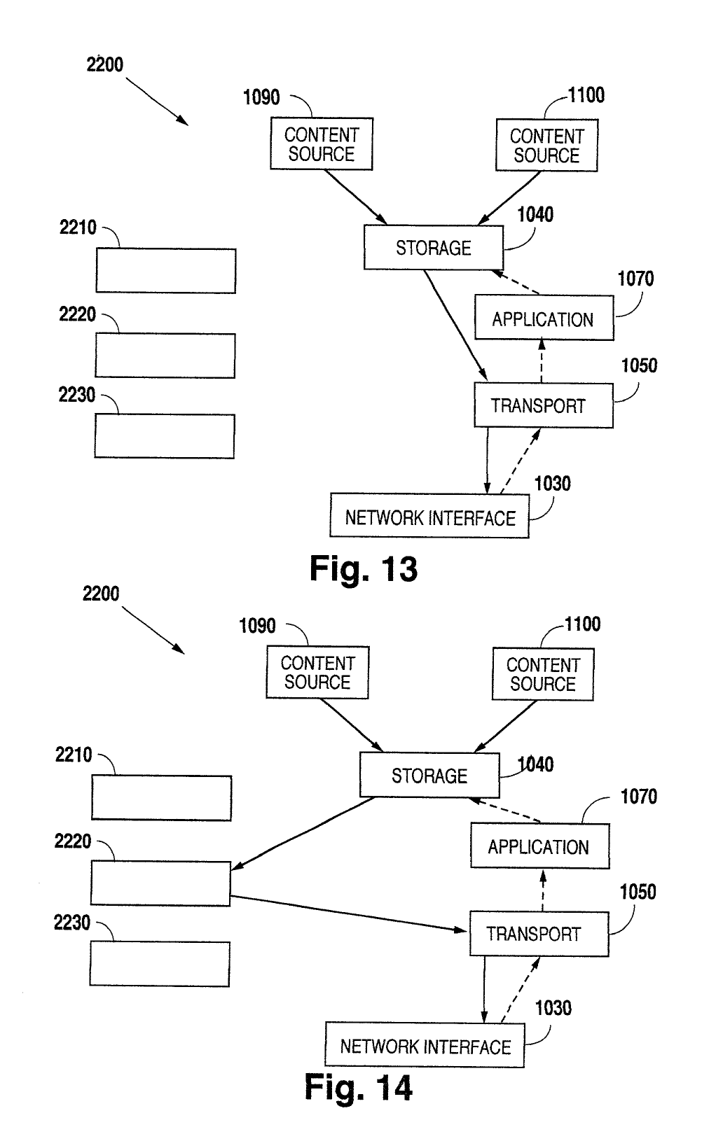

FIGS. 13-16 illustrate exemplary data and communication flow path configurations possible among processing engines or processing modules of one exemplary embodiment of an information management system 2200, in this exemplary case a content delivery system such has been previously described herein. The illustrated embodiment of FIGS. 12-15 employs a number of processing engines distributively interconnected, for example, using a distributed interconnect (not shown) such as a switch fabric. The processing engines of FIGS. 12-15 include a group of basic processing engines capable of performing basic information manipulation tasks (i.e., those information manipulation tasks that are needed to accomplish the designated information management task of content delivery). In the exemplary embodiment of FIGS. 12-15, the group of basic processing engines includes network application processing engine 1070, network transport processing engine 1050, storage management processing engine 1040, and network interface processing engine 1030. Storage management processing engine 1040 is shown coupled to content sources 1090 and 1100. It will be understood that the group of basic processing engines illustrated in FIGS. 1215 is exemplary only and that members of such a group may vary from embodiment to embodiment, depending on the particular needs of a designated information management task.

In FIGS. 13-16, additional processing engines 2210, 2220 and 2230 are also shown, and may include processing engines capable of performing selectable information manipulation tasks different than the basic information manipulation tasks performed by processing engines 1030, 1040, 1050 and 1070. Selectable information manipulation tasks may be any information manipulation task that is optional or otherwise additional to basic information manipulation tasks that are required to accomplish the designated information management task, in this exemplary embodiment, delivery of content. Examples of such additional selectable information manipulation tasks include, but are not limited to, tasks such as data encryption, data compression, security functions, transcoding, content filtering, content transformation, filtering based on metadata, metadata transformation, etc. It will be understood that although a particular exemplary content delivery system embodiment having three additional processing engines 2210, 2220 and 2230 is illustrated in FIGS. 12-15, that other types of information management system configurations having greater or fewer number of distributively interconnected additional processing engines may be implemented. Furthermore, it will be understood that types of information management other than content delivery, and that types/configurations of information management systems other than content delivery systems, may be implemented using this embodiment including any of the information management systems or combinations of such systems described elsewhere herein.

In FIGS. 13-16, inter-processor command or control flow (i.e. incoming or received data request) is represented by dashed lines, and delivered content data flow is represented by solid lines. As previously described herein, command and data flow between modules may be accomplished through the distributed interconnect that is coupled to each of the processing engines of system 2200. In this regard, FIG. 13 illustrates a request for content that is received and processed by network interface processing engine 1030 and then passed on to network transport processing engine 1050, then on to application processing engine 1070 and to storage management processing engine 1040 for processing and retrieval of the requested content from appropriate content sources 1090 and/or 1100. As shown, storage management processing engine 1040 then forwards the requested content directly to network transport processing engine 1050, which is then transferred via network interface processing engine 1030 to, for example, an external network 1020. As shown in FIG. 13, command and data flow bypasses additional processing engines 2210, 2220 and 2230 by virtue of the distributed interconnect to achieve a content delivery data flow similar to that described and illustrated in relation to FIG. 1B.

Selective bypassing of one or more processing engines using a distributed interconnect may be achieved in a manner as described elsewhere herein. For example, a data-request generated by network interface engine 1030 may include pertinent information such as the component ID of the various processing engines to be utilized in processing the request. Such information may be based on a variety of different parameters, e.g., based on one or more parameters associated with a particular request for information management, one or more parameters associated with a particular type of information management requested, one or more parameters associated with a particular user or class of users, one or more parameters associated with system workload, combinations thereof etc. Such information may also include identifiers or tags associated with requests for information that may be recognized and acted on, or revised/replaced by one or more processing engines coupled to the distributed interconnect so as to achieve selective routing between the processing engines.

It is also possible that one or more individual processing engines may be capable of recognizing or identifying one or more parameters or characteristics associated with the information being managed and in response, altering the data flow path between processing engines based thereon. Such parameters or characteristics may include substantive characteristics such as objectionable subject matter included in requested content, particular language of text in requested content, security-sensitive information such as social security numbers or bank account numbers included in requested content, premium subject matter included in content requested by a non-premium user, user-identified subject matter included in the requested content (i.e., specific types of subject matter included in content requested by a user who has indicated that such types of subject matter are undesirable or that should otherwise be processed using particular information manipulation task/s, etc.). Combinations of these and other parameters/characteristics may considered and used to selectively route the data flow between processing engines.

FIG. 14 illustrates an alternate data and communication flow path configuration that may be implemented using the same information management system embodiment of FIG. 13, this time using the distributed interconnect to route requested content from storage processing engine 1040 to additional processing engine 2220, prior to forwarding it to transport processing engine 1050. Additional processing engine 2220 may, for example, be capable of at least one of filtering the content (e.g., filtering out objectionable images from the content, filtering out premium subject matter from the content, filtering out pre-selected word-types or other pre-selected undesirable characteristics of the content), transforming the content (e.g., transforming text of content from one language to another), encrypting the content (e.g. encoding the content for security purposes), combinations thereof, etc. For example, objectionable subject matter contained in retrieved content may be identified by storage management processing engine 1040 and sent to additional processing engine 2220 for filtering. Storage management processing engine 1040 may also make the decision to route the content to additional processing 2220 prior to transport processing engine 1050 based on a request having, for example, a parental control parameter for restricting access to such subject matter. Alternatively, this routing decision may also be based on such a parental control parameter associated with the request, in combination with the identification of objectionable subject matter by storage management processing engine 1040. Similar methodology (e.g., using parameters associated with an information management request and/or identification of parameters/characteristics associated with the information itself) may be applied to routing decisions made based on need for content transformation, need for content encryption, etc.

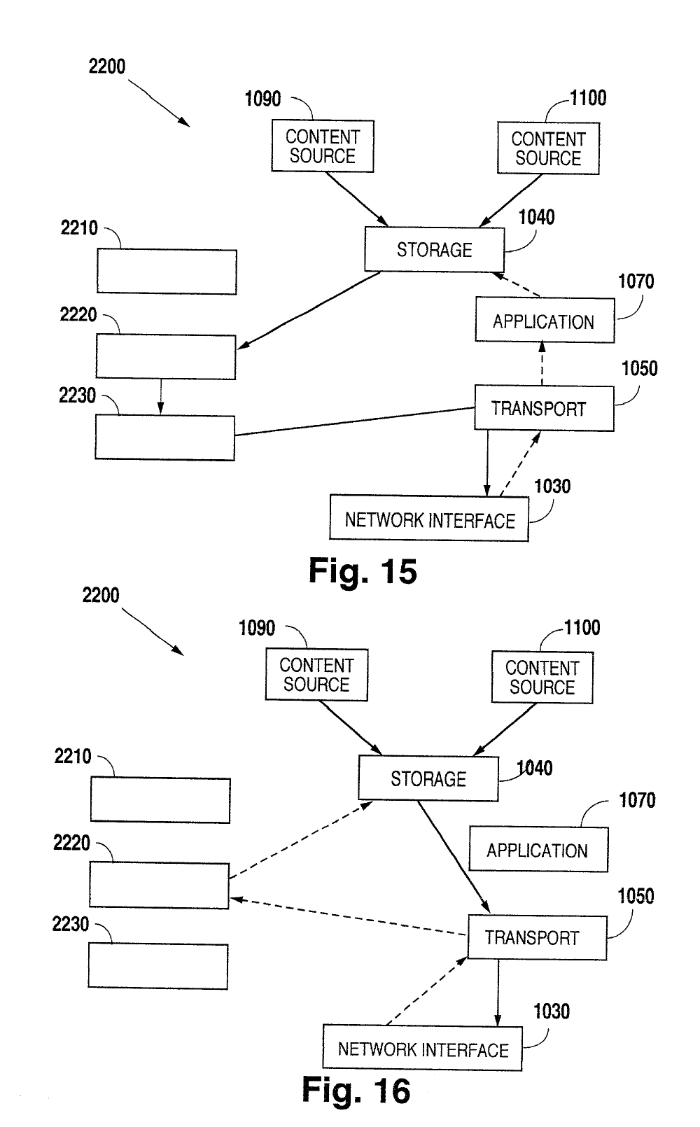

FIG. 15 illustrates an alternate data and communication flow path configuration that may be implemented using the same information management system embodiment of FIGS. 13 and 14, this time using the distributed interconnect to route requested content from storage processing engine 1040 to additional processing engines 2220 and 2230, prior to forwarding it to transport processing engine 1050. Such a data flow path may be implemented, for example, when need for multiple separate additional information manipulation tasks (e.g., filtering and encryption, filtering and transformation, encryption and transformation, etc.) is identified based on one or more parameters as previously described. Although not shown, another possible data flow path may include routing content through all three additional processing engines 2210, 2220 and 2230 prior to transport processing engine 1050 where need for the processing capabilities of all three of the additional processing engines is recognized and/or dictated as described elsewhere herein. Thus, multiple additional processing engines may be provided (e.g., each possessing different additional processing capabilities), and multiple alternative data flow paths generated therebetween as necessary or desired for individual information management tasks based on a variety of different parameters/characteristics and combinations thereof as described elsewhere herein.

FIG. 16 illustrates yet another data and communication flow path configuration that may be implemented using the same information management system embodiment of FIGS. 13-15, this time using the distributed interconnect to route command/control flow (i.e., incoming or received data request) to additional processing engine 2220 rather than application processing engine 1070, prior to forwarding the request on to storage processing engine 1040. Such a flow path may be implemented, for example, to tailor a particular type of information management request to a corresponding processing capability, to differentiate between processing of different information management requests based on priority-indicative parameters associated therewith (e.g., higher priority requests to higher speed processors and vice-versa), to distribute processing load among multiple processors, to assign particular class or subset of request to particular processing engines (e.g., to optimize buffer/cache availability and/or data hit ratio), combinations thereof, etc.

Thus, it will be understood with benefit of this disclosure that one or more distributed interconnects, such as switch fabrics, may be implemented in a variety of information management embodiments, and combinations of such embodiments, to allow asymmetric and/or independent interaction and/or communication between processing engines and/or processing modules thereof to achieve a wide range of advantages including, but not limited to, increased system efficiencies, accelerated performance, deterministic behavior, differentiated service, etc. Examples of just a few of such embodiments described elsewhere herein or that may be otherwise implemented include, but are not limited to, the following embodiments.

Accessing one or more applications (e.g., media streaming applications, HTTP serving applications, NAS applications, HTTP proxy/caching applications, streaming media proxy/caching applications, etc.) using a network transport processor that receives requests for these service from external clients/users over a distributed interconnect, such as a switch fabric.

Using a management processing engine to command one or more other processing engines (e.g., storage processing engine, application processing engine, network transport processing engine, network interface processing engine, etc.) to reboot by issuing such a command over a distributed interconnect, such as a switch fabric.

Using an agent that measures resource utilization (e.g., utilization of CPU, memory, fabric bandwidth, etc.) and reports the measured utilization over a distributed interconnect, such as a switch fabric.

Processing admission control requests/responses over a distributed interconnect, such as switch fabric, for example as follows: 1) A particular processing engine such as storage processing engine receives a request for service; 2) Before servicing the request it checks with a management processing engine to determine whether it should service the request; 3) The management processing engine may base its decision and response to the storage processing engine on any number of factors including, but not limited to, the current load the system is servicing, whether the request comes from an authorized user, identity of content the request will access, etc.

An application processing engine may mount a disk drive directly connected to a management processing engine using a transport protocol that runs over a distributed interconnect, such as a switch fabric.

A firmware image residing in ROM (e.g., FLASH) memory may be updated with a new image that is sent over a distributed interconnect, such as a switch fabric.

Messages/communications used to manage an application may be sent to/from a management processing engine to an application processing engine over a distributed interconnect, such as a switch fabric.

Activity (e.g., aliveness) of an application may be polled by a management processing engine by sending messages to the application over a distributed interconnect, such as a switch fabric.

An application may log access events to a management processing engine over a distributed interconnect, such as a switch fabric.

### EXAMPLES

The following hypothetical examples are illustrative and should not be construed as limiting the scope of the invention or claims thereof.

Examples 1-3 relate to an application that is delivering streams (e.g., video streams) of long duration. In the following examples, it is assumed that one subdirectory contains premium content (subdirectory P), and that other subdirectories on the file system have non-premium content. An external authorization scheme is provided to direct premium customers to the/P directory, and to deny access to this directory for non-premium users. In the scenario of the following examples, all policies are based on two priorities, and do not take into account other parameters that may be considered such as delivered bandwidth, storage or FC utilization, utilization of other system resources, etc.

### Example 1

### Strict Bandwidth Allocation Policy

In this example, the admission control policy states that 100 Mbit/s is reserved for premium content. No additional bandwidth is to be used for premium content. There are multiple logical conditions that must be detected and responses considered. 1000 Mbit/s is the maximum deliverable bandwidth.

Under the admission control policy of this example, a premium stream will be admitted if the total premium bandwidth after admission will be less than or equal to 100 Mbit/s, but will be denied admission if the total premium bandwidth after admission will exceed 100 Mbit/s. A non-premium stream will be admitted if total non-premium bandwidth after admission will be less than or equal to 900 Mbit/s, but will be denied admission if the total non-premium bandwidth after admission will be greater than 900 Mbit/s.

### Example 2

### Additional Premium Bandwidth Allocation Policy

In this example, the admission control policy states that 100 Mbit/s is reserved for premium content, but premium content will be allowed to peak to 200 Mbit/s, where bandwidth allocation to premium content greater than 100 Mbit/s will generate incremental billable traffic. Bandwidth from non-premium content is decreased in support of any additional premium bandwidth admitted. Therefore, in this example the platform is not oversubscribed.

Under the admission control policy of this example, a premium stream will be admitted if the total premium bandwidth after admission will be less than or equal to 200 Mbit/s, but will be denied admission if the total premium bandwidth after admission will exceed 200 Mbit/s. A log event will occur if total premium bandwidth admitted is greater than 100 Mbit/s. A non-premium stream will be admitted if total non-premium bandwidth after admission will be less than or equal to 800 Mbit/s, but will be denied admission if the total non-premium bandwidth after admission will be greater than 800 Mbit/s.

### Example 3

### Bandwidth Allocation Policy with Oversubscription

In this example, the admission control policy states that 100 Mbit/s is reserved for premium content. No additional bandwidth is to be used for premium content. Additional non-premium streams will be accepted if total bandwidth already being served is greater than 900 Mbit/s, and under the condition that premium users are NOT currently utilizing the full 100 Mbit/s. This scenario requires not only admission control behavior, but also requires system behavior modification should premium users request access when some of the 100 Mbit/s is being employed for non-premium streams.

Under the admission control policy of this example, a premium stream will be admitted if the total premium bandwidth after admission will be less than or equal to 100 Mbit/s, but will be denied admission if the total premium bandwidth after admission will exceed 100 Mbit/s. If the new total bandwidth after admission of a new premium stream will be greater than 1000 Mbit/s, non-premium streams will be degraded so that the total delivered bandwidth will be less than or equal to 1000 Mbit/s. A non-premium stream will be admitted if total admitted bandwidth (i.e., premium plus non-premium) after admission will be less than or equal to 1000 Mbit/s, but will be denied admission if the total admitted bandwidth after admission will be greater than 1000 Mbit/s.

To implement the policy of this example, bandwidth degradation of non-premium pool of streams may be accomplished, for example, by dropping one or more connections or typically more desirably, by degrading the rate at which one or more non-premium streams are delivered. In the latter case, once some of the premium bandwidth frees up, the non-premium streams may again be upgraded if so desired.

The three forms of policies represented in the foregoing examples may be used to handle an almost infinite number of possible configurations of an information management system or platform, such as a system of the type described in relation to the embodiment of FIG. 7. Furthermore, it will be understood that the principles utilized by these examples may be extended to cover a variety of information management scenarios including, but not limited to, for content delivery of multiple premium ‘channels’, for content delivery of multiple levels of premium channel, for metering bandwidth from a device serving files for multiple customers (e.g., where the customers have different classes of service), etc. Furthermore, an information management system utilizing the methodology of the above examples may also include an optional utility as previously described herein that helps a HSP who is deploying the platform to choose an optimum configuration for maximizing revenue.

It will be understood with benefit of this disclosure that although specific exemplary embodiments of hardware and software have been described herein, other combinations of hardware and/or software may be employed to achieve one or more features of the disclosed systems and methods. For example, various and differing hardware platform configurations may be built to support one or more aspects of deterministic functionality described herein including, but not limited to other combinations of defined and monitored subsystems, as well as other types of distributive interconnection technologies to interface between components and subsystems for control and data flow. Furthermore, it will be understood that operating environment and application code may be modified as necessary to implement one or more aspects of the disclosed technology, and that the disclosed systems and methods may be implemented using other hardware models as well as in environments where the application and operating system code may be controlled.

Thus, while the invention may be adaptable to various modifications and alternative forms, specific embodiments have been shown by way of example and described herein. However, it should be understood that the invention is not intended to be limited to the particular forms disclosed. Rather, the invention is to cover all modifications, equivalents, and alternatives falling within the spirit and scope of the invention as defined by the appended claims. Moreover, the different aspects of the disclosed apparatus, systems and methods may be utilized in various combinations and/or independently. Thus the invention is not limited to only those combinations shown herein, but rather may include other combinations.

What is claimed is:

1. A system for loading an executable image on to at least one image receiver, said system comprising:
at least one image source, said image source having access to at least one executable image; and
at least one image receiver coupled to said at least one image source by a distributed interconnect;
wherein said at least one image source is capable of communicating said executable image to said at least one image receiver across said distributed interconnect for loading on to said at least one image receiver.

2. The system of claim 1, wherein said distributed interconnect comprises a switch fabric.

3. The system of claim 1, wherein said distributed interconnect comprises a virtual distributed interconnect.

4. The system of claim 2, wherein said executable image comprises a diagnostic image.

5. The system of claim 2, wherein said executable image comprises an initial image.

6. The system of claim 5, wherein said image source comprises a management processing engine, and wherein said image receiver comprises an application processing engine.

7. The system of claim 6, wherein said initial image comprises at least one of a boot code, an operating system, an application program interface, an application, , or a combination thereof.

8. The system of claim 6, wherein said image source and said image receiver comprise components of an information management system.

9. The system of claim 6, wherein said information management system comprises multiple image sources, multiple image receivers, or a combination thereof; and wherein said multiple image sources are coupled to at least one image receiver by said switch fabric, wherein said multiple image receivers are coupled to at least one image source by said switch fabric, or a combination thereof.

10. The system of claim 8, wherein said information management system comprises a content delivery system.

11. The system of claim 10, wherein said content delivery system comprises an endpoint content delivery system.

12. The system of claim 2, wherein said image source has access to a plurality of different executable images; wherein said image receiver comprises a first image receiver; and wherein said method comprises selecting and communicating a first one of said plurality of executable images from said image source to said first image receiver across said switch fabric.

13. The system of claim 12, wherein said method further comprises selecting and communicating a second one of said plurality of executable images from said image source across said switch fabric to a second image receiver coupled to said image source by said switch fabric.

14. The system of claim 2, wherein a first image source has access to a first executable image, and a second image source has access to a second executable image, said first and second executable images being different from each other; wherein said first and second image sources are coupled to said at least one image receiver by said switch fabric; and wherein said method comprises selecting and communicating at least one of said first or second executable images from said respective first or second image source to said image receiver across said switch fabric.

15. A method of loading an executable image on to at least one image receiver, said method comprising:
communicating said executable image from at least one image source to said at least one image receiver; and
loading said executable image on to said image receiver;
wherein said at least one image source and said at least one image receiver are coupled together by a distributed interconnect; and wherein said executable image is communicated from said at least one image source to said at least one image receiver across said distributed interconnect.

16. The method of claim 15, wherein said distributed interconnect comprises a switch fabric.

17. The method of claim 15, wherein said distributed interconnect comprises a virtual distributed interconnect.

18. The method of claim 16, wherein said executable image comprises a diagnostic image.

19. The method of claim 16, wherein said executable image comprises an initial image.

20. The method of claim 19, wherein said image source comprises a management processing engine, and wherein said image receiver comprises an application processing engine.

21. The method of claim 20, wherein said initial image comprises at least one of a boot code, an operating system, an application program interface, an application, or a combination thereof.

22. The method of claim 20, wherein said image source and said image receiver comprise components of an information management system.

23. The method of claim 22, wherein said information management system comprises a content delivery system.

24. The method of claim 23, wherein said content delivery system comprises an endpoint content delivery system.

25. The method of claim 16, wherein said executable image remains quiescent after said loading on said image receiver; and wherein said method further comprises communicating an execution signal to said image receiver across said switch fabric, said execution signal instructing said image receiver to being execution of said executable image.

26. The method of claim 16, wherein said image source has access to a plurality of different executable images; wherein said image receiver comprises a first image receiver; and wherein said method comprises selecting and communicating a first one of said plurality of executable images from said image source to said first image receiver across said switch fabric.

27. The method of claim 26, wherein said method further comprises selecting and communicating a second one of said plurality of executable images from said image source across said switch fabric to a second image receiver coupled to said image source by said switch fabric.

28. The method of claim 16, wherein a first image source has access to a first executable image, and a second image source has access to a second executable image, said first and second executable images being different from each other; wherein said first and second image sources are coupled to said at least one image receiver by said switch fabric; and wherein said method comprises selecting and communicating at least one of said first or second executable images from said respective first or second image source to said image receiver across said switch fabric.

29. A system for interfacing a first processing object with a second processing object, said system comprising:
a first processing engine, said first processing engine having said first processing object residing thereon; and
a second processing engine coupled to said first processing engine by a distributed interconnect, said second processing engine having said second processing object residing thereon;
wherein said second processing object is specific to said first processing object, and wherein said first object is capable of interfacing with said second object across said distributed interconnect.

30. The system of claim 29, wherein said distributed interconnect comprises a switch fabric.

31. The system of claim 29, wherein said distributed interconnect comprises a virtual distributed interconnect.

32. The system of claim 30, wherein said interfacing comprises accessing, managing, or a combination thereof.

33. The system of claim 32, wherein said first processing engine comprises an application processing engine; and wherein said second processing comprises a storage processing engine.

34. The system of claim 33, wherein said first processing object comprises an application object; and wherein said second processing object comprises a buffer/cache object that is specific to said application object.

35. The system of claim 33, wherein said first processing object comprises a file system object; and wherein said second processing object comprises a logical volume management object that is specific to said file system object.

36. The system of claim 34, wherein said first processing engine further has a file system object residing thereon, and said second processing engine further has a logical volume management object residing thereon; wherein said logical volume management object is specific to said file system object; and wherein said file system object is capable of interfacing with said logical volume management object across said distributed interconnect.

37. The system of claim 36, further comprising at least one content source coupled to said storage processing engine; and wherein said second processing engine is capable of providing said first processing engine with access to content available from said content source across said distributed interconnect.

38. The system of claim 33, wherein said first processing engine and said second processing engine comprise components of an information management system.

39. The system of claim 38 wherein said information management system comprises a content delivery system.

40. The system of claim 39, wherein said content delivery system comprises an endpoint content delivery system.

41. The system of claim 30, wherein said interfacing comprises managing, and wherein said managing occurs over said distributed interconnect via a separate designated communication path.

42. The system of claim 30, wherein said system comprises:
at least two first processing engines, each of said first processing engines having at least one respective first processing object residing thereon;
at least two second processing engines, each of said second processing engines having at least one respective second processing object residing thereon;
wherein said first objects are capable of interfacing with said second objects across said distributed interconnect;
wherein the characteristics of a given second processing object residing on at least one of said second processing engines differs from the characteristics of an other second processing object residing on an other one of said second processing engines; and
wherein said given second processing object is specific to a given first processing object residing on at least one of said first processing engines, and wherein said other second processing object is specific to an other first processing object residing on at least one of said first processing engines.

43. The system of claim 42, wherein any one of said first processing engines is selectably interconnectable to any one of said second processing engines across said distributed interconnect so that a selected first processing object residing on one of said first processing engines may be selectably interfaced with a selected second processing object residing on one of said second processing engines that is specific to said selected first processing object.

44. The system of claim 43, wherein any one of said first processing engines is selectably interconnectable to any one of said second processing engines across said distributed interconnect so that a selected first processing object residing on one of said first processing engines may be selectably interfaced with a selected second processing object residing on one of said second processing engines on a dynamic basis.

45. The system of claim 44, wherein said selected first processing object is selectably interfaceable with said second processing object in response to a first request for information management, relative to selective interfacing operations between first processing objects and second processing objects in response to a second request for information management, in a manner based at least in part on one or more parameters associated with individual respective requests for information management.

46. The system of claim 43, wherein each of said first processing engines comprises a first application processing engine of a content delivery system, and wherein each of said second processing engines comprises a storage processing engine of said content delivery system; wherein said selected first processing object may be selectably interfaced with said selected second processing object to allow a first processing engine on which said selected first processing object resides to retrieve content from a content source using a second processing engine on which said selected second processing object resides.

47. The system of claim 46, wherein said selected first processing object comprises a selected application processing object and wherein said selected second processing object comprises a selected buffer/cache processing object specific to said selected application processing object; wherein said selected first processing object comprises a selected file system processing object and wherein said selected second processing object comprises a selected logical volume management processing object specific to said selected file system processing object; or a combination thereof.

48. The system of claim 47, wherein said content delivery system comprises an endpoint content delivery system.

49. A method of interfacing a first processing object with a second processing object, said method comprising interfacing said second processing object with said first processing object across a distributed interconnect; wherein said second processing object is specific to said first processing object.

50. The method of claim 49, wherein said first processing object resides on a first processing engine; wherein said second processing object resides on a second processing engine; and wherein said interfacing comprises coupling said first processing engine to said second processing engine using said distributed interconnect.

51. The method of claim 50, wherein said distributed interconnect comprises a switch fabric.

52. The method of claim 50, wherein said distributed interconnect comprises a virtual distributed interconnect.

53. The method of claim 51, wherein said interfacing comprises accessing, managing, or a combination thereof.

54. The method of claim 53, wherein said first processing engine comprises an application processing engine; and wherein said second processing comprises a storage processing engine.

55. The method of claim 54, wherein said first processing object comprises an application object; and wherein said second processing object comprises a buffer/cache object that is specific to said application object.

56. The method of claim 54, wherein said first processing object comprises a file system object; and wherein said second processing object comprises a logical volume management object that is specific to said file system object.

57. The method of claim 55, wherein said first processing engine further has a file system object residing thereon, and said second processing engine further has a logical volume management object residing thereon; wherein said logical volume management object is specific to said file system object; and wherein said method further comprises interfacing said logical volume management object with said file system object across said distributed interconnect.

58. The method of claim 57, wherein said storage processing engine is coupled to at least one content source; and wherein said method further comprises providing using said storage processing engine to provide said first processing engine with access to content available from said content source across said distributed interconnect.

59. The method of claim 54, wherein said first processing engine and said second processing engine comprise components of an information management system.

60. The method of claim 59, wherein said information management system comprises a content delivery system.

61. The method of claim 60, wherein said content delivery system comprises an endpoint content delivery system.

62. The method of claim 51, wherein said interfacing comprises managing, and wherein said managing occurs over said distributed interconnect via a separate designated communication path.

63. The method of claim 51, wherein:
said first processing engine and said second processing engine comprise part of a system having at least two first processing engines and at least two second processing engines, each of said first processing engines having at least one respective first processing object residing thereon, and each of said second processing engines having at least one respective second processing object residing thereon;
wherein the characteristics of a given second processing object residing on at least one of said second processing engines differs from the characteristics of an other second processing object residing on an other one of said second processing engines;
wherein said given second processing object is specific to a given first processing object residing on at least one of said first processing engines, and wherein said other second processing object is specific to an other first processing object residing on at least one or said first processing engines; and
wherein said interfacing comprises interfacing a first processing object residing on one of said first processing engines with a second processing object residing on one or said second processing engines.

64. The method of claim 63, wherein any one of said first processing engines is selectably interconnectable to any one of said second processing engines across said distributed interconnect, and wherein said interfacing comprises using said distributed interconnect to selectably interface a selected first processing object residing on one of said first processing engines with a selected second processing object residing on one of said second processing engines that is specific to said selected first processing object.

65. The method of claim 64, wherein said interfacing comprises selectably interfacing said selected first processing object with said second processing object on a dynamic basis.

66. The method of claim 65, wherein said method further comprises managing said selectable interfacing of said selected first processing object with said second processing object in response to a first request for information management, relative to selective interfacing operations between first processing objects and second processing objects in response to a second request for information management, in a manner based at least in part on one or more parameters associated with individual respective requests for information management.

67. The method of claim 64, wherein each of said first processing engines comprises a first application processing engine of a content delivery system, and wherein each of said second processing engines comprises a storage processing engine of said content delivery system; and wherein said method comprises selectably interfacing said selected first processing object with said selected second processing object to allow a first processing engine on which said selected first processing object resides to retrieve content from a content source using a second processing engine on which said selected second processing object resides.

68. The method of claim 67, wherein said selected first processing object comprises a selected application processing object and wherein said selected second processing object comprises a selected buffer/cache processing object specific to said selected application processing object; wherein said selected first processing object comprises a selected file system processing object and wherein said selected second processing object comprises a selected logical volume management processing object specific to said selected file system processing object; or a combination thereof.

69. The method of claim 68, wherein said content delivery system comprises an endpoint content delivery system.

70. A system for managing a processing object, said system comprising:
a first processing engine, said first processing engine having at least one first processing object residing thereon; and
a management entity coupled to said first processing engine by a distributed interconnect, said management entity capable of managing said first processing object residing on said first processing engine across said distributed interconnect.

71. The system of claim 70, wherein said distributed interconnect comprises a switch fabric.

72. The system of claim 70, wherein said distributed interconnect comprises a virtual distributed interconnect.

73. The system of claim 71, wherein said management entity comprises at least one of a separate processing engine, a separate system, a manual input, or a combination thereof.

74. The method of claim 73, wherein said management entity comprises a separate processing engine.

75. The system of claim 74, wherein said separate processing engine comprises a system management processing engine; wherein said first processing engine comprises a storage processing engine; and wherein said at least one first processing object comprises a buffer cache algorithm, logical volume management algorithm, or a combination thereof.

76. The system of claim 75, further comprising a second processing engine, said second processing engine being coupled to said first processing engine by said distributed interconnect; wherein said second processing engine has at least one second processing object residing thereon; wherein said first processing object is specific to said second processing object; and wherein said first processing object is capable of interfacing with said second processing object across said distributed interconnect.

77. The system of claim 76, wherein said second processing engine comprises an application processing engine; wherein said second processing object comprises an application object; and wherein said first processing object comprises a buffer/cache object that is specific to said application object.

78. The system of claim 76, wherein said second processing engine comprises an application processing engine; wherein said second processing object comprises a file system object; and wherein said first processing object comprises a logical volume management object that is specific to said file system object.

79. The system of claim 76, wherein said second processing engine comprises an application processing engine; wherein said at least one second processing object comprises an application object and a file system object; and wherein said at least one first processing object comprises a buffer/cache object that is specific to said application object, and a logical volume management object that is specific to said file system object.

80. The system of claim 77, wherein said first processing engine and said second processing engine comprise components of an information management system.

81. The system of claim 80, wherein said information management system comprises a content delivery system.

82. The system of claim 81, wherein said content delivery system comprises an endpoint content delivery system.

83. A method of managing at least one processing object, said method comprising managing said processing object across a distributed interconnect.

84. The method of claim 83, wherein said at least one processing object comprises a first processing object residing on a first processing engine; wherein said first processing engine is coupled to a management entity by said distributed interconnect; and wherein said managing comprises using said management entity to manage said first processing object across said distributed interconnect.

85. The method of claim 83, wherein said distributed interconnect comprises a switch fabric.

86. The method of claim 83, wherein said distributed interconnect comprises a virtual distributed interconnect.

87. The method of claim 85, wherein said management entity comprises at least one of a separate processing engine, a separate system, a manual input, or a combination thereof.

88. The method of method 87, wherein said management entity comprises a separate processing engine.

89. The method of claim 88, wherein said separate processing engine comprises a system management processing engine; wherein said first processing engine comprises a storage processing engine; and wherein said at least one first processing object comprises a buffer cache algorithm, logical volume management algorithm, or a combination thereof.

90. The method of claim 89, wherein a said second processing engine is coupled to said first processing engine by said distributed interconnect; wherein said second processing engine has at least one second processing object residing thereon; wherein said first processing object is specific to said second processing object; and wherein said method further comprises interfacing said first processing object with said second processing object across said distributed interconnect.

91. The method of claim 90, wherein said second processing engine comprises an application processing engine; wherein said second processing object comprises an application object; and wherein said first processing object comprises a buffer/cache object that is specific to said application object.

92. The method of claim 90, wherein said second processing engine comprises an application processing engine; wherein said second processing object comprises a file system object; and wherein said first processing object comprises a logical volume management object that is specific to said file system object.

93. The method of claim 90, wherein said second processing engine comprises an application processing engine; wherein said at least one second processing object comprises an application object and a file system object; and wherein said at least one first processing object comprises a buffer/cache object that is specific to said application object, and a logical volume management object that is specific to said file system object.

94. The method of claim 91, wherein said first processing engine and said second processing engine comprise components of an information management system.

95. The method of claim 94, wherein said information management system comprises a content delivery system.

96. The method of claim 95, wherein said content delivery system comprises an endpoint content delivery system.

97. A method of coordinating a group of multiple processing engines in the performance of an operating task, said method comprising broadcasting a multicast message to said group of multiple processing engines across a distributed interconnect, said multicast facilitating the performance of said operating task.

98. The method of claim 97, wherein said distributed interconnect comprises a switch fabric.

99. The method of claim 97, wherein said distributed interconnect comprises a virtual distributed interconnect.

100. The method of claim 98, wherein said operating task comprises a failover operation, a load-balancing operation, a debugging operation, an operation to monitor a status of one or more information management resources, or a combination thereof.

101. The method of claim 100, wherein said operating task comprises a failover operation; and wherein said method comprises broadcasting said multicast message across said distributed interconnect to keep one or more of said group of processing engines apprised of the status of one or more individual members of said group of processing engines.

102. The method of claim 101, wherein said method comprises using said one or more individual members of said group of multiple processing engines to broadcast periodic multicast communications to other members of said group of multiple processing engines to indicate normal operations; and wherein said method further comprises implementing said failover operation upon absence of said periodic multicast communications from a failed processing engine by using another processing engine to assume the load or tasks of said failed processing engine.

103. The method of claim 101, wherein said method comprises broadcasting a multicast failure alarm from a failed processing engine of said group of multiple processing engines to other members of said group of multiple processing engines; and wherein said method further comprises implementing said failover operation upon broadcast of said multicast failure alarm by using another processing engine to assume the load or tasks of said failed processing engine.

104. The method of claim 101, wherein said method comprises:
using one or more designated members of said group of multiple processing engines to monitor and to detect failures of one or more other members of the group;
upon detection of a failed processing engine, using said one or more designated members of said group of multiple processing engines to broadcast a multicast failure alarm to other members of said group of multiple processing engines; and
wherein said method further comprises implementing said failover operation upon broadcast of said multicast failure alarm by using another processing engine to assume the load or tasks of said failed processing engine.

105. The method of claim 100, wherein said operating task comprises a load balancing operation; and wherein said method comprises broadcasting said multicast message across said distributed interconnect to keep said group of processing engines apprised of the status of one or more individual members of said group of processing engines.

106. The method of claim 105, wherein said method comprises using said one or more individual members of said group of multiple processing engines to broadcast multicast communications to other members of said group of multiple processing engines to indicate a workload level of said one or more individual members of said group of multiple processing engines; and wherein said method further comprises implementing said load balancing operation upon receipt of said multicast communications by transferring workload among two or more members of said group of multiple processing engines to balance workload level among said two or more members of said group of multiple processing engines.

107. The method of claim 100, wherein said multicast message comprises a multicast query from a given member of said group of multiple processing engines, said multicast query requesting information from one or more other members of said group of processing engines; and wherein said method further comprises implementing a failover operation, a load balancing operation, or a combination thereof among two or more members of said group of multiple processing engines upon receipt of said requested information by transferring workload among two or more members of said group of multiple processing engines based at least in part on said requested information.

108. The method of claim 105, wherein said method comprises:
using one or more designated members of said group of multiple processing engines to monitor and to detect workload level of one or more other members of the group;
upon detection of a workload level imbalance among said one or more other members of the group, using said one or more designated members of said group of multiple processing engines to broadcast a multicast communication to other members of said group of multiple processing engines to indicate a workload level of said one or more individual members of said group of multiple processing engines; and
wherein said method further comprises implementing said load balancing operation upon receipt of said multicast communications by transferring workload among two or more members of said group of multiple processing engines to balance workload level among said two or more members of said group of multiple processing engines.

109. The method of claim 100, wherein said method comprises broadcasting said multicast message across said distributed interconnect to keep one or more of said group of processing engines apprised of one or more defined characteristics of one or more other members of said group of processing engines; wherein said defined characteristics comprise at least one of common processing characteristics, related processing characteristics, or a combination thereof.

110. The method of claim 109, wherein said method comprises using a given application running on one of said members of said group of processing engines to broadcast said multicast message; and wherein said multicast message comprises a multicast query for another instance of itself running on one or more other members of said group of processing engines.

111. The method of claim 109, wherein said method comprises using a given application running on one of said members of said group of processing engines to broadcast said multicast message; and wherein said multicast message comprises a multicast query for services or other application on which said given application depends running on one or more other members of said group of processing engines.

112. The method of claim 100, wherein said operating task comprises a debugging operation; wherein said multicast message comprises communications between two or more of said members of said group of multiple processing engines; and wherein said method comprises monitoring said multicast message using a given member of said group of multiple processing engines, and further comprising at least one of viewing, analyzing, or storing said multicast message on said given member of said group of multiple processing engines.

113. The method of claim 112, further comprising making said multicast message accessible on said given member of said group of multiple processing engines for debug analysis by human operator, further external processing and debug analysis, or a combination thereof.

114. The method of claim 112, further comprising performing debug analysis on said multicast message using said given member of said group of multiple processing engines.

115. The method of claim 114, further comprising using said given member of said group of multiple processing engines to identify problems with said software code, to take corrective action to address problems with said software code, to report an external alarm upon identification of problems with said software code, or a combination thereof.

116. The method of claim 114, wherein said two or more processing engines comprise an application processing engine, a storage processing engine, a transport processing engine, or a combination thereof; and wherein said given member of said group of multiple processing engines comprises a system management processing engine.

117. The method of claim 100, wherein said multiple processing engines comprise components of the same information management system, components of multiple information management systems, or a combination thereof.

118. The method of claim 100, wherein said multiple processing engines comprise components of a content delivery system.

119. The method of claim 118, wherein said content delivery system comprises an endpoint content delivery system.

120. A method of analyzing software code running on a first processing engine, said method comprising communicating debug information associated with said code from said first processing engine to a second processing engine across a distributed interconnect.

121. The method of claim 120, wherein said distributed interconnect comprises a switch fabric.

122. The method of claim 120, wherein said distributed interconnect comprises a virtual distributed interconnect.

123. The method of claim 121, further comprising at least one of viewing, analyzing, or storing said debug information on said second processing engine.

124. The method of claim 121, further comprising making said debug information accessible on said second processing engine for analysis by human operator, further external processing and analysis, or a combination thereof.

125. The method of claim 123, further comprising analyzing said debug information using said second processing engine.

126. The method of claim 123, wherein said distributed interconnect comprises a switch fabric; wherein said first processing engine comprises an application processing engine; and wherein said second processing engine comprises a system management processing engine.

127. The method of claim 123, wherein said distributed interconnect comprises a virtual distributed interconnect; wherein said first processing engine comprises an application processing functionality; wherein said second processing engine comprises a host processing functionality; wherein said application processing functionality and said host processing functionality are distributively interconnected across a network by said virtual distributed interconnect.

128. The method of claim 123, wherein said first and second processing engines comprise components of the same information management system, components of different information management systems, or a combination thereof.

129. The method of claim 1232, wherein said first and second processing engines comprise components of a content delivery system.

130. The method of claim 129, wherein said content delivery system comprises an endpoint content delivery system.

131. A method of managing the manipulation of information among a group of multiple processing engines in an information management environment, each of said processing engines being capable of performing one or more information manipulation tasks, said method comprising:
receiving first and second requests for information management;
selecting a first processing flow path among said group of processing engines in order to perform a first selected combination of information manipulation tasks associated with said first request for information management; and
selecting a second processing flow path among said group of processing engines in order to perform a second selected combination of information manipulation tasks associated with said second request for information management;
wherein said group of multiple processing engines are coupled together by a distributed interconnect, wherein said first processing flow path is different from said second processing flow path, and wherein said first and second processing flow paths are each selected using said distributed interconnect.

132. The method of claim 131, wherein said distributed interconnect comprises a switch fabric.

133. The method of claim 132, wherein each of said multiple processing engines is assigned separate information manipulation tasks in an asymmetrical multi-processor configuration.

134. The method of claim 133, wherein said distributed interconnect comprises a virtual distributed interconnect.

135. The method of claim 133, wherein said selecting of said first and second processing flow paths is based at least in part on respective first and second parameters associated with each of said first and second requests for information management, based at least in part on respective first and second parameters associated with the respective particular type of information management requested by each of said first and second requests for information management, based at least in part on respective first and second parameters associated with particular user and/or class of users generating each of said first and second requests for information management, based at least in part on respective first and second parameters associated with system workload implicated by each of said first and second requests for information management, or a combination thereof.

136. The method of claim 131, wherein said selecting of said first processing flow path is based at least in part on a respective first parameter associated with said first request for information management; and wherein said selecting of said second processing flow path is based at least in part on a respective second parameter associated with said second request for information management.

137. The method of claim 136, wherein at least one of said first and second parameters comprises a priority-indicative parameter.

138. The method of claim 136, wherein at least one of said first and second parameters comprises a parameter indicative of one or more selectable information manipulation tasks; and wherein a respective first or second processing flow path selected based at least in part on said parameter indicative of one or more selectable information manipulation tasks comprises a processing flow path that includes one or more processing engines capable of performing said one or more selectable information manipulation tasks.

139. The method of claim 138, wherein one or more processing engines of said first processing flow path are capable of performing one or more e of the same core information manipulation tasks as performed by one or more processing engines of said second processing flow path.

140. The method of claim 139, wherein said one or more selectable information manipulation tasks comprise at least one of data encryption, data compression, a security function, transcoding, content filtering, content transformation, filtering based on metadata, metadata transformation, or a combination thereof.

141. The method of claim 131, wherein one or more of said multiple processing engines is capable of recognizing one or more of said respective first and second parameters and is further capable of altering at least a portion of a processing flow path based upon said recognized parameter; and wherein said selecting of at least one of said first or said second processing flow paths comprises using said one or more of said multiple processing engines to recognize one or more of said respective first and second parameters and to alter at least a portion of at least one or said first or said second processing flow paths based at least in part upon said recognized parameter.

142. The method of claim 131, wherein said multiple processing engines comprise components of the same information management system, components of multiple information management systems, or a combination thereof.

143. The method of claim 132, wherein said multiple processing engines comprise components of a content delivery system; and wherein said information management comprises delivery of content.

144. The method of claim 143, wherein said content delivery system comprises an endpoint content delivery system.

145. The method of claim 143, wherein said selecting of said first and second processing flow paths is based at least in part on respective first and second parameters associated with each of said first and second requests for content delivery, on respective first and second parameters associated with the respective particular type of content delivery requested by each of said first and second requests for information management, on respective first and second parameters associated with particular user and/or class of users generating each of said first and second requests for delivery, on respective first and second parameters associated with system workload implicated by each of said first and second requests for content delivery, or a combination thereof.

146. The method of claim 143, wherein said selecting of said first processing flow path is based at least in part on a respective first parameter associated with said first request for information management; and wherein said selecting of said second processing flow path is based at least in part on a respective second parameter associated with said second request for information management.

147. The method of claim 146, wherein at least one of said first and second parameters comprises a priority-indicative parameter.

148. The method of claim 147, wherein at least one of said first and second parameters comprises a parameter indicative of one or more selectable information manipulation tasks; and wherein a respective first or second processing flow path selected based at least in part on said parameter indicative of one or more selectable information manipulation tasks comprises a processing flow path that includes one or more processing engines capable of performing said one or more selectable information manipulation tasks.

149. The method of claim 148, wherein one or more processing engines of said first processing flow path are capable of performing one or more of the same core information manipulation tasks as performed by one or more processing engines of said second processing flow path.

150. The method of claim 149, wherein said same core information manipulation tasks comprise information manipulation tasks performed by at least one of a network application processing engine, a network transport processing engine, a storage management processing engine, a network interface processing engine, or a combination thereof.

151. The method of claim 149, wherein said one or more selectable information manipulation tasks comprise at least one of data encryption, data compression, a security function, transcoding, content filtering, content transformation, filtering based on metadata, metadata transformation, or a combination thereof.

152. The method of claim 145, wherein one or more of said multiple processing engines is capable of recognizing one or more of said respective first and second parameters and is further capable of altering at least a portion of a processing flow path based upon said recognized parameter; and wherein said selecting of at least one of said first or said second processing flow paths comprises using said one or more of said multiple processing engines to recognize one or more of said respective first and second parameters and to alter at least a portion of at least one or said first or said second processing flow paths based at least in part upon said recognized parameter.

153. The method of claim 152, wherein said recognized parameter comprises a substantive characteristic associated with requested content.

154. The method of claim 153, wherein said substantive characteristic of said content comprises at least one of objectionable subject matter contained in said requested content, language of text contained in said requested content, security-sensitive information contained in said requested content, premium subject matter contained in said requested content, or a user-identified type of subject matter contained in said requested content.
